(19) United States
(12) Patent Application Publication
(10) Pub. No.: US 2026/0147192 A1
(43) Pub. Date: May 28, 2026

(54) ZOOM LENS AND IMAGING APPARATUS

(71) Applicant: FUJIFILM Corporation, Tokyo (JP)

(72) Inventors: Hiroki SAITO, Saitama-shi (JP); Motoari OTA, Saitama (JP); Shunsuke MIYAGISHIMA, Saitama (JP)

(73) Assignee: FUJIFILM Corporation, Tokyo (JP)

(21) Appl. No.: 19/393,854

(22) Filed: Nov. 19, 2025

(30) Foreign Application Priority Data
Nov. 22, 2024 (JP) 2024-204202

(51) Int. Cl. G02B 13/00; G02B 7/02; G02B 15/14

(52) U.S. Cl. CPC G02B 13/009; G02B 7/025; G02B 13/0045; G02B 13/006; G02B 15/1461

(57) ABSTRACT

A zoom lens includes a first lens group positioned closest to an object side, an intermediate group including a plurality of lens groups, and a final lens group positioned closest to an image side. During zooming, the first lens group remains stationary with respect to an image plane, and all spacings between adjacent lens groups change. The number of lenses included in the first lens group is four or less. In a case where a back focus of a zoom lens as an air conversion distance in a state where an infinite distance object is in focus at a wide angle end is denoted by Bfw, and a focal length of the zoom lens in the state where the infinite distance object is in focus at the wide angle end is denoted by fw, the zoom lens satisfies a conditional expression: 0.1<Bfw/fw<1.9.

### CROSS-REFERENCE TO RELATED APPLICATIONS

This application claims priority from Japanese Patent Application No. 2024-204202, filed on Nov. 22, 2024, the entire disclosure of which is incorporated herein by reference.

### BACKGROUND OF THE INVENTION

### Technical Field

The disclosed technology relates to a zoom lens and an imaging apparatus.

### Related Art

In the related art, a zoom lens according to JP1996-005913A (JP-H08-005913A) has been known as a zoom lens that can be used in an imaging apparatus such as a camera.

### SUMMARY

In view of reduction in a burden during imaging, improvement in portability, and the like, there is demand for a zoom lens configured to be reduced in size and weight while having favorable optical performance. A level of demand for such a zoom lens is increasing year by year.

An object of the present disclosure is to provide a zoom lens configured to be reduced in size and weight and having favorable optical performance, and an imaging apparatus comprising the zoom lens.

According to an aspect of the present disclosure, there is provided a zoom lens comprising a first lens group positioned closest to an object side, an intermediate group including a plurality of lens groups, and a final lens group positioned closest to an image side, in which during zooming, the first lens group remains stationary with respect to an image plane, a spacing between the first lens group and the intermediate group changes, a spacing between the intermediate group and the final lens group changes, and all spacings between adjacent lens groups in the intermediate group change, the number of lenses included in the first lens group is four or less, and Conditional Expression (1) is satisfied, which is represented by

$$0.1 < Bfw / fw < 1.9 . \qquad ( 1 )$$

A back focus of a whole system as an air conversion distance in a state where an infinite distance object is in focus at a wide angle end is denoted by Bfw. A focal length of the whole system in the state where the infinite distance object is in focus at the wide angle end is denoted by fw.

It is preferable that the final lens group includes three or more lenses.

It is preferable that at least one of the plurality of lens groups included in the intermediate group is an intermediate stationary lens group that remains stationary with respect to an image plane during zooming. It is preferable that the intermediate stationary lens group includes three or more lenses.

It is preferable that a lens closest to the object side in the first lens group is a negative lens.

The final lens group may be configured to remain stationary with respect to the image plane during zooming.

It is preferable that in the zoom lens of the aspect, in a case where a focal length of the first lens group is denoted by f1, Conditional Expression (2) is satisfied, which is represented by

$$0.05 < f w / fl < 0.54 . \qquad ( 2 )$$

The zoom lens of the aspect includes an aperture stop, preferably satisfies Conditional Expression (3), and more preferably satisfies Conditional Expression (3-1).

$$0.5 < DStw / TLw < 0.85 \qquad ( 3 )$$

$$0.61 < DStw / TLw < 0.8 \qquad ( 3 - 1 )$$

A sum of a distance on an optical axis from the aperture stop to a lens surface closest to the image side in the final lens group and the back focus of the whole system as the air conversion distance in the state where the infinite distance object is in focus at the wide angle end is denoted by DStw. A sum of a distance on the optical axis from a lens surface closest to the object side in the first lens group to the lens surface closest to the image side in the final lens group and the back focus of the whole system as the air conversion distance in the state where the infinite distance object is in focus at the wide angle end is denoted by TLw.

It is preferable that the intermediate group includes a focus group that moves along an optical axis during focusing. The focus group may be configured to have negative refractive power.

It is preferable that a lens surface closest to the object side in the first lens group is a convex surface.

It is preferable that the intermediate group includes a vibration-proof group that moves in a direction intersecting with an optical axis during image shake correction. It is preferable that the vibration-proof group consists of all or a part of an intermediate stationary lens group that remains stationary with respect to the image plane during zooming. The vibration-proof group may be configured to have positive refractive power.

It is preferable that in the zoom lens of the aspect, in a case where a maximum half angle of view in the state where the infinite distance object is in focus at the wide angle end is denoted by ωw, Conditional Expression (4) is satisfied, which is represented by

$$0.4 < B f w / ( f w \times tan ω w ) < 16 ( 4 ) . \qquad ( 4 )$$

It is preferable that in the zoom lens of the aspect, in a case where a focal length of the final lens group is denoted by fE, Conditional Expression (5) is satisfied, which is represented by

$$- 0.7 < f w / f E < 0.7 . \qquad ( 5 )$$

It is preferable that in the zoom lens of the aspect, in a case where a maximum value of Abbe numbers based on a d line for all lenses included in the final lens group is denoted by νEmax, Conditional Expression (6) is satisfied, which is represented by

$$60 < vE max < 105. \qquad ( 6 )$$

It is preferable that in the zoom lens of the aspect, Conditional Expression (7) is satisfied, which is represented by

$$0.005 < D 12 w / ( f w \times tan ω w ) < 0.35 . \qquad ( 7 )$$

A spacing on an optical axis between the first lens group and a lens group adjacent to the image side of the first lens group in the state where the infinite distance object is in focus at the wide angle end is denoted by D12w. A maximum half angle of view in the state where the infinite distance object is in focus at the wide angle end is denoted by ωw.

It is preferable that the zoom lens of the aspect includes at least one combination consisting of a lens group having negative refractive power and a lens group having positive refractive power that are disposed adjacent to each other in order from the object side to the image side, and Conditional Expression (8) is satisfied, which is represented by

$$0.005 < D N P t / ( f w \times tan ω w ) < 0.5 . \qquad ( 8 )$$

A spacing on an optical axis at a telephoto end between a lens group having negative refractive power and a lens group having positive refractive power in a combination closest to the object side among the combinations is denoted by DNPt. A maximum half angle of view in the state where the infinite distance object is in focus at the wide angle end is denoted by ωw.

It is preferable that in the zoom lens of the aspect, Conditional Expression (9) is satisfied, which is represented by

$$- 0.05 < N E + 0.0067 \times v E max - 2 < 0 \text{.13} . \qquad ( 9 )$$

A refractive index with respect to a d line for a lens of which an Abbe number based on a d line is highest among lenses included in the final lens group and the Abbe number are denoted by NE and νEmax, respectively.

It is preferable that the zoom lens of the aspect includes at least one aspherical lens, and Conditional Expression (10) is satisfied, which is represented by

$$0.001 < \vert Δ sagM \vert / HaM < 0 \text{.07} . \qquad ( 10 )$$

A difference between an amount of sag of a lens surface of the aspherical lens at a height of 70% of a maximum effective radius of the lens surface and an amount of sag of a paraxial curvature spherical surface of the lens surface is defined as Δsag. In an aspherical lens closest to the object side among the aspherical lenses included in the zoom lens, any of Δsag of a surface on the object side or Δsag of a surface on the image side having a larger absolute value is denoted by ΔsagM. In the aspherical lens closest to the object side among the aspherical lenses included in the zoom lens, a larger of a maximum effective radius of the surface on the object side or a maximum effective radius of the surface on the image side is denoted by HaM.

It is preferable that the zoom lens of the aspect includes at least one lens group having negative refractive power, and the aspherical lens closest to the object side is a third lens from the object side in a lens group having negative refractive power closest to the object side among the lens groups having negative refractive power and included in the zoom lens.

It is preferable that the zoom lens of the aspect includes at least one lens group having negative refractive power, and the aspherical lens closest to the object side is a fourth lens from the object side in a lens group having negative refractive power closest to the object side among the lens groups having negative refractive power and included in the zoom lens.

It is preferable that the zoom lens of the aspect includes at least one negative lens, and in a case where a refractive index with respect to a d line for a negative lens closest to the object side among the negative lenses included in the zoom lens is denoted by Nn1, Conditional Expression (11) is satisfied, which is represented by

$$1. 59 < Nn 1 < 1.99 . \qquad ( 11 )$$

It is preferable that the zoom lens of the aspect includes at least one negative lens, and Conditional Expression (12) is satisfied, which is represented by

$$0.02 < Dn 1 / Hn 2 < 0.087 . \qquad ( 12 )$$

A center thickness of a negative lens closest to the object side among the negative lenses included in the zoom lens and a maximum effective radius of a surface, on the object side, of the negative lens are denoted by Dn1 and Hn1, respectively.

It is preferable that the zoom lens of the aspect includes at least one lens group having negative refractive power, a lens group having negative refractive power closest to the object side among the lens groups having negative refractive power and included in the zoom lens includes at least one negative lens, and Conditional Expression (13) is satisfied, which is represented by

$$0.02 < Dn 2 / Hn 2 < 0 \text{.105} . \qquad ( 13 )$$

A center thickness of a negative lens closest to the object side among the negative lenses included in the lens group having negative refractive power closest to the object side and a maximum effective radius of a surface, on the object side, of the negative lens are denoted by Dn2 and Hn2, respectively.

The zoom lens of the aspect may be configured to include at least one negative lens, and a surface, on the image side, of a negative lens closest to the object side among the negative lenses included in the zoom lens may be configured to be in contact with air.

It is preferable that the zoom lens of the aspect includes an aperture stop, and a negative lens is disposed adjacent to the image side of the aperture stop.

It is preferable that in the zoom lens of the aspect, in a case where a focal length of a lens group disposed adjacent to the object side of the final lens group is denoted by fFE, Conditional Expression (14) is satisfied, which is represented by

$$- 0.8 < f w / f F E < 0.4 . \qquad ( 14 )$$

It is preferable that the zoom lens of the aspect includes an aperture stop, and Conditional Expression (15) is satisfied, which is represented by

$$1.43 < NStp < 1.895 . \qquad ( 15 )$$

In a case where the aperture stop is included in a lens group, a refractive index with respect to a d line for a positive lens closest to the image side among positive lenses included in the lens group including the aperture stop is denoted by NStp. In a case where the aperture stop is not included in a lens group, a refractive index with respect to a d line for a positive lens closest to the image side among positive lenses included in a lens group adjacent to the image side of the aperture stop is denoted by NStp.

It is preferable that in the zoom lens of the aspect, in a case where an average value of refractive indices with respect to a d line for all lenses included in the first lens group is denoted by N1ave, Conditional Expression (16) is satisfied, which is represented by

$$6 < N 1 ave < 1.9 . \qquad ( 16 )$$

It is preferable that in the zoom lens of the aspect, Conditional Expression (17) is satisfied, which is represented by

$$0.14 < β E t \times β F E t < 2.2 . \qquad ( 17 )$$

A lateral magnification of the final lens group in a state where the infinite distance object is in focus at a telephoto end is denoted by βEt. A lateral magnification of a lens group adjacent to the object side of the final lens group in the state where the infinite distance object is in focus at the telephoto end is denoted by βFEt.

It is preferable that the zoom lens of the aspect includes at least one lens group having negative refractive power, and Conditional Expression (18) is satisfied, which is represented by

$$15 < vN min < 25.6 . \qquad ( 18 )$$

A minimum value of Abbe numbers based on a d line for all lenses included in a lens group having negative refractive power closest to the object side among the lens groups having negative refractive power and included in the zoom lens is denoted by νNmin.

It is preferable that the zoom lens of the aspect includes an aperture stop, and Conditional Expression (19) is satisfied, which is represented by

$$0.3 < fw / fGSt < 1.3 . \qquad ( 19 )$$

In a case where the aperture stop is included in a lens group, a focal length of the lens group including the aperture stop is denoted by fGSt. In a case where the aperture stop is not included in a lens group, a focal length of the lens group adjacent to the image side of the aperture stop is denoted by fGSt.

It is preferable that the zoom lens of the aspect includes at least one lens group having negative refractive power, and Conditional Expression (20) is satisfied, which is represented by

$$- 2.5 < fw / fN < - 0.8 . \qquad ( 20 )$$

A focal length of a lens group having negative refractive power closest to the object side among the lens groups having negative refractive power and included in the zoom lens is denoted by fN.

According to another aspect of the present disclosure, there is provided an imaging apparatus comprising the zoom lens according to the aspect of the present disclosure.

In the present specification, “consist of” and “consisting of” mean that a lens substantially not having refractive power, an optical element other than a lens, such as a stop, a filter, and a cover glass, a mechanism part such as a lens flange, a lens barrel, an imaging element, and a camera shake correction mechanism, and the like may be included in addition to the illustrated constituents.

In the present specification, a “group having positive refractive power” and an expression “a group has positive refractive power” mean that the whole group has positive refractive power. Similarly, a “group having negative refractive power” and an expression “a group has negative refractive power” mean that the whole group has negative refractive power. In the present specification, the “first lens group”, the “lens group”, the “final lens group”, the “focus group”, the “vibration-proof group”, the “object-side vibration-proof group”, and the “image-side vibration-proof group” are not limited to being composed of a plurality of lenses and may be composed of only one lens.

A compound aspherical lens (a lens functioning as one aspherical lens as a whole composed of a spherical lens and a film having an aspherical shape formed on the spherical lens that are integrated with each other) is not regarded as a cemented lens and is treated as one lens. Unless otherwise specified, a sign of refractive power and a surface shape in a paraxial region are used with respect to a lens including an aspherical surface.

In the present specification, the “whole system” refers to the zoom lens. The “focal length” used in the conditional expressions is a paraxial focal length. Unless otherwise specified, the “distance on the optical axis” used in the conditional expressions is a geometrical distance. Unless otherwise specified, values used in the conditional expressions are values based on a d line in the state where the infinite distance object is in focus. Unless otherwise specified, the “height” in the present specification refers to a height from the optical axis.

A “d line”, a “C line”, an “F line”, and a “g line” according to the present specification are bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

According to the present disclosure, a zoom lens configured to be reduced in size and weight and having favorable optical performance, and an imaging apparatus comprising the zoom lens can be provided.

### BRIEF DESCRIPTION OF THE DRAWINGS

FIG. 1 is a diagram showing a configuration and a moving path of a zoom lens according to one embodiment corresponding to a zoom lens of Example 1.

FIG. 2 is a cross-sectional view of the configuration of the zoom lens in FIG. 1 at a wide angle end for describing symbols of conditional expressions.

FIG. 3 is a partial enlarged view for describing the symbols of the conditional expressions.

FIG. 4 is a diagram for describing a maximum effective radius.

FIG. 5 is a diagram for describing an amount of sag and an asphericity.

FIG. 6 is each aberration diagram of the zoom lens of Example 1.

FIG. 7 is a diagram showing a configuration and a moving path of a zoom lens of Example 2.

FIG. 8 is each aberration diagram of the zoom lens of Example 2.

FIG. 9 is a diagram showing a configuration and a moving path of a zoom lens of Example 3.

FIG. 10 is each aberration diagram of the zoom lens of Example 3.

FIG. 11 is a diagram showing a configuration and a moving path of a zoom lens of Example 4.

FIG. 12 is each aberration diagram of the zoom lens of Example 4.

FIG. 13 is a diagram showing a configuration and a moving path of a zoom lens of Example 5.

FIG. 14 is each aberration diagram of the zoom lens of Example 5.

FIG. 15 is a diagram showing a configuration and a moving path of a zoom lens of Example 6.

FIG. 16 is each aberration diagram of the zoom lens of Example 6.

FIG. 17 is a diagram showing a configuration and a moving path of a zoom lens of Example 7.

FIG. 18 is each aberration diagram of the zoom lens of Example 7.

FIG. 19 is a diagram showing a configuration and a moving path of a zoom lens of Example 8.

FIG. 20 is each aberration diagram of the zoom lens of Example 8.

FIG. 21 is a diagram showing a configuration and a moving path of a zoom lens of Example 9.

FIG. 22 is each aberration diagram of the zoom lens of Example 9.

FIG. 23 is a diagram showing a configuration and a moving path of a zoom lens of Example 10.

FIG. 24 is each aberration diagram of the zoom lens of Example 10.

FIG. 25 is a diagram showing a configuration and a moving path of a zoom lens of Example 11.

FIG. 26 is each aberration diagram of the zoom lens of Example 11.

FIG. 27 is a perspective view of a front surface side of an imaging apparatus according to one embodiment.

FIG. 28 is a perspective view of a rear surface side of the imaging apparatus according to one embodiment.

### DETAILED DESCRIPTION

Hereinafter, an embodiment of the present disclosure will be described with reference to the drawings.

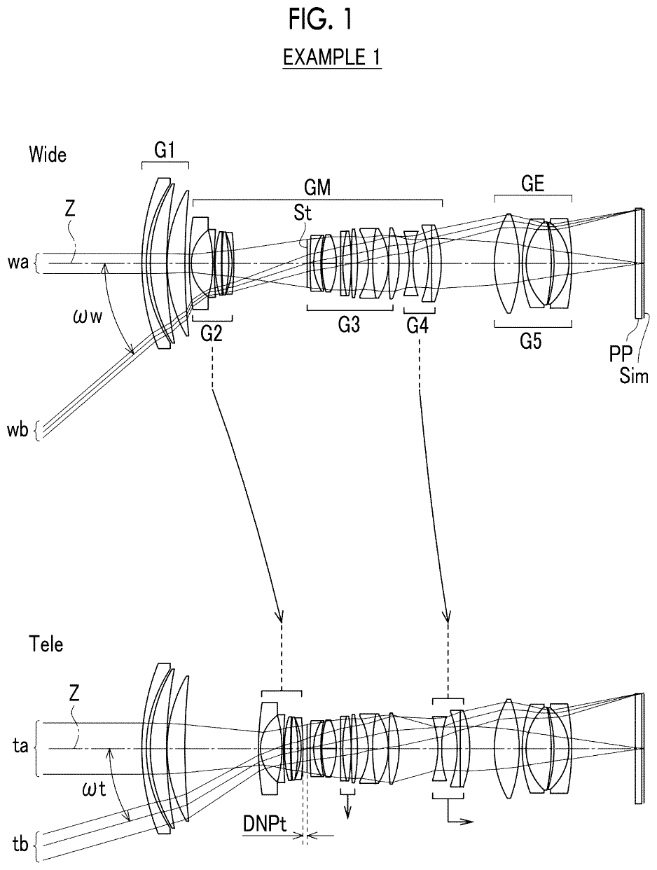

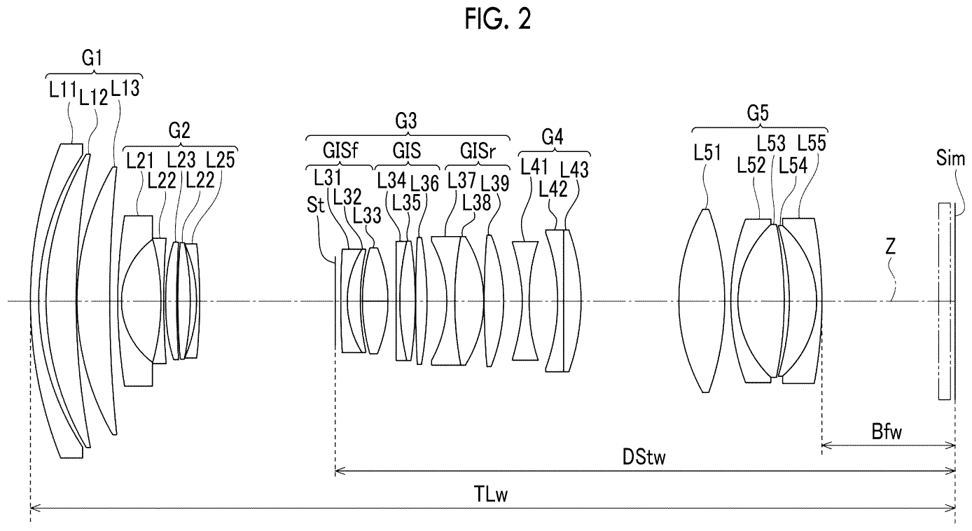

FIG. 1 shows a cross-sectional view of a configuration, luminous fluxes, and a moving path of a zoom lens according to one embodiment of the present disclosure. In FIG. 1, a wide angle end state is shown in an upper part labeled “Wide”, and a telephoto end state is shown in a lower part labeled “Tele”. In FIG. 1, an on-axis luminous flux wa and a luminous flux wb of a maximum half angle of view ωw at a wide angle end and an on-axis luminous flux ta and a luminous flux tb of a maximum half angle of view ωt at a telephoto end are shown as the luminous fluxes. FIG. 2 shows a cross-sectional view of the configuration of the zoom lens in FIG. 1 at the wide angle end. FIGS. 1 and 2 show a state where an infinite distance object is in focus, in which a left side is an object side, and a right side is an image side. Examples shown in FIGS. 1 and 2 correspond to a zoom lens of Example 1 described later. The following description will be mainly provided with reference to FIG. 1 and, as necessary, with reference to FIG. 2.

FIG. 1 shows an example in which an optical member PP having a parallel flat plate shape is disposed between the zoom lens and an image plane Sim, assuming that the zoom lens is applied to an imaging apparatus. The optical member PP is a member that is assumed to be various filters and/or a cover glass or the like. The various filters include a low-pass filter, an infrared cut filter, and/or a filter or the like that cuts a specific wavelength range. The optical member PP is a member not having refractive power. The imaging apparatus can also be configured without the optical member PP.

The zoom lens of the present disclosure comprises a first lens group G1 positioned closest to the object side, an intermediate group GM including a plurality of lens groups, and a final lens group GE positioned closest to the image side. Such a configuration provides an advantage in increasing a zoom ratio while reducing a total length.

During zooming, the first lens group G1 remains stationary with respect to the image plane Sim, a spacing between the first lens group G1 and the intermediate group GM changes, a spacing between the intermediate group GM and the final lens group GE changes, and spacings between all adjacent lens groups in the intermediate group GM change. By not moving the first lens group G1 during zooming, a centroid can be prevented from moving during zooming.

In the present specification, one lens group is defined as a group of which a spacing with respect to an adjacent group in an optical axis direction changes during zooming. During zooming, a spacing between adjacent lenses does not change in one lens group. That is, the “lens group” is a part that is a constituent of the zoom lens and that includes at least one lens divided by an air spacing which changes during zooming. During zooming, each lens group moves or remains stationary in lens group units. The “lens group” may include a constituent, other than a lens, that does not have refractive power, for example, an aperture stop St.

For example, the zoom lens in FIG. 1 consists of, in order from the object side to the image side, the first lens group G1, a second lens group G2, a third lens group G3, a fourth lens group G4, and a fifth lens group G5. In the example of FIG. 1, the intermediate group GM consists of the second lens group G2, the third lens group G3, and the fourth lens group G4, and the final lens group GE consists of the fifth lens group G5.

For example, each lens group in FIG. 1 of which a detailed configuration is shown in FIG. 2 is configured as follows. The first lens group G1 consists of, in order from the object side to the image side, three lenses including lenses L11 to L13. The second lens group G2 consists of, in order from the object side to the image side, five lenses including lenses L21 to L25. The third lens group G3 consists of, in order from the object side to the image side, the aperture stop St and nine lenses including lenses L31 to L39. The fourth lens group G4 consists of, in order from the object side to the image side, three lenses including lenses L41 to L43. The fifth lens group G5 consists of, in order from the object side to the image side, five lenses including lenses L51 to L55. The aperture stop St in FIGS. 1 and 2 does not show a shape or a size and shows a position in the optical axis direction.

In the example of FIG. 1, during zooming, the first lens group G1, the third lens group G3, and the fifth lens group G5 remain stationary with respect to the image plane Sim, and the second lens group G2 and the fourth lens group G4 move along an optical axis Z. In FIG. 1 between the upper part and the lower part, a schematic moving path during zooming from the wide angle end to the telephoto end is shown by solid line arrows for each lens group that moves during zooming.

In the zoom lens of the present disclosure, the number of lenses included in the first lens group G1 is configured to be four or less. Such a configuration provides an advantage in weight reduction.

A lens closest to the object side in the first lens group G1 is preferably a negative lens. Doing so provides an advantage in achieving a wide angle.

A lens surface closest to the object side in the first lens group G1 is preferably a convex surface. Doing so provides an advantage in reducing distortion.

The zoom lens of the present disclosure may be configured to include at least one negative lens, in which a surface, on the image side, of a negative lens closest to the object side among the negative lenses included in the zoom lens is in contact with air. By doing so, an air lens is formed adjacent to the image side of the negative lens closest to the object side, and this air lens provides an advantage in reducing off-axis aberration at the wide angle end. In the present specification, an air spacing between two facing lens surfaces is regarded as a lens having a refractive index of 1, and this air spacing will be referred to as the air lens. For example, the air lens is formed between a surface, on the image side, of the lens L11 and a surface, on the object side, of the lens L12 in FIG. 2.

The zoom lens of the present disclosure may be configured to include at least one lens group having negative refractive power, in which a lens group having negative refractive power closest to the object side among the lens groups having negative refractive power and included in the zoom lens includes four or more lenses. Doing so provides an advantage in reducing fluctuation of aberration during zooming.

The intermediate group GM preferably includes a focus group that moves along the optical axis Z during focusing. Doing so provides an advantage in reducing a weight of the focus group.

For example, in the zoom lens shown in FIG. 1, the focus group consists of the fourth lens group. Brackets and a rightward arrow given to the fourth lens group in the lower part of FIG. 1 show the focus group composed of a lens enclosed in the brackets and a direction in which the focus group moves during focusing from the infinite distance object to a nearest object. While the focus group functions in the whole zoom range including the wide angle end state, the arrow is provided in only the lower part of FIG. 1 to avoid complication.

The focus group may be configured to consist of one lens group that moves during zooming. Doing so provides an advantage in simplifying a moving mechanism.

The focus group may be configured to have negative refractive power. Doing so provides an advantage in reducing the total length. Alternatively, the focus group may be configured to have positive refractive power. Doing so provides an advantage in reducing fluctuation of aberration during focusing.

The focus group may be configured to include three or more lenses. Doing so provides an advantage in reducing fluctuation of aberration during focusing.

At least one of the plurality of lens groups included in the intermediate group GM is preferably an intermediate stationary lens group that remains stationary with respect to the image plane Sim during zooming. Doing so can prevent the centroid from moving during zooming. The intermediate stationary lens group preferably includes three or more lenses. Doing so provides an advantage in reducing spherical aberration. For example, in the example of FIG. 1, the third lens group G3 corresponds to the intermediate stationary lens group.

The intermediate group GM preferably includes a vibration-proof group that moves in a direction intersecting with the optical axis Z during image shake correction. Doing so can prevent an imaging range from moving in a case where a camera shake occurs.

The vibration-proof group preferably consists of all or a part of the intermediate stationary lens group that remains stationary with respect to the image plane Sim during zooming. Doing so provides an advantage in reducing a weight of the lens group that moves during zooming.

The lens group including the vibration-proof group may be configured to include an object-side vibration-proof group that is disposed adjacent to the object side of the vibration-proof group and of which a spacing with respect to the vibration-proof group does not change during zooming. Doing so provides an advantage in reducing fluctuation of aberration during image shake correction.

The lens group including the vibration-proof group may be configured to include an image-side vibration-proof group that is disposed adjacent to the image side of the vibration-proof group and of which a spacing with respect to the vibration-proof group does not change during zooming. Doing so provides an advantage in reducing fluctuation of aberration during image shake correction.

For example, the third lens group G3 shown in FIG. 2 consists of, in order from the object side to the image side, an object-side vibration-proof group GISf, a vibration-proof group GIS, and an image-side vibration-proof group GISr. For example, in the example of FIG. 2, the object-side vibration-proof group GISf consists of the lenses L31 to L33, the vibration-proof group GIS consists of the lenses L34 to L36, and the image-side vibration-proof group GISr consists of the lenses L37 to L39. In the lower part of FIG. 1, a bracket and a downward arrow are given below lenses corresponding to the vibration-proof group. While the vibration-proof group functions in the whole zoom range including the wide angle end state, the arrow is provided in only the lower part of FIG. 1 to avoid complication.

The vibration-proof group may be configured to have positive refractive power. Doing so provides an advantage in reducing sensitivity of aberration caused by relative misregistration between a group disposed adjacent to the object side of the vibration-proof group and a group disposed adjacent to the image side of the vibration-proof group, to the relative misregistration. Alternatively, the vibration-proof group may be configured to have negative refractive power. Doing so provides an advantage in reducing fluctuation of aberration during image shake correction.

A lens closest to the object side in the final lens group GE may be configured to be a positive lens. Doing so provides an advantage in reducing a diameter of the final lens group GE.

The final lens group GE preferably includes three or more lenses. Doing so provides an advantage in reducing off-axis aberration.

The final lens group GE may be configured to remain stationary with respect to the image plane Sim during zooming. Doing so can prevent the centroid from moving during zooming.

The zoom lens of the present disclosure may be configured to include the aperture stop St, in which a negative lens is disposed adjacent to the image side of the aperture stop St. Doing so provides an advantage in configuring a lens system having a small F-number.

The zoom lens of the present disclosure may be configured to include the aperture stop St, in which the aperture stop St remains stationary with respect to the image plane Sim during zooming. Doing so provides an advantage in reducing the weight of the group that moves during zooming.

Next, preferable configurations and available configurations related to conditional expressions of the zoom lens of the present disclosure will be described. In the following description related to the conditional expressions, duplicate descriptions of symbols will be omitted using the same symbols for the same definitions to avoid redundant description. Hereinafter, the “zoom lens of the present disclosure” will be simply referred to as the “zoom lens” to avoid redundant description.

The zoom lens preferably satisfies Conditional Expression (1). A back focus of the whole system as an air conversion distance in a state where the infinite distance object is in focus at the wide angle end is denoted by Bfw. A focal length of the whole system in the state where the infinite distance object is in focus at the wide angle end is denoted by fw. The “back focus of the whole system as the air conversion distance” is an air conversion distance on the optical axis from a lens surface closest to the image side in the final lens group to the image plane Sim. For example, FIG. 2 schematically shows the back focus Bfw. In FIG. 2, an optical member having a parallel flat plate shape and not having refractive power to be calculated using the air conversion distance is shown by a double-dotted dashed line. Ensuring that a corresponding value of Conditional Expression (1) is not less than or equal to its lower limit value provides an advantage in securing a light quantity in an edge part. Ensuring that the corresponding value of Conditional Expression (1) is not greater than or equal to its upper limit value provides an advantage in reducing the total length of the optical system.

$$0.1 < Bfw / fw < 1.9 \qquad ( 1 )$$

To obtain more favorable characteristics, the lower limit value of Conditional Expression (1) is more preferably 0.3, further preferably 0.5, and still more preferably 0.57. To obtain more favorable characteristics, the upper limit value of Conditional Expression (1) is more preferably 1.5, further preferably 1.2, and still more preferably 1.12. For example, the zoom lens more preferably satisfies Conditional Expression (1-1), further preferably satisfies Conditional Expression (1-2), and still more preferably satisfies Conditional Expression (1-3).

$$0.3 < Bfw / fw < 1.5 \qquad ( 1 - 1 )$$

$$0.5 < Bfw / fw < 1.2 \qquad ( 1 - 2 )$$

$$0.57 < Bfw / fw < 1.12 \qquad ( 1 - 3 )$$

In a case where a focal length of the first lens group G1 is denoted by f1, the zoom lens preferably satisfies Conditional Expression (2). Ensuring that a corresponding value of Conditional Expression (2) is not less than or equal to its lower limit value can increase refractive power of the first lens group G1 and thus, provides an advantage in reducing the total length. Ensuring that the corresponding value of Conditional Expression (2) is not greater than or equal to its upper limit value prevents an excessive increase in the refractive power of the first lens group G1 and thus, provides an advantage in achieving a wide angle while reducing aberration.

$$0.05 < fw / fl < 0.54 \qquad ( 2 )$$

To obtain more favorable characteristics, the lower limit value of Conditional Expression (2) is more preferably 0.12, further preferably 0.2, and still more preferably 0.23. To obtain more favorable characteristics, the upper limit value of Conditional Expression (2) is more preferably 0.5, further preferably 0.42, and still more preferably 0.386. For example, the zoom lens more preferably satisfies Conditional Expression (2-1), further preferably satisfies Conditional Expression (2-2), and still more preferably satisfies Conditional Expression (2-3).

$$0.12 < fw / fl < 0.5 \qquad ( 2 - 1 )$$

$$0.2 < fw / fl < 0.42 \qquad ( 2 - 2 )$$

$$0.23 < fw / fl < 0.386 \qquad ( 2 - 3 )$$

In a configuration in which the zoom lens includes the aperture stop St, the zoom lens preferably satisfies Conditional Expression (3). A sum of a distance on the optical axis from the aperture stop St to the lens surface closest to the image side in the final lens group GE and the back focus of the whole system as the air conversion distance in the state where the infinite distance object is in focus at the wide angle end is denoted by DStw. A sum of a distance on the optical axis from the lens surface closest to the object side in the first lens group G1 to the lens surface closest to the image side in the final lens group GE and the back focus of the whole system as the air conversion distance in the state where the infinite distance object is in focus at the wide angle end is denoted by TLw. TLw is the total length of the lens system in the state where the infinite distance object is in focus at the wide angle end. For example, FIG. 2 schematically shows the distance DStw and the total length TLw of the lens system. Ensuring that a corresponding value of Conditional Expression (3) is not less than or equal to its lower limit value provides an advantage in reducing a diameter of the first lens group G1. Ensuring that the corresponding value of Conditional Expression (3) is not greater than or equal to its upper limit value can increase separation between an on-axis luminous flux and an off-axis luminous flux in the first lens group G1 and thus, provides an advantage in correcting aberration of the off-axis luminous flux while reducing the total length of the optical system.

$$0.5 < DStw / TLw < 0.85 \qquad ( 3 )$$

To obtain more favorable characteristics, the lower limit value of Conditional Expression (3) is more preferably 0.61, further preferably 0.63, and still more preferably 0.64. To obtain more favorable characteristics, the upper limit value of Conditional Expression (3) is more preferably 0.8, further preferably 0.72, and still more preferably 0.685. For example, the zoom lens more preferably satisfies Conditional Expression (3-1), further preferably satisfies Conditional Expression (3-2), and still more preferably satisfies Conditional Expression (3-3).

$$0.61 < DStw / TLw < 0.8 \qquad ( 3 - 1 )$$

$$0.63 < DStw / TLw < 0.72 \qquad ( 3 - 2 )$$

$$0.64 < DStw / TLw < 0.685 \qquad ( 3 - 3 )$$

The zoom lens preferably satisfies Conditional Expression (4). A maximum half angle of view in the state where the infinite distance object is in focus at the wide angle end is denoted by ωw. For example, FIG. 1 shows the maximum half angle of view ωw. Ensuring that a corresponding value of Conditional Expression (4) is not less than or equal to its lower limit value provides an advantage in securing the light quantity in the edge part. Ensuring that the corresponding value of Conditional Expression (4) is not greater than or equal to its upper limit value provides an advantage in reducing the total length of the optical system.

$$0.4 < Bfw / ( fw \times tan ω w ) < 1.6 \qquad ( 4 )$$

To obtain more favorable characteristics, the lower limit value of Conditional Expression (4) is more preferably 0.5, further preferably 0.6, and still more preferably 0.69. To obtain more favorable characteristics, the upper limit value of Conditional Expression (4) is more preferably 1.5, further preferably 1.4, and still more preferably 1.29. For example, the zoom lens more preferably satisfies Conditional Expression (4-1), further preferably satisfies Conditional Expression (4-2), and still more preferably satisfies Conditional Expression (4-3).

$$0.5 < Bfw / ( fw \times tan ω w ) < 1.5 \qquad ( 4 - 1 )$$

$$0.6 < Bfw / ( fw \times tan ω w ) < 1.4 \qquad ( 4 - 2 )$$

$$0.69 < Bfw / ( fw \times tan ω w ) < 1.29 \qquad ( 4 - 3 )$$

In a case where a focal length of the final lens group GE is denoted by fE, the zoom lens preferably satisfies Conditional Expression (5). Ensuring that a corresponding value of Conditional Expression (5) is not less than or equal to its lower limit value provides an advantage in securing the back focus. Ensuring that the corresponding value of Conditional Expression (5) is not greater than or equal to its upper limit value can reduce the back focus and thus, provides an advantage in reducing the total length.

$$- 0.7 < fw / fE < 0.7 \qquad ( 5 )$$

To obtain more favorable characteristics, the lower limit value of Conditional Expression (5) is more preferably −0.6, further preferably −0.5, and still more preferably −0.4. To obtain more favorable characteristics, the upper limit value of Conditional Expression (5) is more preferably 0.6, further preferably 0.5, and still more preferably 0.36. For example, the zoom lens more preferably satisfies Conditional Expression (5-1), further preferably satisfies Conditional Expression (5-2), and still more preferably satisfies Conditional Expression (5-3).

$$- 0.6 < fw / fE < 0.6 \qquad ( 5 - 1 )$$

$$- 0.5 < fw / fE < 0.5 \qquad ( 5 - 2 )$$

$$- 0.4 < fw / fE < 0.36 \qquad ( 5 - 3 )$$

In a case where a maximum value of Abbe numbers based on a d line for all lenses included in the final lens group GE is denoted by νEmax, the zoom lens preferably satisfies Conditional Expression (6). Ensuring that a corresponding value of Conditional Expression (6) is not less than or equal to its lower limit value provides an advantage in reducing lateral chromatic aberration. Ensuring that the corresponding value of Conditional Expression (6) is not greater than or equal to its upper limit value enables use of a material having a high refractive index and thus, can reduce a thickness of the lens. This provides an advantage in size reduction.

$$60 < ν E max < 105 \qquad ( 6 )$$

To obtain more favorable characteristics, the lower limit value of Conditional Expression (6) is more preferably 70, further preferably 75, and still more preferably 80. To obtain more favorable characteristics, the upper limit value of Conditional Expression (6) is more preferably 100, further preferably 98, and still more preferably 95. For example, the zoom lens more preferably satisfies Conditional Expression (6-1), further preferably satisfies Conditional Expression (6-2), and still more preferably satisfies Conditional Expression (6-3).

$$70 < ν E max < 100 \qquad ( 6 - 1 )$$

$$75 < ν E max < 98 \qquad ( 6 - 2 )$$

$$80 < ν E max < 95 \qquad ( 6 - 3 )$$

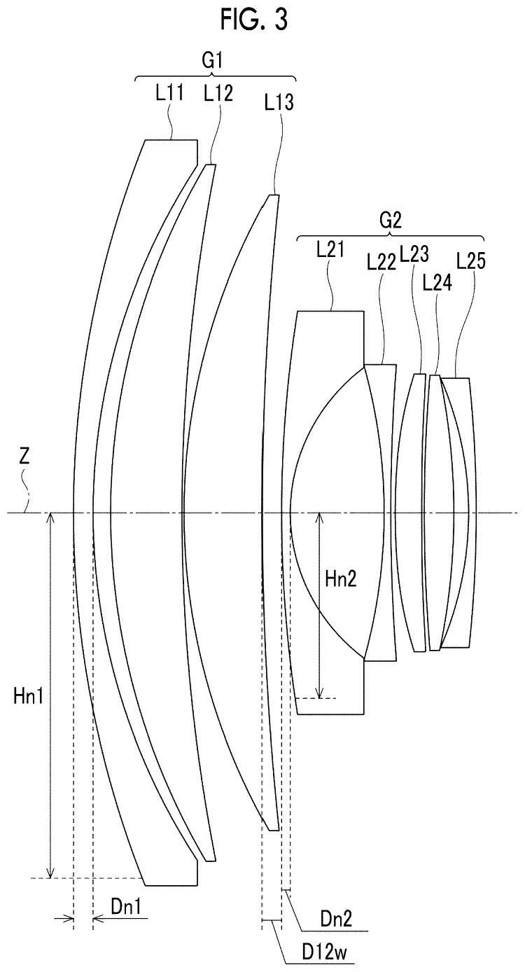

The zoom lens preferably satisfies Conditional Expression (7). A spacing on the optical axis between the first lens group G1 and a lens group adjacent to the image side of the first lens group G1 in the state where the infinite distance object is in focus at the wide angle end is denoted by D12w. FIG. 3 shows a partial enlarged view of the zoom lens of FIG. 1. For example, FIG. 3 shows the spacing D12w. Ensuring that a corresponding value of Conditional Expression (7) is not less than or equal to its lower limit value can avoid contact between lens groups caused by an impact or the like and thus, provides an advantage in improving robustness. Ensuring that the corresponding value of Conditional Expression (7) is not greater than or equal to its upper limit value provides an advantage in achieving a wide angle.

$$0.005 < D 12 w / ( fw \times tan ω w ) < 0.35 \qquad ( 7 )$$

To obtain more favorable characteristics, the lower limit value of Conditional Expression (7) is more preferably 0.01, further preferably 0.02, and still more preferably 0.03. To obtain more favorable characteristics, the upper limit value of Conditional Expression (7) is more preferably 0.25, further preferably 0.15, and still more preferably 0.095. For example, the zoom lens more preferably satisfies Conditional Expression (7-1), further preferably satisfies Conditional Expression (7-2), and still more preferably satisfies Conditional Expression (7-3).

$$0.01 < D 12 w / ( fw \times tan ω w ) < 0.25 \qquad ( 7 - 1 )$$

$$0.02 < D 12 w / ( fw \times tan ω w ) < 0 \text{.15} \qquad ( 7 - 2 )$$

$$0.03 < D 12 w / ( fw \times tan ω w ) < 0 \text{.095} \qquad ( 7 - 3 )$$

In a configuration in which the zoom lens includes at least one combination consisting of a lens group having negative refractive power and a lens group having positive refractive power disposed adjacent to each other in order from the object side to the image side, the zoom lens preferably satisfies Conditional Expression (8). A spacing on the optical axis at the telephoto end between the lens group having negative refractive power and the lens group having positive refractive power in a combination closest to the object side among the combinations is denoted by DNPt. For example, FIG. 1 shows the spacing DNPt. In the example of FIG. 1, a spacing on the optical axis at the telephoto end between the second lens group G2 and the third lens group G3 corresponds to DNPt. Ensuring that a corresponding value of Conditional Expression (8) is not less than or equal to its lower limit value can avoid contact between lens groups caused by an impact or the like and thus, provides an advantage in improving robustness. Ensuring that the corresponding value of Conditional Expression (8) is not greater than or equal to its upper limit value provides an advantage in obtaining a high zoom ratio.

$$0.005 < D N Pt / ( fw \times tan ω w ) < 0.5 \qquad ( 8 )$$

To obtain more favorable characteristics, the lower limit value of Conditional Expression (8) is more preferably 0.02, further preferably 0.04, and still more preferably 0.065. To obtain more favorable characteristics, the upper limit value of Conditional Expression (8) is more preferably 0.35, further preferably 0.25, and still more preferably 0.19. For example, the zoom lens more preferably satisfies Conditional Expression (8-1), further preferably satisfies Conditional Expression (8-2), and still more preferably satisfies Conditional Expression (8-3).

$$0.02 < D N Pt / ( fw \times tan ω w ) < 0.35 \qquad ( 8 - 1 )$$

$$0.04 < D N Pt / ( fw \times tan ω w ) < 0.25 \qquad ( 8 - 2 )$$

$$0.065 < D N Pt / ( fw \times tan ω w ) < 0.19 \qquad ( 8 - 3 )$$

The zoom lens preferably satisfies Conditional Expression (9). A refractive index and an Abbe number with respect to a d line for a lens having the highest Abbe number based on the d line among the lenses included in the final lens group GE are denoted by NE and νEmax, respectively. Ensuring that a corresponding value of Conditional Expression (9) is not less than or equal to its lower limit value provides an advantage in reducing a second-order spectrum of the lateral chromatic aberration. Ensuring that the corresponding value of Conditional Expression (9) is not greater than or equal to its upper limit value enables selection of a material having a low relative density and thus, provides an advantage in weight reduction.

$$- 0.05 < N E + 0.0067 \times vE max - 2 < 0 \text{.13} \qquad ( 9 )$$

To obtain more favorable characteristics, the lower limit value of Conditional Expression (9) is more preferably −0.03, further preferably 0, and still more preferably 0.02. To obtain more favorable characteristics, the upper limit value of Conditional Expression (9) is more preferably 0.11, further preferably 0.09, and still more preferably 0.07. For example, the zoom lens more preferably satisfies Conditional Expression (9-1), further preferably satisfies Conditional Expression (9-2), and still more preferably satisfies Conditional Expression (9-3).

$$- 0.03 < N E + 0.0067 \times vE max - 2 < 0.11 \qquad ( 9 - 1 )$$

$$0 < N E + 0.0067 \times vE max - 2 < 0.09 \qquad ( 9 - 2 )$$

$$0.02 < N E + 0.0067 \times vE max - 2 < 0.07 \qquad ( 9 - 3 )$$

In a configuration in which the zoom lens includes at least one aspherical lens, the zoom lens preferably satisfies Conditional Expression (10). Hereinafter, for convenience of description, an aspherical lens closest to the object side among the aspherical lenses included in the zoom lens will be referred to as a most-object-side aspherical lens. A difference between an amount of sag of a lens surface and an amount of sag of a paraxial curvature spherical surface of the lens surface at a height of 70% of a maximum effective radius of the lens surface of the aspherical lens is defined as Δsag. That is, Δsag is asphericity at the height of 70% of the maximum effective radius. In the most-object-side aspherical lens, any of the asphericity Δsag of a surface on the object side or the asphericity Δsag of a surface on the image side having a larger absolute value is denoted by ΔsagM. In the most-object-side aspherical lens, the larger of a maximum effective radius of the surface on the object side or a maximum effective radius of the surface on the image side is denoted by HaM. Ensuring that a corresponding value of Conditional Expression (10) is not less than or equal to its lower limit value provides an advantage in reducing fluctuation of off-axis aberration during zooming. Ensuring that the corresponding value of Conditional Expression (10) is not greater than or equal to its upper limit value provides an advantage in improving workability of the lens.

$$0.001 < \vert Δ sagM \vert / HaM < 0 \text{.07} \qquad ( 10 )$$

To obtain more favorable characteristics, the lower limit value of Conditional Expression (10) is more preferably 0.002, further preferably 0.004, and still more preferably 0.006. To obtain more favorable characteristics, the upper limit value of Conditional Expression (10) is more preferably 0.06, further preferably 0.05, and still more preferably 0.04. For example, the zoom lens more preferably satisfies Conditional Expression (10-1), further preferably satisfies Conditional Expression (10-2), and still more preferably satisfies Conditional Expression (10-3).

$$0.002 < \vert Δ sagM \vert / HaM < 0.06 \qquad ( 10 - 1 )$$

$$0.004 < \vert Δ sagM \vert / HaM < 0.05 \qquad ( 10 - 2 )$$

$$0.006 < \vert Δ sagM \vert / HaM < 0.04 \qquad ( 10 - 3 )$$

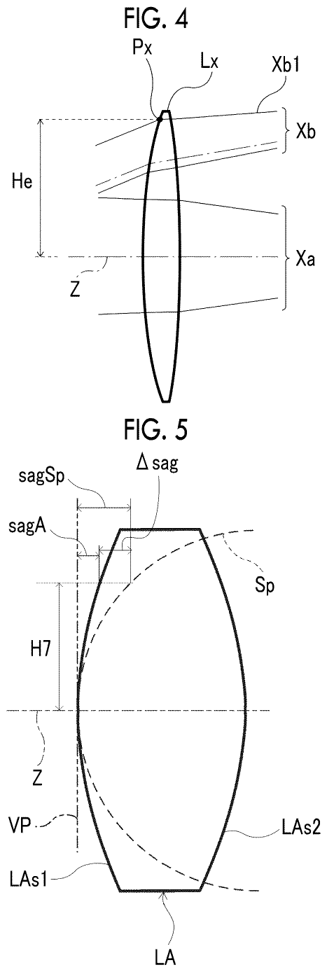

The “maximum effective radius” in the present specification will be described with reference to FIG. 4. FIG. 4 is a diagram for description, in which a left side is the object side, and a right side is the image side. FIG. 4 shows an on-axis luminous flux Xa and an off-axis luminous flux Xb passing through a lens Lx. In the example of FIG. 4, a ray Xb1 that is a ray on an upper side of the off-axis luminous flux Xb is a ray passing through an outermost side. The “outer side” means an outer side in a diameter direction centered on the optical axis Z, that is, a side away from the optical axis Z. A position of an intersection between the ray passing through the outermost side and a lens surface is a position Px of a maximum effective diameter. A height of the position Px of the maximum effective diameter from the optical axis Z is a maximum effective radius He of a surface, on the object side, of the lens Lx. While the ray on the upper side of the off-axis luminous flux Xb is the ray passing through the outermost side in the example of FIG. 4, which ray is the ray passing through the outermost side varies depending on a lens system.

The “amount of sag”, the “paraxial curvature spherical surface”, and the “asphericity Δsag” defined above will be described with reference to FIG. 5. FIG. 5 is a diagram for description, in which a left side is the object side, and a right side is the image side. FIG. 5 shows an aspherical lens LA in which a lens surface LAs1 on the object side has an aspherical shape. In the present specification, the “amount of sag” of a surface at a height refers to a distance in the optical axis direction between a plane perpendicular to the optical axis Z and passing through an intersection between the surface and the optical axis Z and a point on the surface at the height. For example, FIG. 5 shows an amount of sag sagA of the lens surface LAs1 at a height H7 of 70% of a maximum effective radius of the lens surface LAs1. In FIG. 5, a plane VP perpendicular to the optical axis Z and passing through an intersection between the lens surface LAs1 and the optical axis Z is indicated by a double dot dashed line.

A “paraxial curvature spherical surface” of a lens surface refers to a spherical surface that has the same curvature radius as a curvature radius of the lens surface in a paraxial region and that passes through an intersection between the lens surface and the optical axis Z. For example, FIG. 5 shows a paraxial curvature spherical surface Sp of the lens surface LAs1 with a broken line and an amount of sag sagSp of the paraxial curvature spherical surface Sp at the height H7. Since the asphericity Δsag is a difference between the amount of sag of the lens surface and the amount of sag of the paraxial curvature spherical surface of the lens surface, the asphericity Δsag of the lens surface LAs1 at the height H7 is a difference between sagSp and sagA as shown in FIG. 5. While FIG. 5 shows the asphericity Δsag for the lens surface LAs1 on the object side, the asphericity Δsag can also be considered for a lens surface LAs2 on the image side of the aspherical lens LA.

In a case where the zoom lens includes at least one lens group having negative refractive power, the most-object-side aspherical lens is preferably disposed as follows. Particularly, the most-object-side aspherical lens satisfying Conditional Expression (10) is preferably disposed as follows. The most-object-side aspherical lens is preferably a third lens from the object side in the lens group having negative refractive power closest to the object side among the lens groups having negative refractive power and included in the zoom lens. Such disposition provides an advantage in reducing spherical aberration at the telephoto end while reducing fluctuation of off-axis aberration during zooming. Alternatively, the most-object-side aspherical lens is preferably a fourth lens from the object side in the lens group having negative refractive power closest to the object side among the lens groups having negative refractive power and included in the zoom lens. Such disposition provides an advantage in reducing spherical aberration at the telephoto end.

In a configuration in which the zoom lens includes at least one negative lens, the zoom lens preferably satisfies Conditional Expression (11). A refractive index with respect to a d line for the negative lens closest to the object side among the negative lenses included in the zoom lens is denoted by Nn1. Ensuring that a corresponding value of Conditional Expression (11) is not less than or equal to its lower limit value provides an advantage in reducing field curvature. Ensuring that the corresponding value of Conditional Expression (11) is not greater than or equal to its upper limit value enables selection of a material having a low degree of wear and thus, provides an advantage in improving robustness.

$$1.59 < Nn 1 < 1.99 \qquad ( 11 )$$

To obtain more favorable characteristics, the lower limit value of Conditional Expression (11) is more preferably 1.7, further preferably 1.75, and still more preferably 1.8. To obtain more favorable characteristics, the upper limit value of Conditional Expression (11) is more preferably 1.96, further preferably 1.87, and still more preferably 1.85. For example, the zoom lens more preferably satisfies Conditional Expression (11-1), further preferably satisfies Conditional Expression (11-2), and still more preferably satisfies Conditional Expression (11-3).

$$1.7 < Nn 1 < 1.96 \qquad ( 11 - 1 )$$

$$1.75 < Nn 1 < 1.87 \qquad ( 11 - 2 )$$

$$1.8 < Nn 1 < 1.85 \qquad ( 11 - 3 )$$

In a configuration in which the zoom lens includes at least one negative lens, the zoom lens preferably satisfies Conditional Expression (12). A center thickness of the negative lens closest to the object side among the negative lenses included in the zoom lens and a maximum effective radius of a surface, on the object side, of the negative lens are denoted by Dn1 and Hn1, respectively. For example, FIG. 3 shows the center thickness Dn1 and the maximum effective radius Hn1. Ensuring that a corresponding value of Conditional Expression (12) is not less than or equal to its lower limit value provides an advantage in improving robustness. Ensuring that the corresponding value of Conditional Expression (12) is not greater than or equal to its upper limit value provides an advantage in weight reduction.

$$0.02 < Dn 1 / Hn 1 < 0.087 \qquad ( 12 )$$

To obtain more favorable characteristics, the lower limit value of Conditional Expression (12) is more preferably 0.03, further preferably 0.04, and still more preferably 0.048. To obtain more favorable characteristics, the upper limit value of Conditional Expression (12) is more preferably 0.082, further preferably 0.07, and still more preferably 0.053. For example, the zoom lens more preferably satisfies Conditional Expression (12-1), further preferably satisfies Conditional Expression (12-2), and still more preferably satisfies Conditional Expression (12-3).

$$0.03 < Dn 1 / Hn 1 < 0.082 \qquad ( 12 - 1 )$$

$$0.04 < Dn 1 / Hn 1 < 0.07 \qquad ( 12 - 2 )$$

$$0.048 < Dn 1 / Hn 1 < 0.053 \qquad ( 12 - 3 )$$

In a configuration in which the zoom lens includes at least one lens group having negative refractive power, and the lens group having negative refractive power closest to the object side among the lens groups having negative refractive power and included in the zoom lens includes at least one negative lens, the zoom lens preferably satisfies Conditional Expression (13). A center thickness of the negative lens closest to the object side among the negative lenses included in the lens group having negative refractive power closest to the object side and a maximum effective radius of a surface, on the object side, of the negative lens are denoted by Dn2 and Hn2, respectively. For example, FIG. 3 shows the center thickness Dn2 and the maximum effective radius Hn2. Ensuring that a corresponding value of Conditional Expression (13) is not less than or equal to its lower limit value provides an advantage in improving robustness. Ensuring that the corresponding value of Conditional Expression (13) is not greater than or equal to its upper limit value provides an advantage in weight reduction.

$$0.02 < Dn 2 / Hn 2 < 0.105 \qquad ( 13 )$$

To obtain more favorable characteristics, the lower limit value of Conditional Expression (13) is more preferably 0.03, further preferably 0.035, and still more preferably 0.041. To obtain more favorable characteristics, the upper limit value of Conditional Expression (13) is more preferably 0.073, further preferably 0.06, and still more preferably 0.045. For example, the zoom lens more preferably satisfies Conditional Expression (13-1), further preferably satisfies Conditional Expression (13-2), and still more preferably satisfies Conditional Expression (13-3).

$$0.03 < Dn 2 / Hn 2 < 0.073 \qquad ( 13 - 1 )$$

$$0.035 < Dn 2 / Hn 2 < 0.06 \qquad ( 13 - 2 )$$

$$0.041 < Dn 2 / Hn 2 < 0.045 \qquad ( 13 - 3 )$$

In a case where a focal length of a lens group disposed adjacent to the object side of the final lens group GE is denoted by fFE, the zoom lens preferably satisfies Conditional Expression (14). Ensuring that a corresponding value of Conditional Expression (14) is not less than or equal to its lower limit value reduces a height of the off-axis luminous flux incident on the final lens group GE and thus, provides an advantage in reducing a weight of the final lens group GE. Ensuring that the corresponding value of Conditional Expression (14) is not greater than or equal to its upper limit value increases a degree of separation between an on-axis ray and an off-axis ray in the final lens group GE and thus, provides an advantage in reducing off-axis aberration.

$$- 0.8 < fw / fF E < 0.4 \qquad ( 14 )$$

To obtain more favorable characteristics, the lower limit value of Conditional Expression (14) is more preferably −0.7, further preferably −0.6, and still more preferably −0.56. To obtain more favorable characteristics, the upper limit value of Conditional Expression (14) is more preferably 0, further preferably −0.32, and still more preferably −0.45. For example, the zoom lens more preferably satisfies Conditional Expression (14-1), further preferably satisfies Conditional Expression (14-2), and still more preferably satisfies Conditional Expression (14-3).

$$- 0.7 < fw / fF E < 0 \qquad ( 14 - 1 )$$

$$- 0.6 < fw / fF E < - 0.32 \qquad ( 14 - 2 )$$

$$- 0.56 < fw / fF E < - 0.45 \qquad ( 14 - 3 )$$

In a configuration in which the zoom lens includes the aperture stop St, the zoom lens preferably satisfies Conditional Expression (15). In a case where the aperture stop St is included in a lens group, a refractive index with respect to a d line for a positive lens closest to the image side among positive lenses included in the lens group including the aperture stop St is denoted by NStp. In a case where the aperture stop St is not included in a lens group, a refractive index with respect to a d line for a positive lens closest to the image side among positive lenses included in a lens group adjacent to the image side of the aperture stop St is denoted by NStp. Ensuring that a corresponding value of Conditional Expression (15) is not less than or equal to its lower limit value provides advantage in reducing spherical aberration. Ensuring that the corresponding value of Conditional Expression (15) is not greater than or equal to its upper limit value reduces sensitivity to surface shape error of the positive lens and thus, provides an advantage in improving manufacturability.

$$1.43 < NStp < 1.89 \qquad ( 15 )$$

To obtain more favorable characteristics, the lower limit value of Conditional Expression (15) is more preferably 1.49, further preferably 1.65, and still more preferably 1.71. To obtain more favorable characteristics, the upper limit value of Conditional Expression (15) is more preferably 1.89, further preferably 1.87, and still more preferably 1.85. For example, the zoom lens more preferably satisfies Conditional Expression (15-1), further preferably satisfies Conditional Expression (15-2), and still more preferably satisfies Conditional Expression (15-3).

$$1.49 < NStp < 1.89 \qquad ( 15 - 1 )$$

$$1.65 < NStp < 1.87 \qquad ( 15 - 2 )$$

$$1.71 < NStp < 1.85 \qquad ( 15 - 3 )$$

In the present specification, the “lens group including the aperture stop St” refers to a lens group that includes at least one lens adjacent to the aperture stop St and that shows the same action as the aperture stop St during zooming. The “case where the aperture stop St is included in the lens group” refers to a case where the “lens group including the aperture stop St” is present. For example, in the example of FIG. 1, the third lens group G3 is the “lens group including the aperture stop St”, and the example of FIG. 1 shows the zoom lens in a case where the aperture stop St is included in the lens group. The “case where the aperture stop St is not included in the lens group” refers to a case where the “lens group including the aperture stop St” is not present. That is, in the “case where the aperture stop St is not included in the lens group”, any of lenses, on the object side and the image side, adjacent to the aperture stop St does not show the same action as the aperture stop St during zooming. For example, Example 4 described later shows the zoom lens in a case where the aperture stop St is not included in the lens group. The “same action” includes not only unified moving but also remaining stationary with respect to the image plane Sim. In the present specification, the “unified moving” means moving at the same time by the same amount in the same direction.

In a case where an average value of refractive indices with respect to a d line for all lenses included in the first lens group G1 is denoted by N1ave, the zoom lens preferably satisfies Conditional Expression (16). Ensuring that a corresponding value of Conditional Expression (16) is not less than or equal to its lower limit value provides an advantage in reducing field curvature. Ensuring that the corresponding value of Conditional Expression (16) is not greater than or equal to its upper limit value enables selection of a material having a low relative density and thus, provides an advantage in reducing a weight of the first lens group G1.

$$1.6 < N 1 ave < 1.9 \qquad ( 16 )$$

To obtain more favorable characteristics, the lower limit value of Conditional Expression (16) is more preferably 1.65, further preferably 1.68, and still more preferably 1.7. To obtain more favorable characteristics, the upper limit value of Conditional Expression (16) is more preferably 1.86, further preferably 1.78, and still more preferably 1.76. For example, the zoom lens more preferably satisfies Conditional Expression (16-1), further preferably satisfies Conditional Expression (16-2), and still more preferably satisfies Conditional Expression (16-3).

$$1.65 < N 1 ave < 1.86 \qquad ( 16 - 1 )$$

$$1.68 < N 1 ave < 1.78 \qquad ( 16 - 2 )$$

$$1.7 < N 1 ave < 1.76 \qquad ( 16 - 3 )$$

The zoom lens preferably satisfies Conditional Expression (17). A lateral magnification of the final lens group GE in a state where the infinite distance object is in focus at the telephoto end is denoted by βEt. A lateral magnification of a lens group adjacent to the object side of the final lens group GE in the state where the infinite distance object is in focus at the telephoto end is denoted by βFEt. Ensuring that a corresponding value of Conditional Expression (17) is not less than or equal to its lower limit value provides an advantage in reducing a weight of the lens group adjacent to the object side of the final lens group GE. Ensuring that the corresponding value of Conditional Expression (17) is not greater than or equal to its upper limit value provides an advantage in reducing fluctuation of aberration that occurs in the lens group adjacent to the object side of the final lens group GE during zooming.

$$0.14 < β E t \times β F E t < 2.2 \qquad ( 17 )$$

To obtain more favorable characteristics, the lower limit value of Conditional Expression (17) is more preferably 0.7, further preferably 1.1, and still more preferably 1.3. To obtain more favorable characteristics, the upper limit value of Conditional Expression (17) is more preferably 2.15, further preferably 2.05, and still more preferably 1.99. For example, the zoom lens more preferably satisfies Conditional Expression (17-1), further preferably satisfies Conditional Expression (17-2), and still more preferably satisfies Conditional Expression (17-3).

$$0.7 < β E t \times β F E t < 2.15 \qquad ( 17 - 1 )$$

$$1.1 < β Et \times β FEt < 2 \text{.05} \qquad ( 17 - 2 )$$

$$1.3 < β E t \times β F E t < 1.99 \qquad ( 17 - 3 )$$

In a configuration in which the zoom lens includes at least one lens group having negative refractive power, the zoom lens preferably satisfies Conditional Expression (18). A minimum value of Abbe numbers based on a d line for all lenses included in the lens group having negative refractive power closest to the object side among the lens groups having negative refractive power and included in the zoom lens is denoted by νNmin. Ensuring that a corresponding value of Conditional Expression (18) is not less than or equal to its lower limit value provides an advantage in reducing fluctuation of lateral chromatic aberration during zooming. Ensuring that the corresponding value of Conditional Expression (18) is not greater than or equal to its upper limit value provides an advantage in reducing axial chromatic aberration at the telephoto end.

$$15 < vNmin < 25.6 \qquad ( 18 )$$

To obtain more favorable characteristics, the lower limit value of Conditional Expression (18) is more preferably 16.5, further preferably 17, and still more preferably 17.5. To obtain more favorable characteristics, the upper limit value of Conditional Expression (18) is more preferably 24.5, further preferably 23.7, and still more preferably 20.4. For example, the zoom lens more preferably satisfies Conditional Expression (18-1), further preferably satisfies Conditional Expression (18-2), and still more preferably satisfies Conditional Expression (18-3).

$$16.5 < vNmin < 24.5 \qquad ( 18 - 1 )$$

$$17 < vNmin < 23.7 \qquad ( 18 - 2 )$$

$$17.5 < vNmin < 20.4 \qquad ( 18 - 3 )$$

In a configuration in which the zoom lens includes the aperture stop St, the zoom lens preferably satisfies Conditional Expression (19). In a case where the aperture stop St is included in a lens group, a focal length of the lens group including the aperture stop St is denoted by fGSt. In a case where the aperture stop St is not included in a lens group, a focal length of a lens group adjacent to the image side of the aperture stop St is denoted by fGSt. Ensuring that a corresponding value of Conditional Expression (19) is not less than or equal to its lower limit value provides an advantage in size reduction. Ensuring that the corresponding value of Conditional Expression (19) is not greater than or equal to its upper limit value provides an advantage in reducing a change in aberration caused by error during assembly.

$$0.3 < fw / fGSt < 1.3 \qquad ( 19 )$$

To obtain more favorable characteristics, the lower limit value of Conditional Expression (19) is more preferably 0.42, further preferably 0.55, and still more preferably 0.82. To obtain more favorable characteristics, the upper limit value of Conditional Expression (19) is more preferably 1.1, further preferably 1.03, and still more preferably 0.99. For example, the zoom lens more preferably satisfies Conditional Expression (19-1), further preferably satisfies Conditional Expression (19-2), and still more preferably satisfies Conditional Expression (19-3).

$$0.42 < fw / fGSt < 1.1 \qquad ( 19 - 1 )$$

$$0.55 < fw / fGSt < 1.03 \qquad ( 19 - 2 )$$

$$0.82 < fw / fGSt < 0.99 \qquad ( 19 - 3 )$$

In a configuration in which the zoom lens includes at least one lens group having negative refractive power, the zoom lens preferably satisfies Conditional Expression (31). Ensuring that a corresponding value of Conditional Expression (31) is not less than or equal to its lower limit value provides an advantage in obtaining a high zoom ratio. Ensuring that the corresponding value of Conditional Expression (31) is not greater than or equal to its upper limit value provides an advantage in size reduction.

$$- 1 < fN / fGSt < - 0.28 \qquad ( 31 )$$

To obtain more favorable characteristics, the lower limit value of Conditional Expression (31) is more preferably −0.9, further preferably −0.8, and still more preferably −0.74. To obtain more favorable characteristics, the upper limit value of Conditional Expression (31) is more preferably −0.37, further preferably −0.45, and still more preferably −0.54. For example, the zoom lens more preferably satisfies Conditional Expression (31-1), further preferably satisfies Conditional Expression (31-2), and still more preferably satisfies Conditional Expression (31-3).

$$- 0.9 < fN / fGSt < - 0.37 \qquad ( 31 - 1 )$$

$$- 0.8 < fN / fGSt < - 0.45 \qquad ( 31 - 2 )$$

$$- 0.7 \; 4 < fN / fGSt < - 0.54 \qquad ( 31 - 3 )$$

In a configuration in which the zoom lens includes at least one lens group having negative refractive power, the zoom lens preferably satisfies Conditional Expression (20). Ensuring that a corresponding value of Conditional Expression (20) is not less than or equal to its lower limit value provides an advantage in reducing a change in aberration caused by error during assembly. Ensuring that the corresponding value of Conditional Expression (20) is not greater than or equal to its upper limit value provides an advantage in obtaining a high zoom ratio.

$$- 2.5 < f w / fN < - 0.8 \qquad ( 20 )$$

To obtain more favorable characteristics, the lower limit value of Conditional Expression (20) is more preferably −2.1, further preferably −1.9, and still more preferably −1.7. To obtain more favorable characteristics, the upper limit value of Conditional Expression (20) is more preferably −1.1, further preferably −1.23, and still more preferably −1.26. For example, the zoom lens more preferably satisfies Conditional Expression (20-1), further preferably satisfies Conditional Expression (20-2), and still more preferably satisfies Conditional Expression (20-3).

$$- 2.1 < f w / fN < - 1.1 \qquad ( 20 - 1 )$$

$$- 1.9 < f w / fN < - 1.23 \qquad ( 20 - 2 )$$

$$- 1.7 < f w / fN < - 1.26 \qquad ( 20 - 3 )$$

In a configuration in which the zoom lens includes at least one lens group having negative refractive power, the zoom lens preferably satisfies Conditional Expression (35). Ensuring that a corresponding value of Conditional Expression (35) is not less than or equal to its lower limit value provides an advantage in reducing a length from the first lens group G1 to the lens group having negative refractive power closest to the object side among the lens groups included in the zoom lens. Ensuring that the corresponding value of Conditional Expression (35) is not greater than or equal to its upper limit value provides an advantage in achieving a wide angle.

$$0.1 < \vert fN / fl \vert < 0.35 \qquad ( 35 )$$

To obtain more favorable characteristics, the lower limit value of Conditional Expression (35) is more preferably 0.12, further preferably 0.14, and still more preferably 0.17. To obtain more favorable characteristics, the upper limit value of Conditional Expression (35) is more preferably 0.3, further preferably 0.27, and still more preferably 0.25. For example, the zoom lens more preferably satisfies Conditional Expression (35-1), further preferably satisfies Conditional Expression (35-2), and still more preferably satisfies Conditional Expression (35-3).

$$0.12 < \vert fN / f 1 \vert < 0.3 \qquad ( 35 - 1 )$$

$$0.14 < \vert fN / f 1 \vert < 0.27 \qquad ( 35 - 2 )$$

$$0.17 < \vert fN / f 1 \vert < 0.25 \qquad ( 35 - 3 )$$

In a configuration in which the zoom lens includes the focus group, the zoom lens preferably satisfies Conditional Expression (27). A focal length of the focus group is denoted by ffoc. Ensuring that a corresponding value of Conditional Expression (27) is not less than or equal to its lower limit value can reduce a moving amount of the focus group during focusing and thus, provides an advantage in reducing the total length. Ensuring that the corresponding value of Conditional Expression (27) is not greater than or equal to its upper limit value provides an advantage in reducing error sensitivity of the focus group.

$$0.25 < fw / \vert ffoc \vert < 1.2 \qquad ( 27 )$$

To obtain more favorable characteristics, the lower limit value of Conditional Expression (27) is more preferably 0.3, further preferably 0.35, and still more preferably 0.42. To obtain more favorable characteristics, the upper limit value of Conditional Expression (27) is more preferably 1, further preferably 0.8, and still more preferably 0.66. For example, the zoom lens more preferably satisfies Conditional Expression (27-1), further preferably satisfies Conditional Expression (27-2), and still more preferably satisfies Conditional Expression (27-3).

$$0.3 < fw / \vert ffoc \vert < 1 \qquad ( 27 - 1 )$$

$$0.35 < fw / \vert ffoc \vert < 0.8 \qquad ( 27 - 2 )$$

$$0.42 < fw / \vert ffoc \vert < 0.66 \qquad ( 27 - 3 )$$

In a configuration in which the zoom lens includes the focus group, the zoom lens preferably satisfies Conditional Expression (21). A lateral magnification of the focus group in the state where the infinite distance object is in focus at the wide angle end is denoted by βfw. A combined lateral magnification of all lenses on the image side with respect to the focus group in the state where the infinite distance object is in focus at the wide angle end is denoted by βfRw. In addition, γw is defined as γw=(1−βfw²)×βfRw². Ensuring that a corresponding value of Conditional Expression (21) is not less than or equal to its lower limit value can reduce the moving amount of the focus group during focusing and thus, provides an advantage in reducing the total length. Ensuring that the corresponding value of Conditional Expression (21) is not greater than or equal to its upper limit value provides an advantage in reducing the error sensitivity of the focus group.

$$1.53 < \vert γ w \vert < 5.5 \qquad ( 21 )$$

To obtain more favorable characteristics, the lower limit value of Conditional Expression (21) is more preferably 2, further preferably 2.2, and still more preferably 3.1. To obtain more favorable characteristics, the upper limit value of Conditional Expression (21) is more preferably 5, further preferably 4.5, and still more preferably 4. For example, the zoom lens more preferably satisfies Conditional Expression (21-1), further preferably satisfies Conditional Expression (21-2), and still more preferably satisfies Conditional Expression (21-3).

$$2 < \vert γ w \vert < 5 \qquad ( 21 - 1 )$$

$$2.2 < \vert γ w \vert < 4.5 \qquad ( 21 - 2 )$$

$$3.1 < \vert γ w \vert < 4 \qquad ( 21 - 3 )$$

In a configuration in which the zoom lens includes the focus group, the zoom lens preferably satisfies Conditional Expression (28). A lateral magnification of the focus group in the state where the infinite distance object is in focus at the telephoto end is denoted by βft. A combined lateral magnification of all lenses on the image side with respect to the focus group in the state where the infinite distance object is in focus at the telephoto end is denoted by βfRt. In addition, γt is defined as γt=(1−βft²)×βfRt². Ensuring that a corresponding value of Conditional Expression (28) is not less than or equal to its lower limit value can reduce the moving amount of the focus group during focusing and thus, provides an advantage in reducing the total length. Ensuring that the corresponding value of Conditional Expression (28) is not greater than or equal to its upper limit value provides an advantage in reducing the error sensitivity of the focus group.

$$1.3 < \vert γ t \vert < 4.5 \qquad ( 28 )$$

To obtain more favorable characteristics, the lower limit value of Conditional Expression (28) is more preferably 1.42, further preferably 2, and still more preferably 2.8. To obtain more favorable characteristics, the upper limit value of Conditional Expression (28) is more preferably 4.2, further preferably 3.8, and still more preferably 3.5. For example, the zoom lens more preferably satisfies Conditional Expression (28-1), further preferably satisfies Conditional Expression (28-2), and still more preferably satisfies Conditional Expression (28-3).

$$1.42 < \vert γ t \vert < 4.2 \qquad ( 28 - 1 )$$

$$2 < \vert γ t \vert < 3.8 \qquad ( 28 - 2 )$$

$$2.8 < \vert γ t \vert < 3.5 \qquad ( 28 - 3 )$$

In a configuration in which the zoom lens includes the focus group, the zoom lens preferably satisfies Conditional Expression (29). A combined focal length of all lenses on the image side with respect to the focus group in the state where the infinite distance object is in focus at the telephoto end is denoted by ffRt. A distance on the optical axis from a paraxial exit pupil position to the image plane Sim in the state where the infinite distance object is in focus at the telephoto end is denoted by Dext. A maximum half angle of view in the state where the infinite distance object is in focus at the telephoto end is denoted by ωt. For example, FIG. 1 shows the maximum half angle of view wt. In a case where an optical member not having refractive power is disposed between the paraxial exit pupil position and the image plane Sim, Dext is calculated for the optical member using the air conversion distance. In addition, BRt is defined as BRt={βft/(ffoc×γt)−1/(βfRt×ffRt)−(1/Dext)}. Ensuring that a corresponding value of Conditional Expression (29) is not less than or equal to its lower limit value provides an advantage in size reduction. Ensuring that the corresponding value of Conditional Expression (29) is not greater than or equal to its upper limit value can reduce fluctuation of the angle of view during focusing at the telephoto end.

$$0.001 < \vert BRt \times ( ft \times tan ω t ) \vert < 0.08 \qquad ( 29 )$$

To obtain more favorable characteristics, the lower limit value of Conditional Expression (29) is more preferably 0.003, further preferably 0.005, and still more preferably 0.008. To obtain more favorable characteristics, the upper limit value of Conditional Expression (29) is more preferably 0.042, further preferably 0.025, and still more preferably 0.017. For example, the zoom lens more preferably satisfies Conditional Expression (29-1), further preferably satisfies Conditional Expression (29-2), and still more preferably satisfies Conditional Expression (29-3).

$$0.003 < \vert BRt \times ( ft \times tan ω t ) \vert < 0.042 \qquad ( 29 - 1 )$$

$$0.005 < \vert BRt \times ( ft \times tan ω t ) \vert < 0.025 \qquad ( 29 - 2 )$$

$$0.008 < \vert BRt \times ( ft \times tan ω t ) \vert < 0.017 \qquad ( 29 - 3 )$$

In a configuration in which the zoom lens includes the vibration-proof group, the zoom lens preferably satisfies Conditional Expression (30). A focal length of the vibration-proof group is denoted by fIS. Ensuring that a corresponding value of Conditional Expression (30) is not less than or equal to its lower limit value can reduce a moving amount of the vibration-proof group during image shake correction and thus, provides an advantage in reducing a diameter of a lens barrel. Ensuring that the corresponding value of Conditional Expression (30) is not greater than or equal to its upper limit value provides an advantage in reducing aberration that occurs in the vibration-proof group.

$$0.4 < ft / \vert fIS \vert < 2 \qquad ( 30 )$$

To obtain more favorable characteristics, the lower limit value of Conditional Expression (30) is more preferably 0.5, further preferably 0.6, and still more preferably 0.7. To obtain more favorable characteristics, the upper limit value of Conditional Expression (30) is more preferably 1.5, further preferably 1.3, and still more preferably 1.07. For example, the zoom lens more preferably satisfies Conditional Expression (30-1), further preferably satisfies Conditional Expression (30-2), and still more preferably satisfies Conditional Expression (30-3).

$$0.5 < ft / \vert fIS \vert < 1.5 \qquad ( 30 - 1 )$$

$$0.6 < ft / \vert fIS \vert < 1.3 \qquad ( 30 - 2 )$$

$$0.7 < ft / \vert fIS \vert < 1.07 \qquad ( 30 - 3 )$$

In a configuration in which the zoom lens includes the vibration-proof group, the zoom lens preferably satisfies Conditional Expression (32). Ensuring that a corresponding value of Conditional Expression (32) is not less than or equal to its lower limit value provides an advantage in reducing the total length. Ensuring that the corresponding value of Conditional Expression (32) is not greater than or equal to its upper limit value can reduce the moving amount of the vibration-proof group during image shake correction and thus, provides an advantage in reducing the diameter of the lens barrel.

$$1.2 < \vert fIS / fGSt \vert < 4 \qquad ( 32 )$$

To obtain more favorable characteristics, the lower limit value of Conditional Expression (32) is more preferably 1.8, further preferably 2.3, and still more preferably 2.6. To obtain more favorable characteristics, the upper limit value of Conditional Expression (32) is more preferably 3.6, further preferably 3.3, and still more preferably 2.8. For example, the zoom lens more preferably satisfies Conditional Expression (32-1), further preferably satisfies Conditional Expression (32-2), and still more preferably satisfies Conditional Expression (32-3).

$$1.8 < \vert fIS / fGSt \vert < 3.6 \qquad ( 32 - 1 )$$

$$2.3 < \vert fIS / fGSt \vert < 3.3 \qquad ( 32 - 2 )$$

$$2.6 < \vert fIS / fGSt \vert < 2.8 \qquad ( 32 - 3 )$$

In a configuration in which the zoom lens includes the vibration-proof group, the zoom lens preferably satisfies Conditional Expression (22). A lateral magnification of the vibration-proof group in the state where the infinite distance object is in focus at the telephoto end is denoted by βISt. A combined lateral magnification of all lenses on the image side with respect to the vibration-proof group in the state where the infinite distance object is in focus at the telephoto end is denoted by βISRt. Ensuring that a corresponding value of Conditional Expression (22) is not less than or equal to its lower limit value can reduce the moving amount of the vibration-proof group during image shake correction and thus, provides an advantage in reducing the diameter of the lens barrel. Ensuring that the corresponding value of Conditional Expression (22) is not greater than or equal to its upper limit value provides an advantage in reducing aberration that occurs in the vibration-proof group.

$$0.5 < \vert ( 1 - β ISt ) \times β ISRt \vert < 2 \qquad ( 22 )$$

To obtain more favorable characteristics, the lower limit value of Conditional Expression (22) is more preferably 0.6, further preferably 0.7, and still more preferably 0.8. To obtain more favorable characteristics, the upper limit value of Conditional Expression (22) is more preferably 1.5, further preferably 1.3, and still more preferably 1.05. For example, the zoom lens more preferably satisfies Conditional Expression (22-1), further preferably satisfies Conditional Expression (22-2), and still more preferably satisfies Conditional Expression (22-3).

$$0.6 < \vert ( 1 - β ISt ) \times β ISRt \vert < 1.5 \qquad ( 22 - 1 )$$

$$0.7 < \vert ( 1 - β ISt ) \times β ISRt \vert < 1.3 \qquad ( 22 - 2 )$$

$$0.8 < \vert ( 1 - β ISt ) \times β ISRt \vert < 1.05 \qquad ( 22 - 3 )$$

In a case where a focal length of the whole system in the state where the infinite distance object is in focus at the telephoto end is denoted by ft, the zoom lens preferably satisfies Conditional Expression (23). Ensuring that a corresponding value of Conditional Expression (23) is not less than or equal to its lower limit value can secure a space for movement of a lens group during zooming and thus, provides an advantage in achieving a high zoom ratio. Ensuring that the corresponding value of Conditional Expression (23) is not greater than or equal to its upper limit value can reduce the total length and thus, provides an advantage in size reduction.

$$1.5 < TLw / ft < 3.8 \qquad ( 23 )$$

To obtain more favorable characteristics, the lower limit value of Conditional Expression (23) is more preferably 1.75, further preferably 1.9, and still more preferably 2.1. To obtain more favorable characteristics, the upper limit value of Conditional Expression (23) is more preferably 3.4, further preferably 3.1, and still more preferably 2.9. For example, the zoom lens more preferably satisfies Conditional Expression (23-1), further preferably satisfies Conditional Expression (23-2), and still more preferably satisfies Conditional Expression (23-3).

$$1.75 < TLw / ft < 3.4 \qquad ( 23 - 1 )$$

$$1.9 < TLw / ft < 3.1 \qquad ( 23 - 2 )$$

$$2.1 < TLw / ft < 2.9 \qquad ( 23 - 3 )$$

The zoom lens preferably satisfies Conditional Expression (24). Ensuring that a corresponding value of Conditional Expression (24) is not less than or equal to its lower limit value provides an advantage in obtaining a high zoom ratio. Ensuring that the corresponding value of Conditional Expression (24) is not greater than or equal to its upper limit value provides an advantage in size reduction.

$$1.9 < ft / fw < 6 \qquad ( 24 )$$

To obtain more favorable characteristics, the lower limit value of Conditional Expression (24) is more preferably 2.1, further preferably 2.3, and still more preferably 2.5. To obtain more favorable characteristics, the upper limit value of Conditional Expression (24) is more preferably 4.5, further preferably 3.5, and still more preferably 3. For example, the zoom lens more preferably satisfies Conditional Expression (24-1), further preferably satisfies Conditional Expression (24-2), and still more preferably satisfies Conditional Expression (24-3).

$$2.1 < ft / fw < 4.5 \qquad ( 24 - 1 )$$

$$2.3 < ft / fw < 3.5 \qquad ( 24 - 2 )$$

$$2.5 < ft / fw < 3 \qquad ( 24 - 3 )$$

The zoom lens preferably satisfies Conditional Expression (25). Here, ωw is in degree units. Ensuring that a corresponding value of Conditional Expression (25) is not less than or equal to its lower limit value provides an advantage in achieving a wide angle. Ensuring that the corresponding value of Conditional Expression (25) is not greater than or equal to its upper limit value can reduce a height of a ray passing through the first lens group G1 and thus, provides an advantage in diameter reduction.

$$25 < ω w < 58 \qquad ( 25 )$$

To obtain more favorable characteristics, the lower limit value of Conditional Expression (25) is more preferably 30, further preferably 34, and still more preferably 36. To obtain more favorable characteristics, the upper limit value of Conditional Expression (25) is more preferably 53, further preferably 49, and still more preferably 45. For example, the zoom lens more preferably satisfies Conditional Expression (25-1), further preferably satisfies Conditional Expression (25-2), and still more preferably satisfies Conditional Expression (25-3).

$$30 < ω w < 53 \qquad ( 25 - 1 )$$

$$34 < ω w < 49 \qquad ( 25 - 2 )$$

$$36 < ω w < 45 \qquad ( 25 - 3 )$$

The zoom lens preferably satisfies Conditional Expression (26). A distance on the optical axis from a lens surface closest to the object side to a paraxial entrance pupil position in the state where the infinite distance object is in focus at the wide angle end is denoted by Denp. Ensuring that a corresponding value of Conditional Expression (26) is not less than or equal to its lower limit value facilitates separation between the on-axis luminous flux and the off-axis luminous flux in the first lens group G1 and thus, provides an advantage in correcting lateral chromatic aberration. Ensuring that the corresponding value of Conditional Expression (26) is not greater than or equal to its upper limit value causes an entrance pupil to be positioned closer to the object side and thus, can reduce a height of an off-axis ray passing through the first lens group G1. This provides an advantage in diameter reduction and weight reduction.

$$0.6 < Denp / fw < 2 \qquad ( 26 )$$

To obtain more favorable characteristics, the lower limit value of Conditional Expression (26) is more preferably 0.78, further preferably 0.86, and still more preferably 1. To obtain more favorable characteristics, the upper limit value of Conditional Expression (26) is more preferably 1.7, further preferably 1.5, and still more preferably 1.41. For example, the zoom lens more preferably satisfies Conditional Expression (26-1), further preferably satisfies Conditional Expression (26-2), and still more preferably satisfies Conditional Expression (26-3).

$$0.78 < Denp / fw < 1.7 \qquad ( 26 - 1 )$$

$$0.86 < Denp / fw < 1.5 \qquad ( 26 - 2 )$$

$$1 < Denp / fw < 1.41 \qquad ( 26 - 3 )$$

The zoom lens preferably satisfies Conditional Expression (33). An open F-number in the state where the infinite distance object is in focus at the telephoto end is denoted by FNot. An open F-number in the state where the infinite distance object is in focus at the wide angle end is denoted by FNow. Ensuring that a corresponding value of Conditional Expression (33) is not less than or equal to its lower limit value can reduce a diameter of the on-axis luminous flux at the telephoto end and thus, provides an advantage in size reduction and weight reduction of the lens. Ensuring that the corresponding value of Conditional Expression (33) is not greater than or equal to its upper limit value can reduce fluctuation of brightness of an optical image caused by zooming.

$$0.5 < FNot / FNow < 2 \qquad ( 33 )$$

To obtain more favorable characteristics, the lower limit value of Conditional Expression (33) is more preferably 0.6, further preferably 0.7, and still more preferably 0.8. To obtain more favorable characteristics, the upper limit value of Conditional Expression (33) is more preferably 1.5, further preferably 1.3, and still more preferably 1.05. For example, the zoom lens more preferably satisfies Conditional Expression (33-1), further preferably satisfies Conditional Expression (33-2), and still more preferably satisfies Conditional Expression (33-3).

$$0.6 < FNot / FNow < 1.5 \qquad ( 33 - 1 )$$

$$0.7 < FNot / FNow < 1.3 \qquad ( 33 - 2 )$$

$$0.8 < FNot / FNow < 1.05 \qquad ( 33 - 3 )$$

The zoom lens preferably satisfies Conditional Expression (34). A distance on the optical axis from the paraxial exit pupil position to the image plane Sim in the state where the infinite distance object is in focus at the wide angle end is denoted by Dexw. In a case where an optical member not having refractive power is disposed between the paraxial exit pupil position and the image plane Sim, Dexw is calculated for the optical member using the air conversion distance. Ensuring that a corresponding value of Conditional Expression (34) is not less than or equal to its lower limit value can cause a paraxial exit pupil to be positioned closer to the image side and thus, provides an advantage in size reduction. Ensuring that the corresponding value of Conditional Expression (34) is not greater than or equal to its upper limit value can cause the paraxial exit pupil to be positioned closer to the object side and thus, provides an advantage in securing the light quantity in the edge part.

$$0.08 < ( fw \times tan ω w ) / Dexw < 0.36 \qquad ( 34 )$$

To obtain more favorable characteristics, the lower limit value of Conditional Expression (34) is more preferably 0.105, further preferably 0.125, and still more preferably 0.15. To obtain more favorable characteristics, the upper limit value of Conditional Expression (34) is more preferably 0.3, further preferably 0.27, and still more preferably 0.24. For example, the zoom lens more preferably satisfies Conditional Expression (34-1), further preferably satisfies Conditional Expression (34-2), and still more preferably satisfies Conditional Expression (34-3).

$$0.105 < ( fw \times tan ω w ) / Dexw < 0.3 \qquad ( 34 - 1 )$$

$$0.125 < ( fw \times tan ω w ) / Dexw < 0.27 \qquad ( 34 - 2 )$$

$$0.15 < ( fw \times tan ω w ) / Dexw < 0 \text{.24} \qquad ( 34 - 3 )$$

The zoom lens preferably satisfies Conditional Expression (36). A maximum diameter of the on-axis luminous flux at a position of the aperture stop St in the state where the infinite distance object is in focus at the wide angle end is denoted by φSw. A maximum diameter of the on-axis luminous flux at the position of the aperture stop St in the state where the infinite distance object is in focus at the telephoto end is denoted by φSt. Ensuring that a corresponding value of Conditional Expression (36) is not less than or equal to its lower limit value can reduce an increase in the diameter of the on-axis luminous flux at the telephoto end and thus, provides an advantage in reducing the diameter of the lens barrel. Ensuring that the corresponding value of Conditional Expression (36) is not greater than or equal to its upper limit value provides an advantage in correcting fluctuation of spherical aberration caused by a change in the diameter of the on-axis luminous flux in a group adjacent to the aperture stop St during zooming.

$$0.5 < φ Sw / φ St < 2 \qquad ( 36 )$$

To obtain more favorable characteristics, the lower limit value of Conditional Expression (36) is more preferably 0.6, further preferably 0.7, and still more preferably 0.8. To obtain more favorable characteristics, the upper limit value of Conditional Expression (36) is more preferably 1.5, further preferably 1.3, and still more preferably 1.05. For example, the zoom lens more preferably satisfies Conditional Expression (36-1), further preferably satisfies Conditional Expression (36-2), and still more preferably satisfies Conditional Expression (36-3).

$$0.6 < φ Sw / φ St < 1.5 \qquad ( 36 - 1 )$$

$$0 \text{.7} < φ Sw / φ St < 1.3 \qquad ( 36 - 2 )$$

$$0.8 < φ Sw / φ St < 1.05 \qquad ( 36 - 3 )$$

The zoom lens preferably satisfies Conditional Expression (37). A temperature coefficient of a refractive index with respect to a d line at a temperature of 25° C. for a positive lens included in a cemented lens closest to the object side among cemented lenses included in the final lens group GE is set as (dNp/dT)×10⁻⁶. Here, dNp/dT is in ° C.⁻¹ units. Ensuring that a corresponding value of Conditional Expression (37) is not less than or equal to its lower limit value provides an advantage in correcting fluctuation of off-axis aberration under a change in temperature. Ensuring that the corresponding value of Conditional Expression (37) is not greater than or equal to its upper limit value provides an advantage in reducing excessive correction of fluctuation of off-axis aberration under a change in temperature.

$$- 1 < dNp / dT < 7 \qquad ( 37 )$$

To obtain more favorable characteristics, the lower limit value of Conditional Expression (37) is more preferably 0, further preferably 0.8, and still more preferably 1.9. To obtain more favorable characteristics, the upper limit value of Conditional Expression (37) is more preferably 6, further preferably 4.3, and still more preferably 3.5. For example, the zoom lens more preferably satisfies Conditional Expression (37-1), further preferably satisfies Conditional Expression (37-2), and still more preferably satisfies Conditional Expression (37-3).

$$0 < dNp / dT < 6 \qquad ( 37 - 1 )$$

$$0.8 < dNp / dT < 4.3 \qquad ( 37 - 2 )$$

$$1.9 < dNp / dT < 3.5 \qquad ( 37 - 3 )$$

The preferable configurations and available configurations including the configurations related to the conditional expressions can be combined without contradiction and are preferably appropriately selected and adopted in accordance with required specifications. Various modifications can be made to the zoom lens of the present disclosure without departing from the gist of the disclosed technology. For example, the number of lens groups included in the intermediate group GM may be different from the number in the above example. The number of lenses included in each lens group in the first lens group G1, the final lens group GE, and the intermediate group GM, the vibration-proof group, and the focus group may be different from the number in the above example.

For example, in a preferable aspect of the zoom lens of the present disclosure, the zoom lens comprises the first lens group G1 positioned closest to the object side, the intermediate group GM including a plurality of lens groups, and the final lens group GE positioned closest to the image side, in which Conditional Expression (1) is satisfied, during zooming, the first lens group G1 remains stationary with respect to the image plane Sim, a spacing between the first lens group G1 and the intermediate group GM changes, a spacing between the intermediate group GM and the final lens group GE changes, and all spacings between adjacent lens groups in the intermediate group GM change, and the number of lenses included in the first lens group G1 is four or less.

Next, examples of the zoom lens of the present disclosure will be described with reference to the drawings. Reference numerals given to each group in the cross-sectional view of each example are independently used for each example to avoid complication of description and drawings caused by an increase in the number of digits of the reference numerals. Accordingly, a common reference numeral given in the drawings of different examples does not necessarily indicate a common configuration.

### Example 1

A configuration and a moving path of the zoom lens of Example 1 are shown in FIG. 1, and its illustration method and configuration are the same as described above. Thus, duplicate descriptions will be partially omitted. The zoom lens of Example 1 consists of, in order from the object side to the image side, the first lens group G1 having positive refractive power, the second lens group G2 having negative refractive power, the third lens group G3 having positive refractive power, the fourth lens group G4 having negative refractive power, and the fifth lens group G5 having positive refractive power. The intermediate group GM consists of the second lens group G2, the third lens group G3, and the fourth lens group G4. The final lens group GE consists of the fifth lens group G5.

During zooming from the wide angle end to the telephoto end, the second lens group G2 and the fourth lens group G4 move along the optical axis Z by changing spacings with respect to adjacent lens groups, and other lens groups remain stationary with respect to the image plane Sim. The focus group consists of the fourth lens group G4. During focusing from the infinite distance object to the nearest object, the focus group moves to the image side. The vibration-proof group consists of three lenses including fourth to sixth lenses from the object side in the third lens group G3.

For the zoom lens of Example 1, Tables 1A and 1B show basic lens data, Table 2 shows specifications and a variable surface spacing, and Table 3 shows aspherical coefficients. The basic lens data is divided and shown in two tables including Tables 1A and 1B to avoid one lengthy table.

The table of the basic lens data is described as follows. A column of “Sn” shows surface numbers in a case where a surface closest to the object side is set as a first surface, and the number is increased by one at a time to the image side. A column of “R” shows a curvature radius of each surface. A column of “D” shows a surface spacing on the optical axis between each surface and a surface adjacent to the image side of each surface. A column of “Nd” shows a refractive index with respect to a d line for each constituent. A column of “νd” shows an Abbe number based on a d line for each constituent. A column of “θg,F” shows a partial dispersion ratio between a g line and an F line for each constituent. A column of “dN/dT” shows a value obtained by multiplying a temperature coefficient of the refractive index with respect to the d line at a temperature of 25° C. for each lens by 10⁶. Here, dN/dT is in ° C.⁻¹ units. A column of “ED” shows a maximum effective diameter of each surface. The maximum effective diameter is twice a maximum effective radius.

In a case where refractive indices of a lens with respect to a g line, an F line, and a C line are denoted by Ng, NF, and NC, respectively, and a partial dispersion ratio between the g line and the F line for the lens is denoted by θg,F, θg,F is defined by the following expression.

$$θ g , F = ( Ng - NF ) / ( NF - NC )$$

In the table of the basic lens data, a sign of the curvature radius of a surface having a convex shape facing the object side is positive, and a sign of the curvature radius of a surface having a convex shape facing the image side is negative. The table of the basic lens data also shows the aperture stop St and the optical member PP. A field of the surface number of a surface corresponding to the aperture stop St shows the surface number and a text (St). A value in a lowermost field of the column of D in Table 1B indicates a spacing between a surface closest to the image side in the table and the image plane Sim. A symbol DD [ ] is used for the variable surface spacing during zooming. A surface number on the object side of the spacing is given within [ ] in the column of the surface spacing.

Table 2 shows a zoom ratio Zr, a focal length f, an open F-number FNo, a maximum full angle of view 2ω, and the variable surface spacing based on a d line. The zoom ratio is synonymous with a zoom magnification. Here, [°] in a field of 2ω indicates that 2ω is in degree units. Table 2 shows each value in the wide angle end state, a middle focal length state, and the telephoto end state in columns labeled “Wide”, “Middle”, and “Tele”, respectively.

In the table of the basic lens data, the surface number of an aspherical surface is marked with *, and a field of the curvature radius of the aspherical surface shows a value of a paraxial curvature radius. In Table 3, a row of Sn shows the surface number of the aspherical surface, and rows of KA and Am (m=3, 4, 5, . . . , 16) show numerical values of the aspherical coefficients for each aspherical surface. Here, “E±n” (n: integer) in the numerical values of the aspherical coefficients in Table 3 means “×10^{±n}”. KA and Am are aspherical coefficients in an aspheric equation represented by the following expression.

$$Z d = C \times {h}^{2} / \{ 1 + {( 1 - KA \times {C}^{2} \times {h}^{2} )}^{1 / 2} \} + Σ A m \times {h}^{m}$$

where
Zd: a depth of the aspherical surface (a length of a perpendicular line drawn from a point on the aspherical surface having a height h to a plane that is in contact with an aspherical surface apex and perpendicular to the optical axis Z)
h: a height (a distance from the optical axis Z to the lens surface)
C: a reciprocal of the paraxial curvature radius
KA and Am: aspherical coefficients
Σ in the aspheric equation means a sum total related to m.

In the data of each table, a degree unit is used for angles, and a millimeter unit is used for lengths. However, since the optical system can also be proportionally enlarged or proportionally reduced to be used, other appropriate units can also be used. Each table below shows numerical values rounded to predetermined digits.

TABLE 1A
Example 1

| | | | | | θg, | dN/ | |
|---|---|---|---|---|---|---|---|
| Sn | R | D | Nd | νd | F | dT | ED |
| 1 | 123.1147 | 2.2200 | 1.84666 | 23.835 | 0.620 | 1.4 | 86.848 |
| 2 | 77.0546 | 1.9800 | | | | | 81.165 |
| 3 | 83.5431 | 8.0700 | 1.59349 | 67.001 | 0.537 | −0.7 | 80.638 |
| 4 | 221.8839 | 0.2300 | | | | | 79.581 |
| 5 | 78.0065 | 8.7900 | 1.72916 | 54.684 | 0.545 | 2.9 | 73.097 |
| 6 | 370.4098 | DD[6] | | | | | 72.028 |
| 7 | 157.9373 | 0.9800 | 1.77250 | 49.598 | 0.552 | 4.1 | 44.573 |
| 8 | 21.8405 | 10.6110 | | | | | 33.691 |
| 9 | −67.3444 | 0.7500 | 1.77250 | 49.598 | 0.552 | 4.1 | 33.153 |
| 10 | 242.3673 | 0.5000 | | | | | 32.419 |
| *11 | 87.2762 | 2.9900 | 1.51654 | 63.849 | 0.541 | 4.1 | 32.019 |
| *12 | 444.2815 | 0.3000 | | | | | 31.587 |
| 13 | 205.3276 | 3.3400 | 1.92286 | 18.897 | 0.650 | 2.1 | 31.386 |
| 14 | −82.6762 | 1.6695 | | | | | 31.01 |
| 15 | −41.4675 | 0.8600 | 1.80400 | 46.574 | 0.558 | 3.7 | 30.830 |
| 16 | −156.3431 | DD[16] | | | | | 30.458 |
| 17 | ∞ | 1.5000 | | | | | 24.729 |
| (St) | | | | | | | |
| 18 | 256.3637 | 1.7600 | 1.80610 | 33.269 | 0.588 | 4.7 | 25.645 |
| 19 | 28.4192 | 3.4800 | 1.72825 | 28.320 | 0.608 | 2.7 | 26.717 |
| 20 | 67.2343 | 0.5800 | | | | | 27.157 |
| *21 | 52.1736 | 6.8600 | 1.49674 | 81.433 | 0.536 | −5.5 | 28.057 |
| *22 | −38.2221 | 2.1784 | | | | | 28.893 |
| 23 | ∞ | 1.0300 | 1.94595 | 17.942 | 0.655 | 2.9 | 31.934 |
| 24 | 75.1999 | 4.1300 | 1.59270 | 35.270 | 0.593 | 0.2 | 32.253 |
| 25 | −118.4665 | 0.1100 | | | | | 32.559 |
| 26 | 357.5599 | 3.0300 | 1.80610 | 33.269 | 0.588 | 4.7 | 32.920 |
| 27 | −106.7334 | 5.3476 | | | | | 33.031 |
| 28 | −35.5914 | 2.1300 | 1.74950 | 35.282 | 0.582 | 5.4 | 30.754 |
| 29 | 100.0080 | 7.7900 | 1.48749 | 70.235 | 0.530 | −0.7 | 33.157 |
| 30 | −34.8489 | 0.1100 | | | | | 34.084 |
| 31 | 227.4149 | 5.2100 | 1.80400 | 46.560 | 0.556 | 4.7 | 35.073 |
| 32 | −51.9580 | DD[32] | | | | | 35.124 |

TABLE 1B
Example 1

| | | | | | θg, | dN/ | |
|---|---|---|---|---|---|---|---|
| Sn | R | D | Nd | νd | F | dT | ED |
| *33 | −34.9718 | 1.8600 | 1.69259 | 53.072 | 0.549 | 3.3 | 31.701 |
| *34 | 97.9734 | 7.6500 | | | | | 32.208 |
| 35 | −56.9527 | 1.5800 | 1.48749 | 70.392 | 0.530 | −1.5 | 34.364 |
| 36 | ∞ | 4.7000 | 1.94595 | 17.942 | 0.655 | 2.9 | 37.489 |
| 37 | −61.1655 | DD[37] | | | | | 38.37 |
| 38 | 54.0802 | 12.3300 | 1.49700 | 81.554 | 0.538 | −6.0 | 50.284 |
| 39 | −78.4389 | 1.5000 | | | | | 50.09 |
| 40 | 68.0310 | 1.9200 | 2.00100 | 29.134 | 0.600 | 4.4 | 45.203 |
| 41 | 30.2109 | 12.4300 | 1.51679 | 64.198 | 0.537 | 2.7 | 41.389 |
| 42 | −109.3154 | 1.3700 | | | | | 40.792 |
| 43 | −75.3207 | 7.3400 | 1.49700 | 81.554 | 0.538 | −6.0 | 40.464 |
| 44 | −28.7482 | 1.4000 | 2.00069 | 25.466 | 0.617 | 4.3 | 40.066 |
| 45 | −131.2716 | 31.4994 | | | | | 42.643 |
| 46 | ∞ | 3.2000 | 1.51680 | 64.197 | 0.534 | 2.7 | 53.699 |
| 47 | ∞ | 0.9910 | | | | | 54.404 |

TABLE 2
Example 1

| | Wide | Middle | Tele |
|---|---|---|---|
| Zr | 1.00 | 1.79 | 2.65 |
| f | 32.94 | 59.13 | 87.33 |
| FNo. | 3.19 | 3.25 | 3.30 |
| 2ω[°] | 82.2 | 46.4 | 32.0 |
| DD[6] | 2.1800 | 24.4145 | 36.4341 |
| DD[16] | 36.2546 | 14.0201 | 2.0005 |
| DD[32] | 5.0257 | 12.5441 | 19.2029 |
| DD[37] | 26.2668 | 18.7484 | 12.0896 |

TABLE 3
Example 1

| Sn | 11 | 12 | 21 |
|---|---|---|---|
| KA | 8.2315289219E−01 | 5.0000088438E+00 | −2.6074425142E+00 |
| A3 | 0.0000000000E+00 | 0.0000000000E+00 | 0.0000000000E+00 |
| A4 | 1.0146441588E−05 | 3.6438032149E−06 | −2.6856662043E−06 |
| A5 | 5.6622030893E−07 | 5.0634349074E−07 | 1.1238618879E−06 |
| A6 | −1.0764724932E−07 | −1.0841516596E−07 | −3.8028903990E−07 |
| A7 | 6.8000644924E−09 | 1.7818278764E−08 | 5.1038698818E−08 |
| A8 | 5.0769887931E−10 | −1.6737837100E−09 | −8.8577214117E−10 |
| A9 | −1.2161842832E−10 | −1.8921907314E−11 | −4.4178115257E−10 |
| A10 | 4.9367494653E−12 | 1.5559078273E−11 | 3.6605855275E−11 |
| A11 | 4.3044032603E−13 | −7.6127415126E−13 | 3.7628048265E−13 |
| A12 | −3.9093010319E−14 | −3.3664969838E−14 | −1.5115113791E−13 |
| A13 | −7.5223561621E−17 | 3.2425531378E−15 | 4.2326105026E−15 |
| A14 | 7.7910492329E−17 | −1.2588480732E−17 | 1.3594462527E−16 |
| A15 | −1.0402442368E−18 | −3.7682151280E−18 | −7.8966000652E−18 |
| A16 | −3.3402899142E−20 | 7.1507895100E−20 | 1.0298721973E−19 |
| Sn | 22 | 33 | 34 |
| KA | 1.1838419419E+00 | −3.5673855631E+00 | −3.9078337850E+00 |
| A3 | 5.9009734714E−08 | −3.2767361939E−08 | 0.0000000000E+00 |
| A4 | 9.5515403400E−07 | 6.0659513412E−05 | 6.8546757067E−05 |
| A5 | 4.0748017833E−07 | −1.9605517078E−06 | −1.8879855284E−06 |
| A6 | −3.6975801386E−08 | −5.7573066356E−07 | −6.3624971906E−07 |
| A7 | −1.0981951963E−08 | 2.0063169641E−08 | 3.4543970538E−08 |
| A8 | 2.4609229305E−09 | 4.2176971743E−09 | 2.8088781042E−09 |
| A9 | −4.9159099213E−11 | −1.7074481622E−10 | −2.0232397441E−10 |
| A10 | −2.3897128083E−11 | −2.0011785515E−11 | −5.2851098425E−12 |
| A11 | 1.6421532622E−12 | 1.0057470349E−12 | 3.5754073208E−13 |
| A12 | 6.3486546367E−14 | 4.5446843343E−14 | 6.9110677772E−15 |
| A13 | −8.3493738270E−15 | −2.8482518497E−15 | 7.2437106129E−16 |
| A14 | 5.6727340818E−17 | −2.9175453501E−17 | −4.4074102260E−17 |
| A15 | 1.2643965141E−17 | 2.9051766907E−18 | −2.4505644946E−18 |
| A16 | −2.8751156853E−19 | −1.9546441992E−20 | 1.0890423461E−19 |

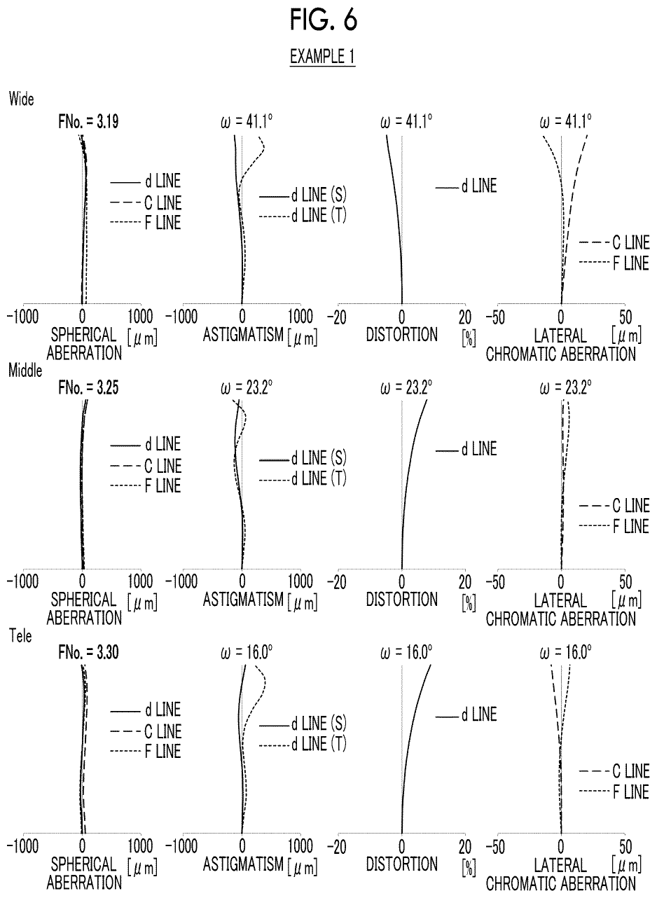

FIG. 6 shows each aberration diagram of the zoom lens of Example 1 in a state where the infinite distance object is in focus. In FIG. 6, an upper part labeled “Wide” shows aberration in the wide angle end state, a middle part labeled “Middle” shows aberration in the middle focal length state, and a lower part labeled “Tele” shows aberration in the telephoto end state. FIG. 6 shows spherical aberration, astigmatism, distortion, and lateral chromatic aberration in this order from the left. In the spherical aberration diagram, aberration on a d line, a C line, and an F line is shown by a solid line, a long broken line, and a short broken line, respectively. In the astigmatism diagram, aberration on a d line in a sagittal direction is shown by a solid line, and aberration on a d line in a tangential direction is shown by a short broken line. In the distortion diagram, aberration on a d line is shown by a solid line. In the lateral chromatic aberration diagram, aberration on a C line and an F line is shown by a long broken line and a short broken line, respectively. In the spherical aberration diagram, a value of the open F-number is shown after FNo.=. In other aberration diagrams, a value of the maximum half angle of view is shown after ω=.

Symbols, meanings, description methods, and illustration methods of each data related to Example 1 are basically the same for the following examples unless otherwise specified. Thus, duplicate descriptions will be omitted below.

### Example 2

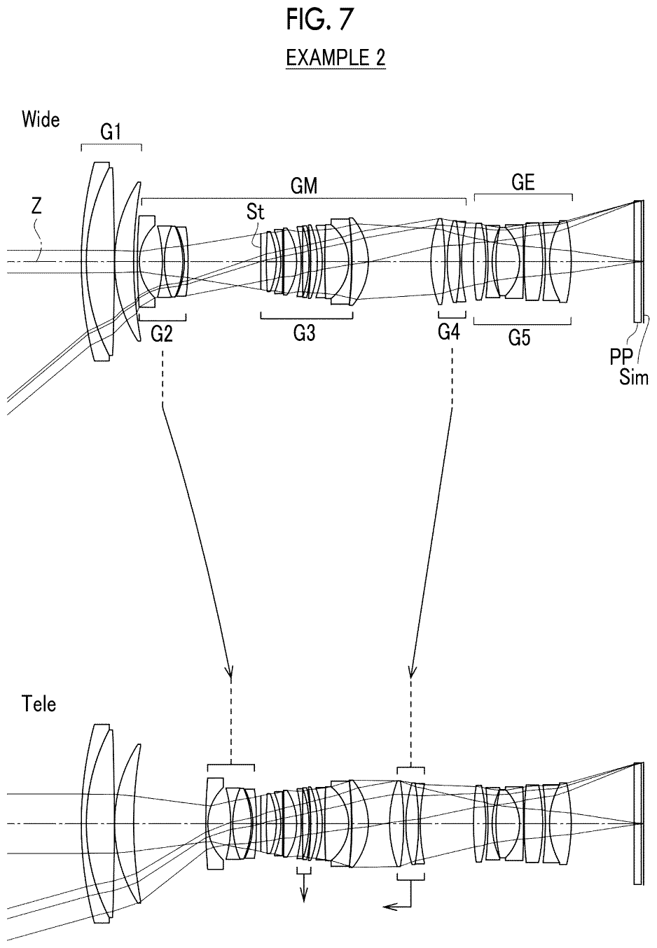

FIG. 7 shows a configuration and a moving path of a zoom lens of Example 2. The zoom lens of Example 2 consists of, in order from the object side to the image side, the first lens group G1 having positive refractive power, the second lens group G2 having negative refractive power, the third lens group G3 having positive refractive power, the fourth lens group G4 having positive refractive power, and the fifth lens group G5 having negative refractive power. The intermediate group GM consists of the second lens group G2, the third lens group G3, and the fourth lens group G4. The final lens group GE consists of the fifth lens group G5.

During zooming from the wide angle end to the telephoto end, the second lens group G2 and the fourth lens group G4 move along the optical axis Z by changing spacings with respect to adjacent lens groups, and other lens groups remain stationary with respect to the image plane Sim. The focus group consists of the fourth lens group G4. During focusing from the infinite distance object to the nearest object, the focus group moves to the object side. The vibration-proof group consists of three lenses including the fourth to sixth lenses from the object side in the third lens group G3.

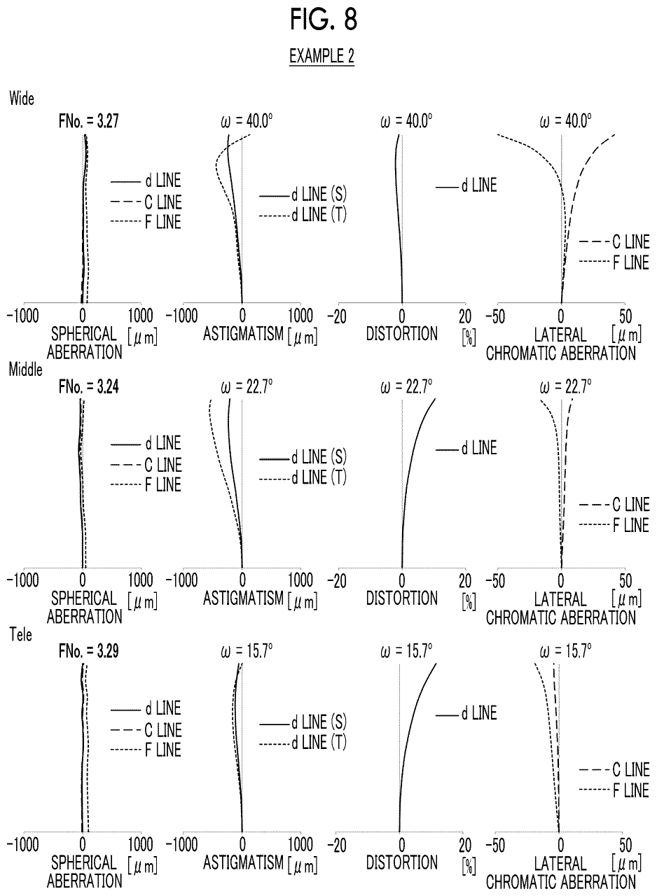

For the zoom lens of Example 2, Tables 4A and 4B show basic lens data, Table 5 shows specifications and a variable surface spacing, Table 6 shows aspherical coefficients, and FIG. 8 shows each aberration diagram.

TABLE 4A
Example 2

| | | | | | θg, | dN/ | |
|---|---|---|---|---|---|---|---|
| Sn | R | D | Nd | νd | F | dT | ED |
| 1 | 171.3298 | 2.2500 | 1.95906 | 17.471 | 0.660 | 4.1 | 88.500 |
| 2 | 91.0989 | 12.4300 | 1.51633 | 64.141 | 0.535 | 2.7 | 83.555 |
| 3 | −1139.7838 | 0.1200 | | | | | 82.521 |
| 4 | 65.6601 | 8.4700 | 1.83481 | 42.743 | 0.565 | 5.0 | 70.803 |
| 5 | 194.5307 | DD[5] | | | | | 69.421 |
| 6 | 253.7382 | 0.8900 | 2.00069 | 25.458 | 0.614 | 3.8 | 40.685 |
| 7 | 22.3615 | 10.2000 | | | | | 32.325 |
| 8 | −59.9078 | 0.9253 | 1.72916 | 54.679 | 0.545 | 4.0 | 31.748 |
| 9 | 40.5003 | 8.1500 | 1.85896 | 22.728 | 0.628 | 2.0 | 31.503 |
| 10 | −38.2440 | 0.7189 | | | | | 31.348 |
| *11 | −35.0696 | 1.6150 | 1.80610 | 40.730 | 0.569 | 7.9 | 30.700 |
| *12 | −180.2126 | DD[12] | | | | | 30.46 |
| 13 | ∞ | 2.4000 | | | | | 24.835 |
| (St) | | | | | | | |
| *14 | 131.7543 | 4.4479 | 1.49710 | 81.558 | 0.538 | −5.5 | 26.202 |
| *15 | −31.3816 | 2.0000 | | | | | 26.712 |
| 16 | −34.3906 | 0.8988 | 1.91082 | 35.253 | 0.583 | 4.8 | 26.945 |
| 17 | −541.6635 | 0.4999 | | | | | 28.546 |
| 18 | −801.2061 | 5.6500 | 1.83400 | 37.344 | 0.579 | 8.8 | 29.042 |
| 19 | −27.8540 | 2.0000 | | | | | 29.741 |
| 20 | −66.3039 | 0.6700 | 1.81600 | 46.620 | 0.557 | 5.2 | 30.809 |
| 21 | 1085.6468 | 2.8040 | | | | | 31.1 |
| 22 | −46.2945 | 0.6700 | 2.00069 | 25.458 | 0.614 | 3.8 | 31.101 |
| 23 | −79.3137 | 0.1200 | | | | | 31.913 |
| 24 | −128.9652 | 2.9289 | 1.92286 | 18.897 | 0.650 | 2.1 | 32.295 |
| 25 | −47.3739 | 2.2000 | | | | | 32.7 |
| 26 | −45.5618 | 1.0500 | 1.51823 | 58.901 | 0.546 | 0.8 | 30.974 |
| 27 | 308.9580 | 0.1200 | | | | | 32.236 |
| 28 | 418.0822 | 10.3400 | 1.43700 | 95.099 | 0.534 | −6.2 | 32.241 |
| 29 | −21.1906 | 1.2000 | 1.69895 | 30.127 | 0.603 | 3.6 | 32.963 |
| 30 | −186.2204 | 0.2985 | | | | | 37.925 |
| 31 | −147.5030 | 7.2219 | 1.72342 | 38.029 | 0.583 | 4.7 | 37.963 |
| 32 | −30.6483 | DD[32] | | | | | 38.902 |

TABLE 4B
Example 2

| | | | | | θg, | dN/ | |
|---|---|---|---|---|---|---|---|
| Sn | R | D | Nd | νd | F | dT | ED |
| 33 | 54.7485 | 6.2400 | 1.62588 | 35.722 | 0.589 | 3.3 | 38.200 |
| 34 | −127.8343 | 1.0109 | | | | | 38.095 |
| 35 | 61.7035 | 5.6649 | 1.56384 | 60.706 | 0.541 | 3.4 | 36.424 |
| 36 | −103.6646 | 0.7500 | 2.00069 | 25.458 | 0.614 | 3.8 | 35.845 |
| 37 | 84.1408 | DD[37] | | | | | 34.827 |
| 38 | 125.1323 | 5.4774 | 1.80518 | 25.425 | 0.616 | 1.3 | 34.097 |
| 39 | −73.1847 | 0.9259 | | | | | 33.677 |
| 40 | −142.2022 | 1.8710 | 1.89190 | 37.133 | 0.578 | 5.3 | 32.107 |
| 41 | 36.4355 | 1.6924 | | | | | 30.414 |
| 42 | 68.6234 | 10.5320 | 1.67270 | 32.099 | 0.599 | 3.0 | 30.436 |
| 43 | −21.4331 | 1.7000 | 2.00069 | 25.458 | 0.614 | 3.8 | 30.412 |
| 44 | −464.0019 | 0.3200 | | | | | 32.774 |
| 45 | 164.5117 | 8.2000 | 2.00069 | 25.458 | 0.614 | 3.8 | 33.588 |
| 46 | −83.8913 | 1.2001 | | | | | 34.476 |
| 47 | −146.3830 | 1.8490 | 1.95375 | 32.324 | 0.591 | 4.4 | 34.275 |
| 48 | 35.6330 | 9.6363 | 1.45860 | 90.194 | 0.535 | −6.2 | 34.747 |
| 49 | −83.4892 | 27.9866 | | | | | 36.368 |
| 50 | ∞ | 3.2000 | 1.51680 | 64.197 | 0.534 | 2.7 | 53.048 |
| 51 | ∞ | 0.9900 | | | | | 54.195 |

TABLE 5
Example 2

| | Wide | Middle | Tele |
|---|---|---|---|
| Zr | 1.00 | 1.79 | 2.65 |
| f | 32.97 | 59.15 | 87.34 |
| FNo. | 3.27 | 3.24 | 3.29 |
| 2ω[°] | 80.0 | 45.4 | 31.4 |
| DD[5] | 1.6500 | 21.6530 | 32.0673 |
| DD[12] | 32.4026 | 12.3996 | 1.9853 |
| DD[32] | 27.7942 | 16.7465 | 9.4285 |
| DD[37] | 5.2938 | 16.3415 | 23.6595 |

TABLE 6
Example 2

| Sn | 11 | 12 | 14 | 15 |
|---|---|---|---|---|
| KA | 1.0000000000E+00 | 1.0000000000E+00 | 1.0000000000E+00 | 1.0000000000E+00 |
| A3 | 0.0000000000E+00 | 0.0000000000E+00 | 0.0000000000E+00 | 0.0000000000E+00 |
| A4 | 5.4086041812E−06 | 1.3273555020E−06 | −1.2143338324E−05 | 5.6334511294E−06 |
| A5 | −4.8709675883E−09 | −1.3859588027E−07 | 4.2822333527E−06 | −2.7482892660E−06 |
| A6 | −1.2639961347E−07 | −4.3943940593E−08 | 3.0636120996E−06 | 2.1324747890E−06 |
| A7 | 5.1776898829E−09 | −3.8467571671E−09 | −6.9274026564E−07 | −4.8758316103E−07 |
| A8 | 1.1398540389E−09 | 8.0543171312E−10 | 5.7515796225E−08 | 4.5077571448E−08 |
| A9 | −4.6920876311E−11 | 9.2632275180E−12 | 1.8269586394E−09 | −4.6633556820E−10 |
| A10 | −1.1125137976E−11 | −1.6678931541E−12 | −6.5084426776E−10 | −1.6584133096E−10 |
| A11 | 7.0849013701E−13 | −6.3623767729E−13 | 4.5529871042E−11 | 5.9626398098E−12 |
| A12 | 2.1018783139E−14 | 3.8657806700E−14 | −2.8058466303E−12 | −5.2716605188E−13 |
| A13 | −1.2964534457E−15 | 2.7736968931E−15 | 3.1686950715E−13 | 1.4699313604E−13 |
| A14 | −1.0878696811E−16 | −2.5936733928E−16 | −2.3461232073E−14 | −1.1762867253E−14 |
| A15 | 6.8012201988E−18 | 4.1349265987E−18 | 7.7658203929E−16 | 3.4574626627E−16 |
| A16 | −9.0882397462E−20 | 5.3162517871E−20 | −8.7502355772E−18 | −2.7773418579E−18 |

### Example 3

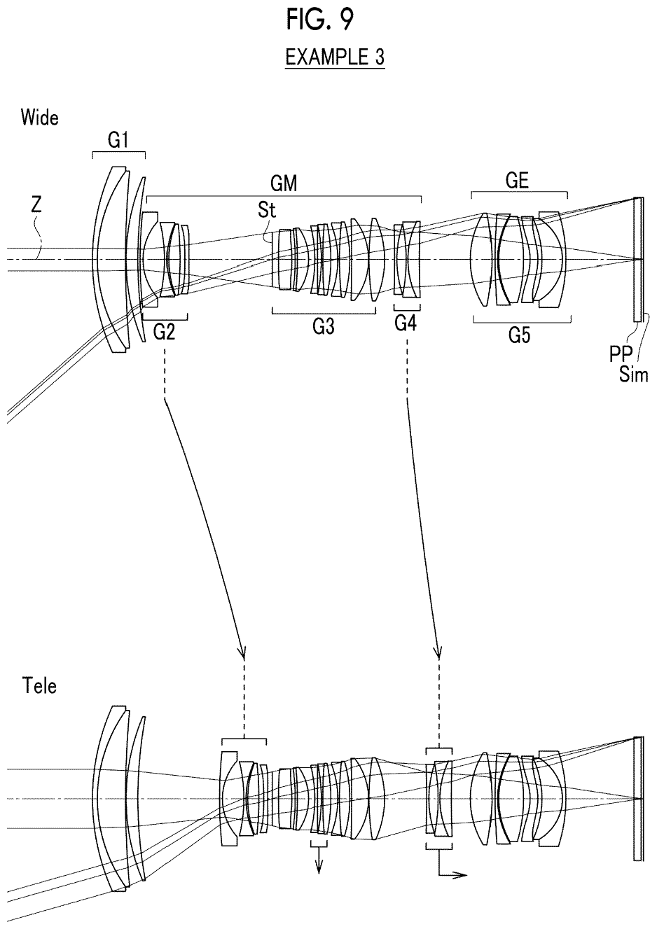

FIG. 9 shows a configuration and a moving path of a zoom lens of Example 3. The zoom lens of Example 3 consists of, in order from the object side to the image side, the first lens group G1 having positive refractive power, the second lens group G2 having negative lens group G3, and the fourth lens group G4. The final lens group GE consists of the fifth lens group G5.

During zooming from the wide angle end to the telephoto end, the second lens group G2 and the fourth lens group G4 move along the optical axis Z by changing spacings with respect to adjacent lens groups, and other lens groups remain stationary with respect to the image plane Sim. The focus group consists of the fourth lens group G4. During focusing from the infinite distance object to the nearest object, the focus group moves to the image side. The vibration-proof group consists of three lenses including the fourth to sixth lenses from the object side in the third lens group G3.

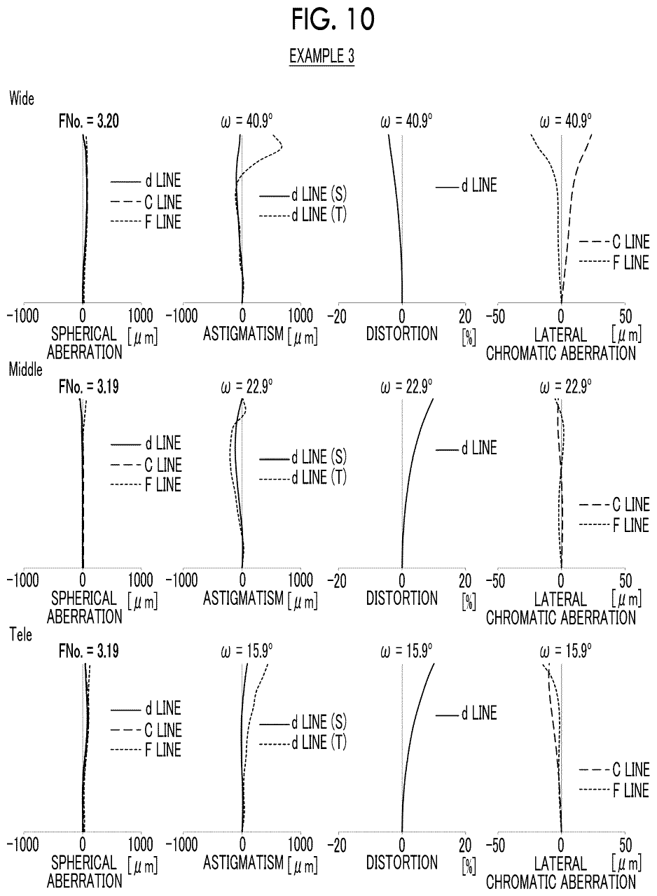

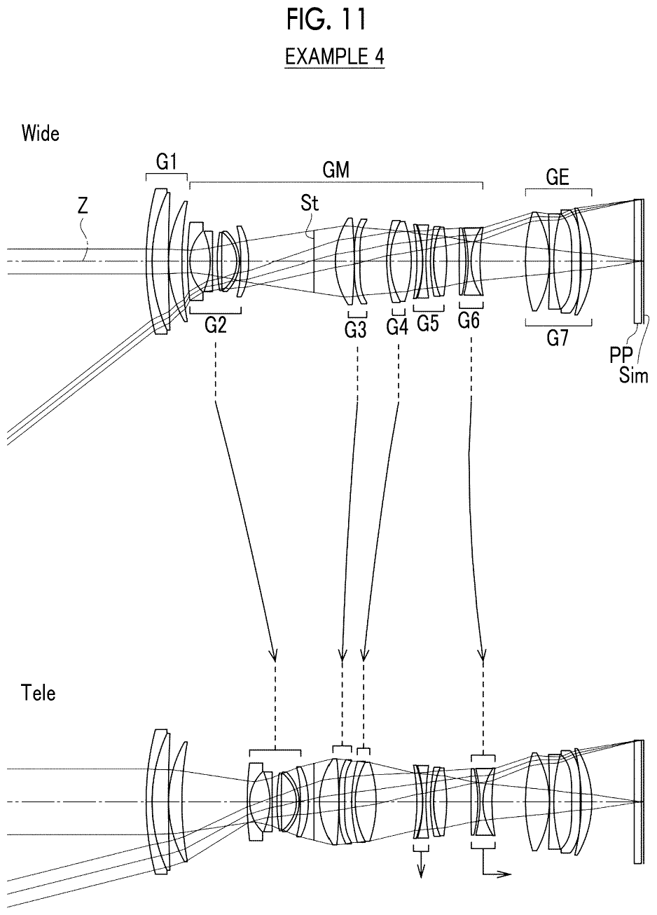

For the zoom lens of Example 3, Tables 7A and 7B show basic lens data, Table 8 shows specifications and a variable surface spacing, Table 9 shows aspherical coefficients, and FIG. 10 shows each aberration diagram.

TABLE 7A
Example 3

| | | | | | θg, | dN/ | |
|---|---|---|---|---|---|---|---|
| Sn | R | D | Nd | νd | F | dT | ED |
| 1 | 108.5505 | 2.1798 | 1.95906 | 17.472 | 0.659 | 4.1 | 86.000 |
| 2 | 72.9956 | 12.5198 | 1.64000 | 60.202 | 0.537 | 2.7 | 81.985 |
| 3 | 471.2221 | 0.2500 | | | | | 81.052 |
| 4 | 101.9364 | 5.2245 | 1.95375 | 32.276 | 0.591 | 3.5 | 76.140 |
| 5 | 217.8490 | DD[5] | | | | | 75.222 |
| 6 | 218.5940 | 1.2998 | 2.00100 | 29.134 | 0.600 | 4.4 | 43.363 |
| 7 | 27.1737 | 9.5002 | | | | | 35.116 |
| 8 | −76.6579 | 0.9998 | 1.72916 | 54.684 | 0.545 | 2.9 | 34.146 |
| 9 | 42.3695 | 0.7498 | | | | | 32.643 |
| 10 | 47.7357 | 4.9411 | 1.89286 | 20.361 | 0.639 | 1.2 | 32.712 |
| 11 | −159.7221 | 2.1248 | | | | | 32.411 |
| *12 | −338.4501 | 1.7998 | 1.69350 | 53.185 | 0.548 | 3.3 | 31.446 |
| *13 | 206.4861 | DD[13] | | | | | 31.2 |
| 14 | ∞ | 2.7825 | | | | | 24.99 |
| (St) | | | | | | | |
| *15 | 1122.7971 | 5.9012 | 1.58313 | 59.385 | 0.542 | 3.8 | 26.649 |
| *16 | −59.3884 | 1.5020 | | | | | 27.661 |
| 17 | −109.2308 | 0.9600 | 1.86966 | 20.019 | 0.643 | 1.0 | 28.147 |
| 18 | −160.3933 | 4.9873 | 1.51742 | 52.148 | 0.559 | 2.0 | 28.600 |
| 19 | −26.6457 | 2.7613 | | | | | 29.133 |
| 20 | −65.9684 | 1.2129 | 1.92286 | 18.899 | 0.650 | 2.5 | 30.553 |
| 21 | 2544.7316 | 1.6598 | | | | | 31.177 |
| 22 | −84.0990 | 0.6601 | 1.80400 | 46.574 | 0.558 | 3.7 | 31.238 |
| 23 | 209.8830 | 3.5613 | 1.95906 | 17.472 | 0.659 | 4.1 | 32.330 |
| 24 | −81.9345 | 3.1043 | | | | | 32.778 |
| 25 | −47.3082 | 0.7498 | 1.88252 | 26.995 | 0.613 | 3.2 | 31.744 |
| 26 | 165.0154 | 4.5886 | 1.57135 | 52.951 | 0.555 | −0.5 | 33.875 |
| 27 | −65.7797 | 0.8249 | | | | | 34.764 |
| 28 | −803.6122 | 7.4998 | 1.45650 | 90.273 | 0.535 | −6.6 | 36.838 |
| 29 | −31.5596 | 0.1998 | | | | | 37.569 |
| 30 | 122.6429 | 6.9179 | 1.49700 | 81.607 | 0.539 | −6.2 | 38.090 |
| 31 | −47.7274 | DD[31] | | | | | 38 |

TABLE 7B
Example 3

| | | | | | θg, | dN/ | |
|---|---|---|---|---|---|---|---|
| Sn | R | D | Nd | νd | F | dT | ED |
| 32 | −498.0464 | 0.9998 | 1.75500 | 52.320 | 0.548 | 3.8 | 32.000 |
| 33 | 52.8178 | 4.1032 | | | | | 31.88 |
| 34 | −86.5086 | 0.8098 | 1.53775 | 74.702 | 0.539 | −4.3 | 31.949 |
| 35 | 41.5932 | 5.0369 | 1.80518 | 25.456 | 0.615 | −0.7 | 34.511 |
| 36 | 381.3186 | DD[36] | | | | | 34.854 |
| 37 | 42.5399 | 9.3751 | 1.49700 | 81.607 | 0.539 | −6.2 | 42.800 |
| 38 | −111.4899 | 1.4002 | | | | | 42.599 |
| 39 | 273.5194 | 1.1184 | 1.73211 | 46.182 | 0.558 | 6.2 | 40.899 |
| 40 | 41.4892 | 0.4998 | | | | | 39.336 |
| 41 | 42.4665 | 11.0000 | 1.49700 | 81.607 | 0.539 | −6.2 | 39.448 |
| 42 | −73.2814 | 2.9241 | | | | | 38.859 |
| *43 | −24.1987 | 3.4313 | 1.69350 | 53.185 | 0.548 | 3.3 | 37.821 |
| *44 | −28.1358 | 1.7995 | | | | | 36.821 |
| 45 | −47.6547 | 9.1632 | 1.60311 | 60.694 | 0.541 | 2.0 | 36.751 |
| 46 | −22.3606 | 1.4998 | 1.80518 | 25.456 | 0.616 | 0.9 | 37.290 |
| 47 | −75.4032 | 30.2248 | | | | | 41.266 |
| 48 | ∞ | 3.2000 | 1.51680 | 64.197 | 0.534 | 2.7 | 53.626 |
| 49 | ∞ | 0.9962 | | | | | 54.406 |

TABLE 8
Example 3

| | Wide | Middle | Tele |
|---|---|---|---|
| Zr | 1.00 | 1.79 | 2.65 |
| f | 32.96 | 59.13 | 87.30 |
| FNo. | 3.20 | 3.19 | 3.19 |
| 2ω[°] | 81.8 | 45.8 | 31.8 |
| DD[5] | 1.0001 | 23.6988 | 36.0319 |
| DD[13] | 37.0523 | 14.3536 | 2.0205 |
| DD[31] | 4.5000 | 12.2167 | 18.7094 |
| DD[36] | 22.6584 | 14.9417 | 8.4490 |

TABLE 9
Example 3

| Sn | 12 | 13 | 15 |
|---|---|---|---|
| KA | 9.9999114384E−01 | 9.9999159573E−01 | 1.0000000000E+00 |
| A3 | 0.0000000000E+00 | 0.0000000000E+00 | 0.0000000000E+00 |
| A4 | −1.6837714779E−05 | −1.8288441985E−05 | 7.0167684586E−06 |
| A5 | −1.7789547252E−06 | −2.3180508149E−06 | 1.1247907861E−06 |
| A6 | 1.6996053292E−07 | 3.0942002162E−07 | −9.0637404529E−08 |
| A7 | 9.0769782191E−10 | −3.9581168672E−09 | −1.0573293915E−09 |
| A8 | −2.2215019351E−10 | −2.2071101870E−09 | 8.4569981430E−10 |
| A9 | −4.3020473474E−11 | 1.6968831117E−10 | −1.0247952827E−11 |
| A10 | 3.4314945595E−13 | 3.9106193518E−12 | −3.9438425119E−12 |
| A11 | 2.9155775690E−13 | −1.0427800783E−12 | 3.8195623528E−14 |
| A12 | −5.6460600071E−15 | 2.1314625198E−14 | 9.3266473862E−15 |
| A13 | −6.4104912898E−16 | 2.6489337953E−15 | −5.1274988417E−17 |
| A14 | 1.6406680058E−17 | −1.0013643151E−16 | −1.0875841330E−17 |
| A15 | 4.6818240476E−19 | −2.4734659478E−18 | 2.4304054534E−20 |
| A16 | −1.3357433084E−20 | 1.1745293355E−19 | 4.9904508509E−21 |
| Sn | 16 | 43 | 44 |
| KA | 1.0000000000E+00 | 1.0000000000E+00 | 1.0000000000E+00 |
| A3 | 0.0000000000E+00 | 0.0000000000E+00 | 0.0000000000E+00 |
| A4 | 2.3289678048E−05 | 4.3068955361E−05 | 4.1375478040E−05 |
| A5 | 1.0224929981E−06 | 5.7151893122E−07 | −2.7738628085E−07 |
| A6 | −6.3715522421E−08 | −1.4139074580E−07 | −2.9056903088E−08 |
| A7 | −9.1906271891E−10 | 1.6435436740E−08 | 1.3484098392E−08 |
| A8 | 6.4327710784E−10 | −2.0035483566E−10 | −7.5832615228E−10 |
| A9 | 7.3746792666E−13 | −9.5150918196E−11 | −4.4070663796E−11 |
| A10 | −3.0456519066E−12 | 3.9801438883E−12 | 4.3394355106E−12 |
| A11 | −9.4695390975E−15 | 2.3020714924E−13 | 3.8863860544E−14 |
| A12 | 6.6274896622E−15 | −1.4071860385E−14 | −1.0229848535E−14 |
| A13 | 2.1452955920E−17 | −2.4771374449E−16 | 2.3548107128E−17 |
| A14 | −6.7870834271E−18 | 2.1212857403E−17 | 1.2490198663E−17 |
| A15 | −1.3412054753E−20 | 9.1667893766E−20 | −3.8077921457E−20 |
| A16 | 2.6413416871E−21 | −1.1997568904E−20 | −6.7672095232E−21 |

### Example 4

FIG. 11 shows a configuration and a moving path of a zoom lens of Example 4. The zoom lens of Example 4 consists of, in order from the object side to the image side, the first lens group G1 having positive refractive power, the second lens group G2 having negative refractive power, the aperture stop St, the third lens group G3 having positive refractive power, the fourth lens group G4 having positive refractive power, the fifth lens group G5 having negative refractive power, a sixth lens group G6 having negative refractive power, and a seventh lens group G7 having positive refractive power. The intermediate group GM consists of the second lens group G2, the aperture stop St, the third lens group G3, the fourth lens group G4, the fifth lens group G5, and the sixth lens group G6. The final lens group GE consists of the seventh lens group G7. In the zoom lens of Example 4, the aperture stop St is not included in any of the lens groups.

During zooming from the wide angle end to the telephoto end, the second lens group G2, the third lens group G3, the fourth lens group G4, and the sixth lens group G6 move along the optical axis Z by changing spacings with respect to adjacent lens groups, and other lens groups and the aperture stop St remain stationary with respect to the image plane Sim. The focus group consists of the sixth lens group G6. During focusing from the infinite distance object to the nearest object, the focus group moves to the image side. The vibration-proof group consists of two lenses including first and second lenses from the object side in the fifth lens group G5.

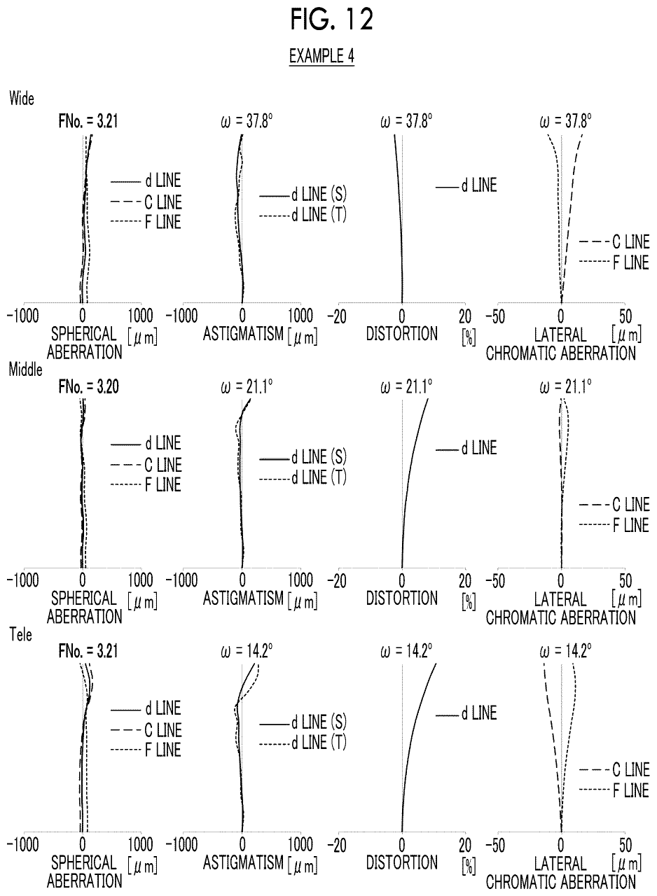

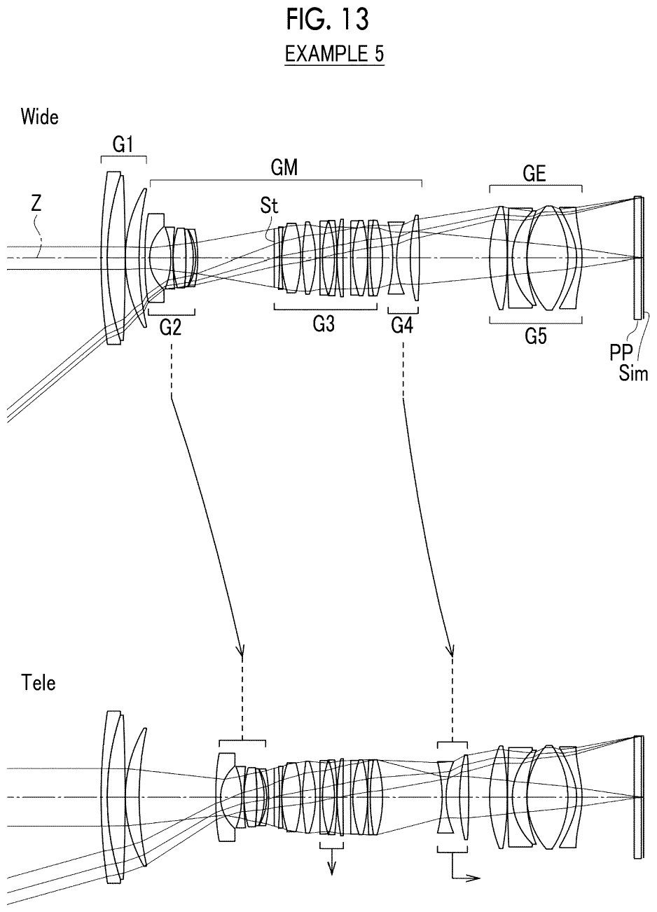

For the zoom lens of Example 4, Tables 10A and 10B show basic lens data, Table 11 shows specifications and a variable surface spacing, Tables 12A and 12B show aspherical coefficients, and FIG. 12 shows each aberration diagram.

TABLE 10A
Example 4

| | | | | | θg, | dN/ | |
|---|---|---|---|---|---|---|---|
| Sn | R | D | Nd | νd | F | dT | ED |
| 1 | 137.2771 | 2.6785 | 1.80809 | 22.760 | 0.631 | −0.2 | 67.069 |
| 2 | 79.4196 | 7.2077 | 1.57144 | 71.615 | 0.542 | −5.9 | 63.380 |
| 3 | 709.9267 | 0.1001 | | | | | 62.504 |
| 4 | 57.9953 | 5.8876 | 1.72924 | 53.850 | 0.546 | 3.6 | 55.498 |
| 5 | 158.5657 | DD[5] | | | | | 54.636 |
| 6 | 158.6996 | 1.0945 | 1.78800 | 47.368 | 0.556 | 4.5 | 35.705 |
| 7 | 20.0054 | 8.9848 | | | | | 28.055 |
| *8 | −29.9374 | 0.9869 | 1.69281 | 53.048 | 0.547 | 3.4 | 27.738 |
| 9 | 8084.8556 | 2.0911 | | | | | 27.336 |
| 10 | 83.9835 | 1.9413 | 1.85479 | 24.801 | 0.612 | 2.6 | 26.774 |
| 11 | 508.2101 | 6.6895 | | | | | 26.519 |
| 12 | −17.2992 | 1.1837 | 1.78472 | 25.720 | 0.616 | 0.8 | 26.337 |
| 13 | −19.9904 | 0.5868 | | | | | 27.647 |
| *14 | −142.5040 | 3.5046 | 1.63351 | 23.627 | 0.610 | 0.0 | 31.293 |
| *15 | −51.1355 | DD[15] | | | | | 32.518 |
| 16 | ∞ | DD[16] | | | | | 35.569 |
| (St) | | | | | | | |
| 17 | 37.7094 | 8.3040 | 1.45650 | 90.273 | 0.535 | −6.6 | 39.865 |
| 18 | −221.3297 | 0.1001 | | | | | 39.744 |
| *19 | 329.1976 | 2.4703 | 1.74330 | 49.325 | 0.553 | 7.4 | 38.991 |
| *20 | −5223.1880 | DD[20] | | | | | 37.713 |
| 21 | 72.2364 | 1.5812 | 2.00069 | 25.455 | 0.614 | 5.3 | 37.627 |
| 22 | 40.3859 | 9.2626 | 1.53775 | 74.702 | 0.539 | −4.3 | 36.635 |
| 23 | −59.8196 | DD[23] | | | | | 36.494 |
| 24 | −99.2523 | 2.5002 | 1.95906 | 17.472 | 0.657 | 2.1 | 33.920 |
| 25 | −52.8108 | 0.1002 | | | | | 33.979 |
| 26 | −61.9074 | 1.4221 | 1.85033 | 42.696 | 0.565 | 4.5 | 33.620 |
| 27 | 118.3182 | 1.9973 | | | | | 33.402 |
| 28 | 81.4491 | 1.3460 | 1.89286 | 20.361 | 0.639 | 1.2 | 31.976 |
| 29 | 44.3268 | 0.1402 | | | | | 31.483 |
| *30 | 50.5202 | 5.6973 | 1.61999 | 63.763 | 0.543 | −4.1 | 31.504 |
| *31 | −78.5394 | DD[31] | | | | | 31.27 |

TABLE 10B
Example 4

| Sn | R | D | Nd | νd | θg, F | dN/dT | ED |
|---|---|---|---|---|---|---|---|
| 32 | 816.0427 | 2.9819 | 1.92286 | 20.886 | 0.638 | 2.3 | 30.797 |
| 33 | −70.2387 | 1.0068 | | | | | 30.736 |
| 34 | −62.3543 | 1.3239 | 1.80400 | 46.560 | 0.556 | 4.7 | 30.265 |
| 35 | 29.3489 | 3.9450 | 1.51823 | 58.960 | 0.544 | 0.0 | 30.760 |
| 36 | 90.8008 | DD[36] | | | | | 31.069 |
| 37 | 83.1706 | 10.5759 | 1.52841 | 76.452 | 0.540 | −5.9 | 44.263 |
| 38 | −48.4751 | 0.1000 | | | | | 44.627 |
| 39 | −545.8214 | 1.8520 | 1.92286 | 20.886 | 0.638 | 2.3 | 43.094 |
| 40 | 83.9250 | 7.9324 | | | | | 42.517 |
| *41 | −5647.3501 | 3.8161 | 1.85370 | 40.579 | 0.568 | 6.6 | 42.777 |
| *42 | −2797.0841 | 0.4425 | | | | | 46.409 |
| 43 | −106.5479 | 4.6693 | 1.49665 | 81.548 | 0.538 | −6.2 | 47.367 |
| 44 | −50.8021 | 18.7739 | | | | | 48.023 |
| 45 | ∞ | 3.2000 | 1.51680 | 64.197 | 0.534 | 2.7 | 53.991 |
| 46 | ∞ | 0.9760 | | | | | 54.497 |

TABLE 11
Example 4

| | Wide | Middle | Tele |
|---|---|---|---|
| Zr | 1.00 | 1.81 | 2.70 |
| f | 36.14 | 65.58 | 97.51 |
| FNo. | 3.21 | 3.20 | 3.21 |
| 2ω[°] | 75.6 | 42.2 | 28.4 |
| DD[5] | 2.4985 | 19.1177 | 28.9660 |
| DD[15] | 28.9652 | 12.3460 | 2.4977 |
| DD[16] | 9.2779 | 4.4363 | 2.4967 |
| DD[20] | 11.8798 | 6.3831 | 3.1172 |
| DD[23] | 2.4973 | 12.8356 | 18.0411 |
| DD[31] | 5.5300 | 6.0368 | 10.8037 |
| DD[36] | 20.1491 | 19.6423 | 14.8754 |

TABLE 12A
Example 4

| Sn | 8 | 14 | 15 |
|---|---|---|---|
| KA | 1.6141907335E−01 | 1.0580053196E+00 | 3.0445965772E+00 |
| A3 | 0.0000000000E+00 | 0.0000000000E+00 | 0.0000000000E+00 |
| A4 | 1.2998525621E−05 | −1.2640128337E−05 | −2.9618345466E−06 |
| A5 | −5.0329112313E−08 | −1.0576596688E−06 | −2.2296288450E−06 |
| A6 | −1.3183590678E−07 | 1.5154801577E−07 | 3.8784437274E−07 |
| A7 | 2.5467133956E−08 | 7.6316256871E−10 | −1.8231264576E−08 |
| A8 | −5.3987598907E−10 | −1.6432166372E−09 | −2.4720718021E−09 |
| A9 | −2.4506799516E−10 | 7.8894409524E−11 | 2.9750576554E−10 |
| A10 | 1.0914935009E−11 | 6.9978505638E−12 | 2.6279214422E−13 |
| A11 | 1.7047452597E−12 | −6.1455783613E−13 | −1.3522571946E−12 |
| A12 | −8.6573691235E−14 | −5.4226283319E−15 | 4.0461266853E−14 |
| A13 | −7.1348241531E−15 | 1.8915015949E−15 | 2.5665011845E−15 |
| A14 | 3.8791286394E−16 | −4.1780619667E−17 | −1.2647700071E−16 |
| A15 | 1.1604758911E−17 | −2.1179367826E−18 | −1.6806948091E−18 |
| A16 | −6.5697839643E−19 | 8.7610378512E−20 | 1.2035186333E−19 |
| Sn | 19 | 20 | 30 |
| KA | 4.9999999101E+00 | −4.9999921075E+00 | −3.6176834086E+00 |
| A3 | 0.0000000000E+00 | 0.0000000000E+00 | 0.0000000000E+00 |
| A4 | 1.2470688783E−05 | 1.6377815916E−05 | 1.8438282059E−06 |
| A5 | 5.5117519129E−07 | 1.1595775865E−06 | 2.1235461380E−06 |
| A6 | 3.4847976002E−09 | −7.5596321045E−08 | −2.1558734590E−07 |
| A7 | 2.6581913094E−10 | −1.9980123379E−09 | −1.5712526929E−08 |
| A8 | −4.0067338230E−10 | 9.9724667867E−10 | 4.0694257761E−09 |
| A9 | 1.6147966788E−11 | −5.9095538915E−11 | −7.8578377794E−11 |
| A10 | 2.1552404026E−12 | −3.2946047159E−12 | −2.3976066204E−11 |
| A11 | −1.2636130606E−13 | 4.6700144392E−13 | 1.1011673112E−12 |
| A12 | −3.8739379212E−15 | −3.9507708719E−15 | 5.7755324710E−14 |
| A13 | 2.9473713668E−16 | −1.2149713131E−15 | −3.6002705609E−15 |
| A14 | 1.4738494122E−18 | 3.2564479575E−17 | −4.9793313639E−17 |
| A15 | −2.2624269534E−19 | 1.0605344261E−18 | 3.8285632698E−18 |
| A16 | 1.3615262028E−21 | −3.7704751695E−20 | 6.3678315268E−21 |

TABLE 12B
Example 4

| Sn | 31 | 41 | 42 |
|---|---|---|---|
| KA | −2.9115673409E−01 | −4.9999992152E+00 | 4.9999919732E+00 |
| A3 | 0.0000000000E+00 | 0.0000000000E+00 | 0.0000000000E+00 |
| A4 | −2.4606140025E−06 | −1.1920603801E−05 | −2.0941190071E−07 |
| A5 | 2.1914163494E−06 | −8.0686177567E−07 | −3.4735588391E−06 |
| A6 | −2.0897782684E−07 | 2.0745945315E−09 | 3.4707709521E−07 |
| A7 | −1.2708800115E−08 | 7.8630411009E−09 | −4.7516952106E−09 |
| A8 | 2.7019611021E−09 | −6.1230350500E−11 | −1.3661467543E−09 |
| A9 | 5.0541170538E−11 | −7.0070920650E−11 | 6.1855768848E−11 |
| A10 | −1.8858204280E−11 | 2.1805655041E−12 | 1.9151484996E−12 |
| A11 | −1.7932958192E−13 | 2.1595411336E−13 | −1.5027755457E−13 |
| A12 | 8.2490493708E−14 | −9.0917190580E−15 | −5.0089516945E−16 |
| A13 | 4.6570309945E−16 | −2.8496141101E−16 | 1.5423282501E−16 |
| A14 | −2.0623915948E−16 | 1.4182486920E−17 | −1.0524905547E−18 |
| A15 | −4.6896843052E−19 | 1.4144775171E−19 | −5.9462574305E−20 |
| A16 | 2.1997870361E−19 | −7.9573779420E−21 | 6.7338446241E−22 |

### Example 5

FIG. 13 shows a configuration and a moving path of a zoom lens of Example 5. The zoom lens of Example 5 consists of, in order from the object side to the image side, the first lens group G1 having positive refractive power, the second lens group G2 having negative refractive power, the third lens group G3 having positive refractive power, the fourth lens group G4 having negative refractive power, and the fifth lens group G5 having positive refractive power. The intermediate group GM consists of the second lens group G2, the third lens group G3, and the fourth lens group G4. The final lens group GE consists of the fifth lens group G5.

During zooming from the wide angle end to the telephoto end, the second lens group G2 and the fourth lens group G4 move along the optical axis Z by changing spacings with respect to adjacent lens groups, and other lens groups remain stationary with respect to the image plane Sim. The focus group consists of the fourth lens group G4. During focusing from the infinite distance object to the nearest object, the focus group moves to the image side. The vibration-proof group consists of three lenses including the fourth to sixth lenses from the object side in the third lens group G3.

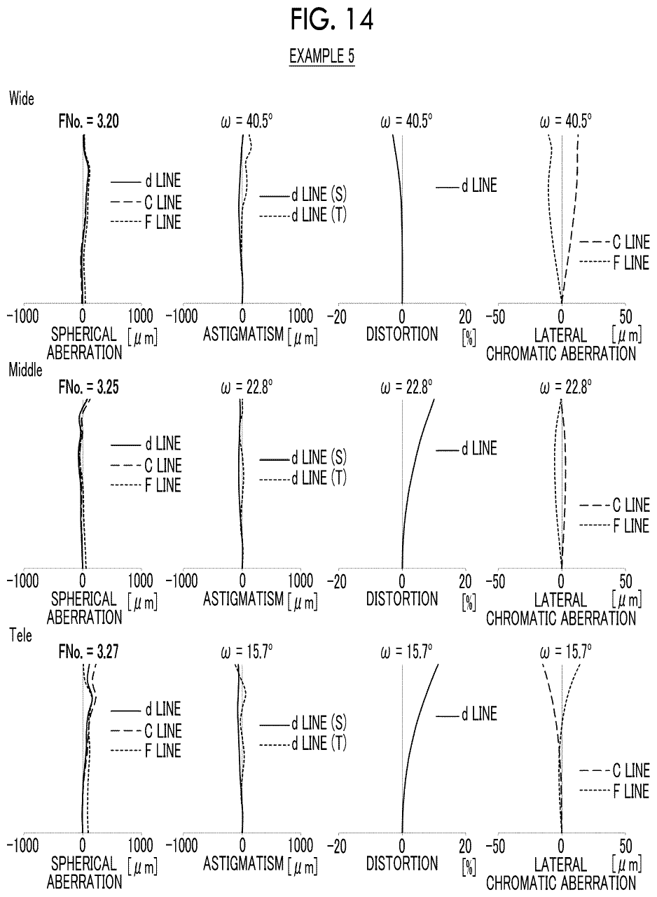

For the zoom lens of Example 5, Tables 13A and 13B show basic lens data, Table 14 shows specifications and a variable surface spacing, Tables 15A and 15B show aspherical coefficients, and FIG. 14 shows each aberration diagram.

TABLE 13A
Example 5

| Sn | R | D | Nd | νd | θg, F | dN/dT | ED |
|---|---|---|---|---|---|---|---|
| 1 | 281.5075 | 2.7717 | 1.86966 | 20.019 | 0.643 | 1.0 | 80.030 |
| 2 | 127.9039 | 7.9205 | 1.61921 | 63.854 | 0.542 | −2.9 | 76.313 |
| 3 | −894.9192 | 0.1001 | | | | | 75.466 |
| 4 | 66.5521 | 6.1097 | 1.77535 | 50.308 | 0.550 | 3.8 | 64.110 |
| 5 | 154.5595 | DD[5] | | | | | 62.844 |
| *6 | 986.3889 | 2.0944 | 1.69350 | 53.185 | 0.548 | 3.3 | 40.463 |
| *7 | 21.2886 | 9.3769 | | | | | 29.037 |
| 8 | −40.5995 | 0.9202 | 1.88300 | 40.847 | 0.568 | 4.2 | 28.371 |
| 9 | 129.4768 | 0.1000 | | | | | 27.664 |
| 10 | 50.5073 | 5.6525 | 1.59270 | 35.309 | 0.593 | 0.2 | 27.504 |
| 11 | −143.8614 | 0.1002 | | | | | 26.604 |
| 12 | −141.1318 | 3.1927 | 1.86966 | 20.019 | 0.643 | 1.0 | 26.550 |
| 13 | −36.0257 | 1.1007 | | | | | 26.277 |
| 14 | −27.1791 | 0.8631 | 1.90043 | 37.372 | 0.577 | 4.2 | 25.853 |
| 15 | −66.3254 | DD[15] | | | | | 26.406 |
| 16 (St) | ∞ | 2.3408 | | | | | 26.831 |
| 17 | −233.1377 | 0.9290 | 1.96300 | 24.114 | 0.621 | 3.1 | 28.002 |
| 18 | 166.8693 | 0.1001 | | | | | 28.713 |
| 19 | 52.1287 | 8.3465 | 1.48071 | 85.295 | 0.536 | −5.9 | 30.434 |
| 20 | −61.2317 | 0.8681 | | | | | 31.903 |
| *21 | 75.5954 | 5.7180 | 1.58313 | 59.460 | 0.541 | 3.9 | 33.185 |
| *22 | −48.7311 | 2.0040 | | | | | 33.349 |
| 23 | −85678.2497 | 1.0687 | 1.69349 | 53.348 | 0.547 | 5.5 | 34.108 |
| 24 | 59.5030 | 5.1015 | | | | | 33.64 |
| 25 | −58.7647 | 1.0796 | 1.64769 | 33.840 | 0.592 | 1.4 | 33.679 |
| 26 | −156.3056 | 0.1000 | | | | | 34.572 |
| 27 | 97.4623 | 2.5997 | 1.92286 | 20.880 | 0.640 | 0.0 | 35.729 |
| 28 | 1174.1147 | 3.3302 | | | | | 35.763 |
| 29 | 1018.4804 | 1.0841 | 1.85000 | 27.027 | 0.609 | 1.7 | 34.104 |
| 30 | 55.9933 | 6.4789 | 1.45600 | 91.373 | 0.534 | −5.9 | 34.215 |
| 31 | −73.3932 | 0.1000 | | | | | 34.597 |
| 32 | 332.8717 | 1.1123 | 1.89286 | 20.361 | 0.639 | 1.2 | 34.864 |
| 33 | 105.0470 | 5.4651 | 1.88300 | 40.688 | 0.567 | 4.9 | 34.872 |
| 34 | −62.7578 | DD[34] | | | | | 34.881 |

TABLE 13B
Example 5

| Sn | R | D | Nd | νd | θg, F | dN/dT | ED |
|---|---|---|---|---|---|---|---|
| *35 | −69.4964 | 1.7552 | 1.77250 | 49.502 | 0.552 | 5.8 | 32.915 |
| *36 | 38.7430 | 6.0350 | | | | | 33.157 |
| 37 | 85.6740 | 4.0472 | 1.94595 | 17.989 | 0.656 | 3.7 | 38.336 |
| 38 | −333.0858 | DD[38] | | | | | 38.663 |
| 39 | 67.2718 | 7.8066 | 1.70154 | 41.176 | 0.576 | 4.8 | 47.662 |
| 40 | −143.9439 | 0.1427 | | | | | 47.455 |
| 41 | 462.0284 | 2.1410 | 2.00069 | 25.458 | 0.614 | 3.8 | 46.118 |
| 42 | 30.8416 | 6.3937 | 1.51577 | 63.989 | 0.534 | 4.1 | 43.084 |
| 43 | 58.8017 | 0.1000 | | | | | 43.508 |
| 44 | 38.0660 | 18.1399 | 1.45562 | 91.306 | 0.534 | −5.9 | 47.333 |
| 45 | −44.4919 | 3.8753 | | | | | 47.254 |
| *46 | −27.0093 | 2.4158 | 1.80625 | 40.907 | 0.569 | 7.9 | 44.784 |
| *47 | −42.4042 | 23.1375 | | | | | 46.016 |
| 48 | ∞ | 3.2000 | 1.51680 | 64.197 | 0.534 | 2.7 | 53.726 |
| 49 | ∞ | 0.9815 | | | | | 54.365 |

TABLE 14
Example 5

| | Wide | Middle | Tele |
|---|---|---|---|
| Zr | 1.00 | 1.79 | 2.65 |
| f | 32.97 | 59.16 | 87.37 |
| FNo. | 3.20 | 3.25 | 3.27 |
| 2ω[°] | 81.0 | 45.6 | 31.4 |
| DD[5] | 2.5941 | 22.9716 | 34.0816 |
| DD[15] | 33.9796 | 13.6021 | 2.4921 |
| DD[34] | 4.5038 | 15.6428 | 26.4419 |
| DD[38] | 31.1959 | 20.0569 | 9.2578 |

TABLE 15A
Example 5

| Sn | 6 | 7 | 21 |
|---|---|---|---|
| KA | 4.9999999076E+00 | 1.5495304638E+00 | −3.0562191023E+00 |
| A3 | 0.0000000000E+00 | 0.0000000000E+00 | 0.0000000000E+00 |
| A4 | 4.4206564597E−05 | 4.0009304891E−05 | −4.4038466287E−06 |
| A5 | −1.8114542259E−06 | −3.0344598847E−06 | 1.1349038775E−06 |
| A6 | −3.2120225290E−07 | 1.0350831907E−07 | −3.0700755116E−07 |
| A7 | 3.7613187132E−08 | −4.9588833626E−08 | 2.5114139444E−08 |
| A8 | −1.4324187987E−09 | 8.0800264964E−09 | 2.5269678333E−10 |
| A9 | −4.2930768396E−11 | −2.4131708015E−10 | −1.0751413702E−10 |
| A10 | 8.7937942310E−12 | −8.1178820438E−11 | 4.3939367772E−12 |
| A11 | −3.5105132267E−13 | 8.3595045644E−12 | −3.4557750904E−13 |
| A12 | −9.6019645395E−15 | 6.5505837522E−14 | 8.7195017188E−15 |
| A13 | 1.0177548734E−15 | −4.0162926648E−14 | 2.2270267885E−15 |
| A14 | −1.0457339857E−17 | 1.0301225940E−15 | −9.9403349033E−17 |
| A15 | −7.7194757404E−19 | 5.6624783911E−17 | −2.7894870515E−18 |
| A16 | 1.7116677626E−20 | −2.2630287904E−18 | 1.4474891905E−19 |
| Sn | 22 | 35 | 36 |
| KA | 2.2143555901E+00 | −6.9019848525E−01 | 1.0392639122E+00 |
| A3 | 0.0000000000E+00 | 0.0000000000E+00 | 0.0000000000E+00 |
| A4 | 3.1496636196E−06 | −2.4966104904E−05 | −2.8060355184E−05 |
| A5 | 1.6475163585E−06 | 3.3425152962E−06 | 2.5028204421E−06 |
| A6 | −4.2323674119E−07 | −6.0485948646E−08 | 1.4554153761E−07 |
| A7 | 3.9253434275E−08 | −2.5509229423E−08 | −4.0628217711E−08 |
| A8 | −2.4124018460E−10 | 1.9988071575E−09 | 9.2994325633E−10 |
| A9 | −1.8584321478E−10 | 7.2677209039E−11 | 2.6912110990E−10 |
| A10 | 1.2513405517E−11 | −1.2352476536E−11 | −1.3644437250E−11 |
| A11 | −3.5434761558E−13 | 7.2256348086E−14 | −9.0816667440E−13 |
| A12 | −1.5678422144E−14 | 3.1577445211E−14 | 6.1646402681E−14 |
| A13 | 2.7003430557E−15 | −7.1016884931E−16 | 1.5491593836E−15 |
| A14 | −7.2433315622E−17 | −2.9251678441E−17 | −1.2724792633E−16 |
| A15 | −3.1844887675E−18 | 9.0522745387E−19 | −1.0655757939E−18 |
| A16 | 1.2812575261E−19 | 1.6325667263E−22 | 1.0218069526E−19 |

TABLE 15B
Example 5

| Sn | 46 | 47 |
|---|---|---|
| KA | 8.9955880343E−01 | 1.2881635045E+00 |
| A3 | 0.0000000000E+00 | 0.0000000000E+00 |
| A4 | 7.6203439988E−06 | 1.1014879358E−05 |
| A5 | 2.6111352006E−06 | 1.4173823263E−06 |
| A6 | −4.2706919581E−07 | −1.9412750896E−07 |
| A7 | 3.3070212650E−08 | 1.1203066194E−08 |
| A8 | 4.9259092440E−10 | 7.7231740547E−10 |
| A9 | −2.0459618327E−10 | −1.0432338521E−10 |
| A10 | 5.0094589068E−12 | −5.3614550603E−13 |
| A11 | 4.5582697183E−13 | 3.6537975635E−13 |
| A12 | −1.7863934579E−14 | −5.4614169608E−15 |
| A13 | −4.5009195869E−16 | −5.3941164571E−16 |
| A14 | 2.2471437547E−17 | 1.3054584115E−17 |
| A15 | 1.6485979907E−19 | 2.8276376153E−19 |
| A16 | −1.0055255312E−20 | −8.3177826017E−21 |

### Example 6

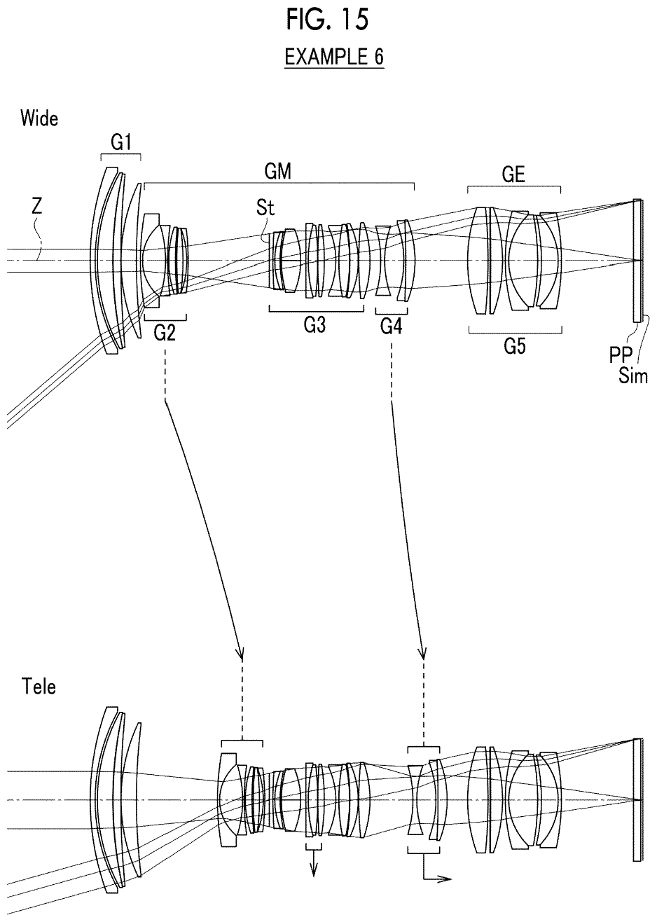

FIG. 15 shows a configuration and a moving path of a zoom lens of Example 6. The zoom lens of Example 6 consists of, in order from the object side to the image side, the first lens group G1 having positive refractive power, the second lens group G2 having negative refractive power, the third lens group G3 having positive refractive power, the fourth lens group G4 having negative refractive power, and the fifth lens group G5 having positive refractive power. The intermediate group GM consists of the second lens group G2, the third lens group G3, and the fourth lens group G4. The final lens group GE consists of the fifth lens group G5.

During zooming from the wide angle end to the telephoto end, the second lens group G2 and the fourth lens group G4 move along the optical axis Z by changing spacings with respect to adjacent lens groups, and other lens groups remain stationary with respect to the image plane Sim. The focus group consists of the fourth lens group G4. During focusing from the infinite distance object to the nearest object, the focus group moves to the image side. The vibration-proof group consists of three lenses including the fourth to sixth lenses from the object side in the third lens group G3.

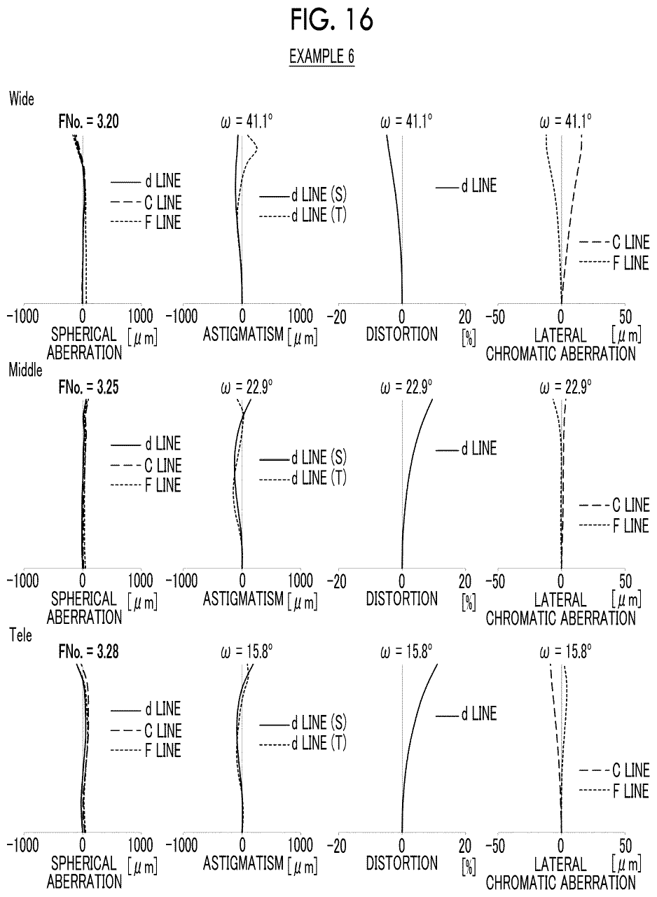

For the zoom lens of Example 6, Tables 16A and 16B show basic lens data, Table 17 shows specifications and a variable surface spacing, Table 18 shows aspherical coefficients, and FIG. 16 shows each aberration diagram.

TABLE 16A
Example 6

| Sn | R | D | Nd | νd | θg, F | dN/dT | ED |
|---|---|---|---|---|---|---|---|
| 1 | 130.6321 | 2.1926 | 1.89286 | 20.361 | 0.639 | 1.2 | 86.296 |
| 2 | 88.9056 | 1.0025 | | | | | 81.93 |
| 3 | 88.1621 | 6.8244 | 1.58831 | 60.991 | 0.537 | 2.9 | 81.253 |
| 4 | 188.9488 | 0.1499 | | | | | 80.229 |
| 5 | 195.1426 | 3.4244 | 1.55352 | 71.717 | 0.540 | −6.1 | 80.218 |
| 6 | 425.5366 | 0.0999 | | | | | 79.278 |
| 7 | 87.1712 | 6.8384 | 1.72916 | 54.673 | 0.545 | 3.4 | 71.467 |
| 8 | 298.1513 | DD[8] | | | | | 70.059 |
| 9 | 129.9572 | 0.9465 | 1.77250 | 49.598 | 0.552 | 4.5 | 42.927 |
| 10 | 22.0916 | 10.2105 | | | | | 32.908 |
| 11 | −57.9014 | 0.7232 | 1.77250 | 49.598 | 0.552 | 4.5 | 32.277 |
| 12 | 122.9661 | 0.4999 | | | | | 31.234 |
| *13 | 56.2450 | 2.9528 | 1.51654 | 63.849 | 0.541 | 4.1 | 30.740 |
| *14 | 173.1756 | 0.6273 | | | | | 30.254 |
| 15 | 178.0018 | 2.6983 | 1.92286 | 18.897 | 0.650 | 2.1 | 30.018 |
| 16 | −116.9101 | 1.7034 | | | | | 29.649 |
| 17 | −43.8693 | 0.6523 | 1.69350 | 50.810 | 0.555 | 2.4 | 29.570 |
| 18 | −123.4112 | DD[18] | | | | | 29.125 |
| 19 (St) | ∞ | 1.6182 | | | | | 24.802 |
| 20 | 185.9572 | 0.8688 | 1.85026 | 32.352 | 0.595 | 4.0 | 25.882 |
| 21 | 37.0414 | 2.3547 | 1.80809 | 22.760 | 0.631 | −0.2 | 26.480 |
| 22 | 61.7028 | 0.5558 | | | | | 26.799 |
| *23 | 50.0340 | 8.5664 | 1.49710 | 81.558 | 0.538 | −5.5 | 27.573 |
| *24 | −38.7620 | 2.3620 | | | | | 29.033 |
| 25 | 5443.5397 | 1.0271 | 1.92286 | 20.880 | 0.640 | 0.0 | 32.139 |
| 26 | 65.9791 | 4.1650 | 1.59270 | 35.309 | 0.593 | 0.2 | 32.432 |
| 27 | −153.9284 | 0.1002 | | | | | 32.721 |
| 28 | 274.4652 | 2.8506 | 1.80610 | 33.269 | 0.588 | 4.7 | 33.069 |
| 29 | −111.2761 | 5.1105 | | | | | 33.152 |
| 30 | −38.5353 | 1.3737 | 1.80000 | 29.844 | 0.602 | 4.5 | 30.667 |
| 31 | 88.1689 | 4.7487 | 1.49700 | 81.604 | 0.538 | 6.2 | 32.617 |
| 32 | −84.1297 | 0.1641 | | | | | 33.359 |
| 33 | −109.9142 | 3.6949 | 1.60886 | 57.913 | 0.541 | 2.6 | 33.636 |
| 34 | −41.5907 | 0.2463 | | | | | 34.206 |
| 35 | 180.2670 | 4.9696 | 1.83400 | 37.206 | 0.581 | 9.2 | 34.989 |
| 36 | −56.9697 | DD[36] | | | | | 34.988 |

TABLE 16B
Example 6

| Sn | R | D | Nd | νd | θg, F | dN/dT | ED |
|---|---|---|---|---|---|---|---|
| *37 | −59.4191 | 1.7371 | 1.69350 | 53.185 | 0.548 | 3.3 | 31.968 |
| *38 | 44.3244 | 8.5103 | | | | | 31.809 |
| 39 | −51.8654 | 0.8996 | 1.52500 | 70.370 | 0.531 | 0.5 | 34.149 |
| 40 | −420.1329 | 4.0603 | 2.00272 | 19.317 | 0.645 | 7.7 | 36.711 |
| 41 | −54.6712 | DD[41] | | | | | 37.388 |
| 42 | 75.7374 | 9.0735 | 1.48749 | 70.235 | 0.530 | −0.7 | 49.055 |
| 43 | −265.4572 | 0.9144 | | | | | 49.154 |
| 44 | −2376.7433 | 5.2741 | 1.49653 | 81.602 | 0.537 | −5.4 | 49.053 |
| 45 | −75.4469 | 1.2208 | | | | | 49.016 |
| 46 | 86.6875 | 1.5529 | 1.90366 | 31.314 | 0.595 | 4.1 | 45.618 |
| 47 | 30.1985 | 12.8345 | 1.49700 | 81.607 | 0.539 | −6.2 | 42.258 |
| 48 | −119.0076 | 1.6658 | | | | | 41.997 |
| 49 | −96.9396 | 7.4764 | 1.49700 | 81.607 | 0.539 | −6.2 | 41.542 |
| 50 | −30.9568 | 1.4186 | 1.96300 | 24.114 | 0.621 | 3.1 | 41.393 |
| 51 | −109.2939 | 32.0993 | | | | | 43.877 |
| 52 | ∞ | 3.2000 | 1.51680 | 64.197 | 0.534 | 2.7 | 53.812 |
| 53 | ∞ | 0.9884 | | | | | 54.418 |

TABLE 17
Example 6

| | Wide | Middle | Tele |
|---|---|---|---|
| Zr | 1.00 | 1.79 | 2.65 |
| f | 32.95 | 59.12 | 87.31 |
| FNo. | 3.20 | 3.25 | 3.28 |
| 2ω[°] | 82.2 | 45.8 | 31.6 |
| DD[8] | 1.7825 | 23.8836 | 35.8195 |
| DD[18] | 36.0273 | 13.9262 | 1.9903 |
| DD[36] | 4.7950 | 12.3477 | 19.1132 |
| DD[41] | 23.4362 | 15.8835 | 9.1180 |

TABLE 18
Example 6

| Sn | 13 | 14 | 23 |
|---|---|---|---|
| KA | 4.9823609785E−01 | −2.7889354028E+00 | −9.9980072460E−01 |
| A3 | 0.0000000000E+00 | 0.0000000000E+00 | 0.0000000000E+00 |
| A4 | 1.8492977962E−05 | 1.0842991590E−05 | −2.4837861133E−06 |
| A5 | −1.5410899511E−06 | −1.2532252687E−07 | 3.5312211172E−07 |
| A6 | 9.4151840435E−11 | −2.3819791894E−07 | −3.9654796253E−07 |
| A7 | 1.7925955220E−08 | 4.1779168360E−08 | 1.0757270838E−07 |
| A8 | −6.5509412135E−10 | −1.5641804910E−09 | −1.0405251075E−08 |
| A9 | −1.7965349329E−10 | −2.9825459699E−10 | −2.9793582630E−10 |
| A10 | 1.0182897424E−11 | 2.9488768111E−11 | 1.3358052045E−10 |
| A11 | 9.3636740528E−13 | 2.8897903075E−13 | −6.8413614295E−12 |
| A12 | −6.6040421556E−14 | −1.2612285329E−13 | −3.6596929357E−13 |
| A13 | −2.1899353576E−15 | 2.6936353810E−15 | 4.2441075604E−14 |
| A14 | 1.7654613442E−16 | 1.6476373053E−16 | −4.1476770043E−16 |
| A15 | 1.8177448716E−18 | −5.9710325939E−18 | −6.7476409042E−17 |
| A16 | −1.6488460448E−19 | 2.0343876837E−20 | 1.9353807739E−18 |
| Sn | 24 | 37 | 38 |
| KA | 9.1162787147E−01 | −4.5040714238E+00 | 9.8771014748E−01 |
| A3 | 0.0000000000E+00 | 0.0000000000E+00 | 0.0000000000E+00 |
| A4 | 1.0386672948E−06 | −1.7566645205E−05 | −1.7068180787E−05 |
| A5 | 2.2903410369E−07 | 3.4757430115E−07 | −2.2199263901E−07 |
| A6 | −5.5759975825E−08 | 2.1571252901E−07 | 3.0184018198E−07 |
| A7 | −1.0670917952E−09 | −1.0845614784E−08 | −1.3187968885E−08 |
| A8 | 2.0343323911E−09 | −1.7096787729E−09 | −2.5486971555E−09 |
| A9 | −1.9448583750E−10 | 1.2539919374E−10 | 2.2180473031E−10 |
| A10 | −1.0510619347E−11 | 8.7427932475E−12 | 7.0932753859E−12 |
| A11 | 2.2015937305E−12 | −8.7044271319E−13 | −1.2311117638E−12 |
| A12 | −2.6619693345E−14 | −1.6956737130E−14 | 7.0208706427E−15 |
| A13 | −8.4263031551E−15 | 3.0403746994E−15 | 2.9585341426E−15 |
| A14 | 2.8339972360E−16 | −2.4660114791E−17 | −6.4806720992E−17 |
| A15 | 1.0790418308E−17 | −3.9786269995E−18 | −2.6507722998E−18 |
| A16 | −4.8278732949E−19 | 9.2706975507E−20 | 8.1672323197E−20 |

### Example 7

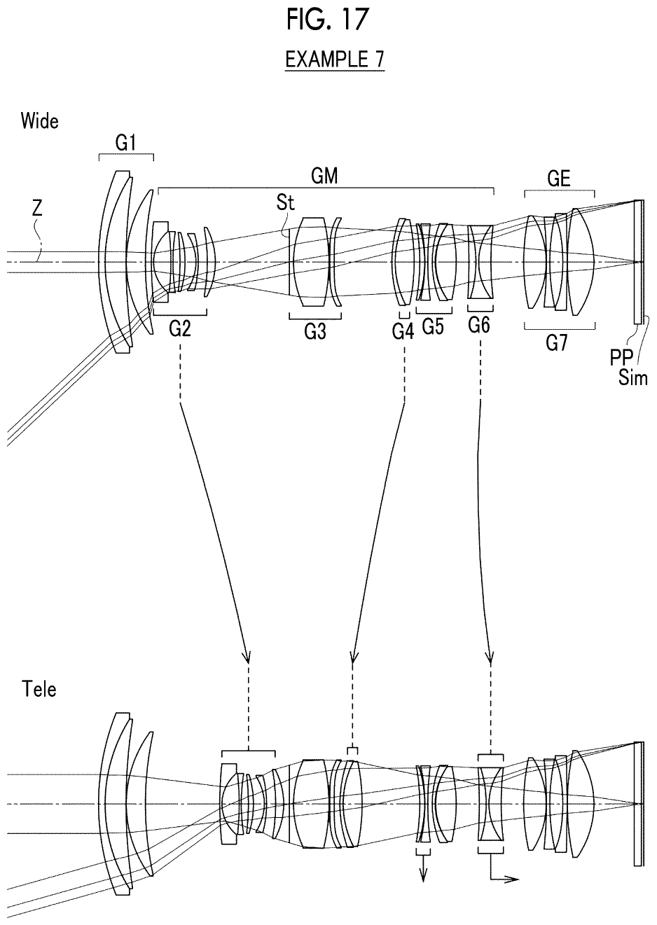

FIG. 17 shows a configuration and a moving path of a zoom lens of Example 7. The zoom lens of Example 7 consists of, in order from the object side to the image side, the first lens group G1 having positive refractive power, the second lens group G2 having negative group G4 having positive refractive power, the fifth lens group G5 having positive refractive power, the sixth lens group G6 having negative refractive power, and the seventh lens group G7 having positive refractive power. The intermediate group GM consists of the second lens group G2, the third lens group G3, the fourth lens group G4, the fifth lens group G5, and the sixth lens group G6. The final lens group GE consists of the seventh lens group G7.

During zooming from the wide angle end to the telephoto end, the second lens group G2, the fourth lens group G4, and the sixth lens group G6 move along the optical axis Z by changing spacings with respect to adjacent lens groups, and other lens groups remain stationary with respect to the image plane Sim. The focus group consists of the sixth lens group G6. During focusing from the infinite distance object to the nearest object, the focus group moves to the image side. The vibration-proof group consists of two lenses including the first and second lenses from the object side in the fifth lens group G5.

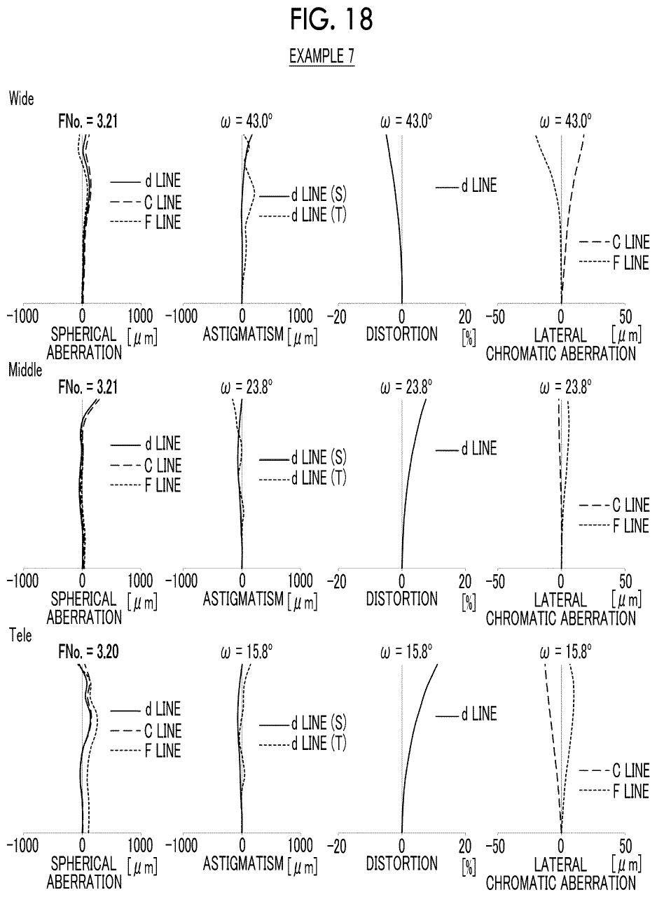

For the zoom lens of Example 7, Tables 19A and 19B show basic lens data, Table 20 shows specifications and a variable surface spacing, Tables 21A and 21B show aspherical coefficients, and FIG. 18 shows each aberration diagram.

TABLE 19A
Example 7

| Sn | R | D | Nd | νd | θg, F | dN/dT | ED |
|---|---|---|---|---|---|---|---|
| 1 | 117.6055 | 2.9092 | 1.84666 | 23.784 | 0.621 | 0.6 | 84.076 |
| 2 | 76.3876 | 9.2394 | 1.55032 | 75.495 | 0.540 | −5.5 | 78.081 |
| 3 | 260.2349 | 0.1000 | | | | | 76.856 |
| 4 | 57.6937 | 8.4664 | 1.72916 | 54.673 | 0.545 | 3.4 | 66.569 |
| 5 | 158.2688 | DD[5] | | | | | 65.395 |
| 6 | 187.1545 | 0.9691 | 1.95375 | 32.317 | 0.590 | 4.5 | 36.914 |
| 7 | 18.8935 | 7.6322 | | | | | 28.382 |
| 8 | −130.5342 | 0.9124 | 1.69679 | 56.185 | 0.540 | 2.5 | 28.110 |
| 9 | 94.0858 | 3.1345 | | | | | 27.45 |
| 10 | −118.7128 | 2.2347 | 1.94595 | 17.984 | 0.655 | 4.2 | 27.162 |
| 11 | −48.7099 | 4.8349 | | | | | 27.168 |
| *12 | −20.6136 | 0.9955 | 1.85135 | 40.098 | 0.570 | 6.1 | 25.406 |
| *13 | −42.7394 | 3.9836 | | | | | 26.368 |
| 14 | −91.4783 | 3.5600 | 1.64769 | 33.723 | 0.593 | 1.1 | 31.075 |
| 15 | −35.6413 | DD[15] | | | | | 31.925 |
| 16 (St) | ∞ | 1.8714 | | | | | 35.803 |
| 17 | 49.0369 | 15.6688 | 1.43700 | 95.099 | 0.534 | −6.2 | 39.666 |
| 18 | −88.6729 | 0.1002 | | | | | 40.816 |
| *19 | 459.8812 | 2.0051 | 1.80625 | 40.907 | 0.569 | 7.9 | 40.686 |
| *20 | 7398.9603 | DD[20] | | | | | 39.797 |
| 21 | 62.0333 | 1.4510 | 1.92286 | 18.896 | 0.650 | 1.3 | 40.030 |
| 22 | 44.7301 | 8.3702 | 1.55032 | 75.495 | 0.540 | −5.5 | 39.276 |
| 23 | −97.1799 | DD[23] | | | | | 39.058 |
| 24 | −99.4772 | 2.1468 | 1.95906 | 17.472 | 0.659 | 4.1 | 35.014 |
| 25 | −60.5974 | 0.1001 | | | | | 35.191 |
| 26 | −82.9202 | 1.2798 | 1.88300 | 40.688 | 0.567 | 4.9 | 34.960 |
| 27 | 135.4993 | 1.9994 | | | | | 35.224 |
| 28 | 49.7352 | 1.2975 | 1.90366 | 31.274 | 0.595 | 4.6 | 35.500 |
| 29 | 30.4956 | 0.2365 | | | | | 34.621 |
| *30 | 32.7511 | 9.0619 | 1.59201 | 67.022 | 0.536 | −0.7 | 34.636 |
| *31 | −68.1895 | DD[31] | | | | | 34.553 |

TABLE 19B
Example 7

| Sn | R | D | Nd | νd | θg, F | dN/dT | ED |
|---|---|---|---|---|---|---|---|
| 32 | −266.7252 | 3.0597 | 1.94595 | 17.984 | 0.655 | 4.2 | 33.588 |
| 33 | −58.3998 | 1.2313 | 1.88300 | 40.688 | 0.567 | 4.9 | 33.563 |
| 34 | 28.4877 | 5.3934 | 1.59270 | 35.271 | 0.594 | 0.2 | 33.154 |
| 35 | 146.1850 | DD[35] | | | | | 41.801 |
| 36 | 104.3139 | 9.9501 | 1.45860 | 90.171 | 0.537 | −6.8 | 42.200 |
| 37 | −41.1398 | 0.1002 | | | | | 40.901 |
| 38 | −205.2079 | 1.5004 | 1.95906 | 17.471 | 0.660 | 4.1 | 40.746 |
| 39 | 100.2307 | 5.7702 | | | | | 40.906 |
| *40 | −78.4691 | 1.8880 | 1.80625 | 40.907 | 0.569 | 7.9 | 43.651 |
| *41 | −252.3095 | 0.1002 | | | | | 46.634 |
| 42 | 121.1275 | 11.7569 | 1.45860 | 90.171 | 0.537 | −6.8 | 48.002 |
| 43 | −44.6737 | 17.7840 | | | | | 54.07 |
| 44 | ∞ | 3.2000 | 1.51680 | 64.197 | 0.534 | 2.7 | 54.588 |
| 45 | ∞ | 1.0106 | | | | | |

TABLE 20
Example 7

| | Wide | Middle | Tele |
|---|---|---|---|
| Zr | 1.00 | 1.87 | 2.83 |
| f | 30.86 | 57.55 | 87.17 |
| FNo. | 3.21 | 3.21 | 3.20 |
| 2ω[°] | 86.0 | 47.6 | 31.6 |
| DD[5] | 2.6767 | 22.2491 | 32.9093 |
| DD[15] | 32.7324 | 13.1600 | 2.4998 |
| DD[20] | 25.5059 | 10.4295 | 2.4996 |
| DD[23] | 2.4997 | 17.5761 | 25.5060 |
| DD[31] | 5.6539 | 5.5176 | 10.1989 |
| DD[35] | 14.5048 | 14.6411 | 9.9598 |

TABLE 21A
Example 7

| Sn | 12 | 13 | 19 |
|---|---|---|---|
| KA | 8.8638938826E−01 | 7.8780355601E−01 | 2.2356405887E+00 |
| A3 | 0.0000000000E+00 | 0.0000000000E+00 | 0.0000000000E+00 |
| A4 | 8.6617291984E−05 | 7.0547227168E−05 | 1.3135924482E−05 |
| A5 | −1.9254509120E−06 | 3.7941263052E−07 | −4.0297179095E−07 |
| A6 | −8.5265885684E−07 | −1.7254557936E−06 | 8.0941350868E−08 |
| A7 | 5.6151860201E−09 | 1.9264774093E−07 | 2.2563131051E−09 |
| A8 | 9.1675604434E−09 | −7.0669865195E−09 | −1.0663066060E−09 |
| A9 | 8.6471937866E−11 | −6.8057265320E−10 | 5.2218782289E−11 |
| A10 | −7.7068710948E−11 | 1.7088149529E−10 | 2.6454226100E−12 |
| A11 | −1.7389122906E−12 | −1.3203552492E−11 | −2.6037287411E−13 |
| A12 | 4.8020362363E−13 | −2.7902389767E−13 | 1.0184792049E−16 |
| A13 | 1.0202689088E−14 | 8.7595282037E−14 | 4.2913563632E−16 |
| A14 | −1.8140365572E−15 | −2.4486160740E−15 | −6.6472530835E−18 |
| A15 | −1.8580846887E−17 | −1.2873235210E−16 | −2.4090714138E−19 |
| A16 | 2.8096919761E−18 | 5.6050771586E−18 | 5.5334389747E−21 |
| Sn | 20 | 30 | 31 |
| KA | 5.0000000469E+00 | −3.0767886718E+00 | 3.7030845736E+00 |
| A3 | 0.0000000000E+00 | 0.0000000000E+00 | 0.0000000000E+00 |
| A4 | 1.6538217205E−05 | 1.3614413917E−05 | −4.9380337640E−06 |
| A5 | −6.6881771675E−07 | −6.0337806061E−07 | 3.3312928484E−06 |
| A6 | 1.0821618543E−07 | 5.0539237571E−07 | −4.5002981867E−07 |
| A7 | 4.4189652258E−09 | −8.9413335051E−08 | 3.2491856720E−08 |
| A8 | −1.6073680259E−09 | 3.7967325498E−09 | −9.0496429615E−10 |
| A9 | 7.2492126004E−11 | 4.8358431122E−10 | −1.5714683937E−10 |
| A10 | 4.8686202540E−12 | −5.3980069211E−11 | 2.4076154579E−11 |
| A11 | −4.3503226317E−13 | 4.5989540544E−13 | −7.9124900301E−13 |
| A12 | −1.5574031441E−15 | 1.6058937359E−13 | −6.6472584375E−14 |
| A13 | 8.6776547100E−16 | −6.5174464215E−15 | 5.0624832499E−15 |
| A14 | −1.3062286148E−17 | −8.4121166164E−17 | −1.1653347145E−17 |
| A15 | −5.9855062518E−19 | 9.4493133626E−18 | −6.8067194762E−18 |
| A16 | 1.4630221648E−20 | −1.4902519377E−19 | 1.4830221173E−19 |

TABLE 21B
Example 7

| Sn | 40 | 41 |
|---|---|---|
| KA | −6.7271466132E−01 | 4.9999984066E+00 |
| A3 | 0.0000000000E+00 | 0.0000000000E+00 |
| A4 | −5.4039094438E−05 | −3.4118702117E−05 |
| A5 | 1.1846817338E−05 | 6.8099415290E−06 |
| A6 | −6.4728291320E−07 | 2.0645680482E−08 |
| A7 | −2.2503171087E−08 | −5.0459185216E−08 |
| A8 | 3.5094980327E−09 | 1.1322779296E−09 |
| A9 | −1.4672163517E−10 | 1.5900913329E−10 |
| A10 | 1.6742371761E−13 | −5.5394686105E−12 |
| A11 | 4.8471493469E−13 | −2.2918160612E−13 |
| A12 | −2.5940175946E−14 | 1.0123686681E−14 |
| A13 | −3.2842467074E−17 | 1.4395086986E−16 |
| A14 | 3.3463684003E−17 | −7.9639112811E−18 |
| A15 | −6.3651893244E−19 | −2.7646632253E−20 |
| A16 | −4.1911710298E−22 | 2.1670207049E−21 |

### Example 8

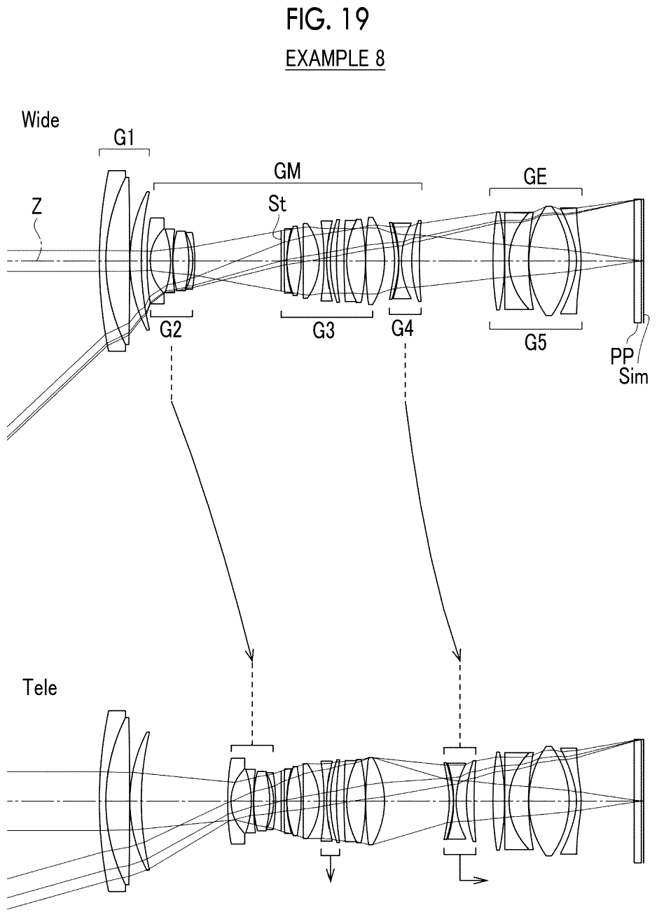

FIG. 19 shows a configuration and a moving path of a zoom lens of Example 8. The zoom lens of Example 8 consists of, in order from the object side to the image side, the first lens group G1 having positive refractive power, the second lens group G2 having negative refractive power, the third lens group G3 having positive refractive power, the fourth lens group G4 having negative refractive power, and the fifth lens group G5 having positive refractive power. The intermediate group GM consists of the second lens group G2, the third lens group G3, and the fourth lens group G4. The final lens group GE consists of the fifth lens group G5.

During zooming from the wide angle end to the telephoto end, the second lens group G2 and the fourth lens group G4 move along the optical axis Z by changing spacings with respect to adjacent lens groups, and other lens groups remain stationary with respect to the image plane Sim. The focus group consists of the fourth lens group G4. During focusing from the infinite distance object to the nearest object, the focus group moves to the image side. The vibration-proof group consists of two lenses including the fourth and fifth lenses from the object side in the third lens group G3.

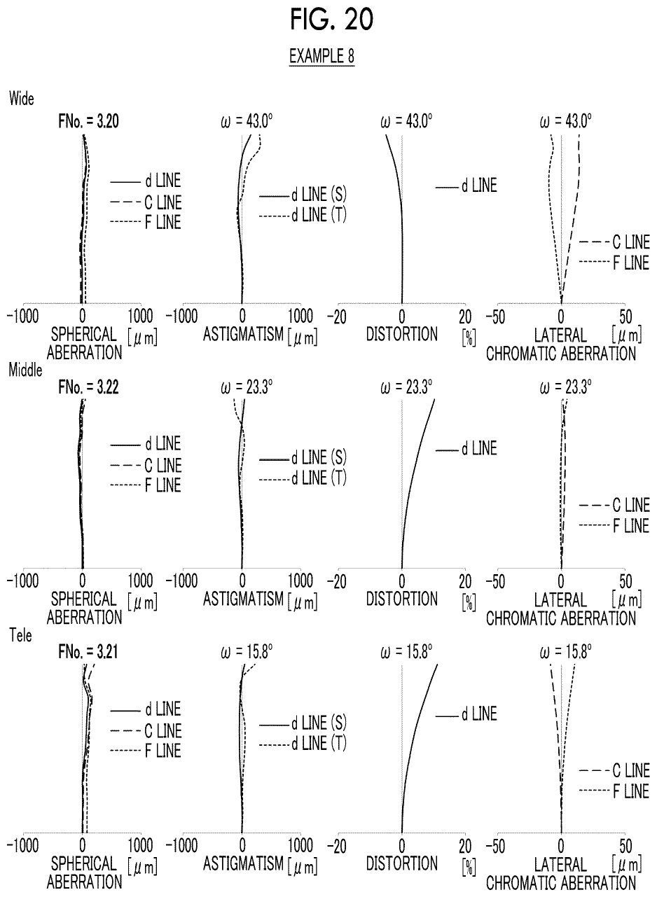

For the zoom lens of Example 8, Tables 22A and 22B show basic lens data, Table 23 shows specifications and a variable surface spacing, Tables 24A and 24B show aspherical coefficients, and FIG. 20 shows each aberration diagram.

TABLE 22A
Example 8

| Sn | R | D | Nd | νd | θg, F | dN/dT | ED |
|---|---|---|---|---|---|---|---|
| 1 | 215.5534 | 2.8959 | 1.95203 | 26.195 | 0.610 | 4.6 | 83.681 |
| 2 | 90.4813 | 10.5500 | 1.69680 | 55.459 | 0.543 | 4.1 | 77.396 |
| 3 | −1904.6804 | 0.1002 | | | | | 76.18 |
| 4 | 72.0432 | 5.0330 | 1.80400 | 46.527 | 0.558 | 4.5 | 64.047 |
| 5 | 141.9751 | DD[5] | | | | | 62.804 |
| *6 | −609.7675 | 1.4044 | 1.85135 | 40.098 | 0.570 | 6.1 | 38.794 |
| *7 | 24.9384 | 8.9532 | | | | | 29.779 |
| 8 | −45.5830 | 0.9672 | 1.72916 | 54.537 | 0.545 | 3.4 | 28.953 |
| 9 | 121.7014 | 0.0998 | | | | | 27.762 |
| 10 | 55.6831 | 7.0998 | 1.80518 | 25.456 | 0.615 | −0.7 | 27.423 |
| 11 | −52.8560 | 1.7395 | | | | | 25.872 |
| 12 | −28.3201 | 0.8602 | 1.83481 | 42.743 | 0.565 | 5.0 | 25.309 |
| 13 | −81.1940 | DD[13] | | | | | 26.364 |
| 14 (St) | ∞ | 1.3102 | | | | | 27.897 |
| 15 | 572.4325 | 1.1637 | 1.95375 | 32.312 | 0.590 | 5.3 | 28.945 |
| 16 | 54.4530 | 0.1012 | | | | | 29.924 |
| *17 | 43.0435 | 6.2313 | 1.58313 | 59.385 | 0.542 | 3.8 | 31.131 |
| *18 | −52.1563 | 0.9956 | | | | | 32.042 |
| 19 | −20402.0597 | 7.0616 | 1.52841 | 76.452 | 0.540 | −5.9 | 33.874 |
| 20 | −31.1023 | 2.1185 | | | | | 34.653 |
| 21 | −127.1162 | 1.1900 | 1.77250 | 49.624 | 0.550 | 5.0 | 36.476 |
| 22 | 77.8533 | 1.3684 | | | | | 37.016 |
| 23 | 64.1303 | 2.6840 | 1.84666 | 23.835 | 0.620 | 1.4 | 38.324 |
| 24 | 131.4517 | 3.3473 | | | | | 38.349 |
| 25 | 330.8537 | 1.1986 | 1.85883 | 29.997 | 0.598 | 4.7 | 37.072 |
| 26 | 43.2637 | 8.3191 | 1.43700 | 95.099 | 0.534 | −6.2 | 37.585 |
| 27 | −96.0439 | 0.1001 | | | | | 38.525 |
| 28 | 159.2533 | 8.3307 | 1.72916 | 54.684 | 0.545 | 2.9 | 40.096 |
| 29 | −41.4939 | DD[29] | | | | | 40.379 |
| *30 | −44.5328 | 1.7950 | 1.68948 | 31.023 | 0.599 | 0.2 | 35.529 |
| *31 | −40.4836 | 0.1208 | | | | | 35.447 |
| 32 | −59.5162 | 1.1269 | 1.73400 | 51.508 | 0.548 | 6.1 | 35.065 |
| 33 | 36.9145 | 4.5256 | | | | | 34.253 |
| 34 | 59.7158 | 3.3763 | 1.95906 | 17.472 | 0.659 | 4.1 | 37.143 |
| 35 | 227.4784 | DD[35] | | | | | 37.213 |

TABLE 22B
Example 8

| Sn | R | D | Nd | νd | θg, F | dN/dT | ED |
|---|---|---|---|---|---|---|---|
| 36 | 152.7895 | 5.1521 | 1.65844 | 50.843 | 0.558 | 3.3 | 45.338 |
| 37 | −115.1303 | 0.1001 | | | | | 45.381 |
| 38 | −40328.2308 | 1.8973 | 1.92119 | 23.956 | 0.620 | 2.4 | 44.888 |
| 39 | 32.6001 | 8.6512 | 1.51741 | 52.157 | 0.562 | −0.4 | 43.778 |
| 40 | 120.6065 | 0.1002 | | | | | 44.675 |
| 41 | 45.6323 | 17.8750 | 1.48749 | 70.439 | 0.529 | −1.9 | 49.232 |
| 42 | −45.1365 | 3.2431 | | | | | 49.38 |
| *43 | −28.2004 | 2.0726 | 1.80625 | 40.907 | 0.569 | 7.9 | 46.699 |
| *44 | −43.9037 | 23.4852 | | | | | 47.629 |
| 45 | ∞ | 3.2000 | 1.51680 | 64.197 | 0.534 | 2.7 | 53.984 |
| 46 | ∞ | 0.9741 | | | | | 54.531 |

TABLE 23
Example 8

| | Wide | Middle | Tele |
|---|---|---|---|
| Zr | 1.00 | 1.87 | 2.83 |
| f | 30.86 | 57.55 | 87.20 |
| FNo. | 3.20 | 3.22 | 3.21 |
| 2ω[°] | 86.0 | 46.6 | 31.6 |
| DD[5] | 2.5880 | 25.9158 | 38.3685 |
| DD[13] | 38.2667 | 14.9389 | 2.4862 |
| DD[29] | 4.4998 | 15.9165 | 28.7455 |
| DD[35] | 32.5882 | 21.1715 | 8.3425 |

TABLE 24A
Example 8

| Sn | 6 | 7 | 17 |
|---|---|---|---|
| KA | −5.0000000893E+00 | 1.5567044789E+00 | 4.1359789516E+00 |
| A3 | 0.0000000000E+00 | 0.0000000000E+00 | 0.0000000000E+00 |
| A4 | 1.3626688780E−04 | 1.3700598454E−04 | −7.8501787160E−06 |
| A5 | −1.3943885662E−05 | −1.5114688294E−05 | −1.4525589345E−06 |
| A6 | −1.2473197458E−07 | 3.3189622370E−07 | 5.2206745230E−07 |
| A7 | 9.3392372257E−08 | −1.2452213595E−08 | −8.3416359494E−08 |
| A8 | −4.2568660876E−09 | 7.1261618146E−09 | 2.9041390185E−09 |
| A9 | −1.4161445827E−10 | −1.7948308127E−10 | 7.4841938791E−10 |
| A10 | 1.8773264731E−11 | −1.1345936108E−10 | −8.4694603681E−11 |
| A11 | −4.2015627318E−13 | 1.0583905128E−11 | 5.2267108126E−13 |
| A12 | −2.3044856153E−14 | 1.8640812111E−13 | 3.4515466519E−13 |
| A13 | 1.4686233139E−15 | −5.8386620623E−14 | −1.5048530041E−14 |
| A14 | −9.2959329135E−18 | 1.2877887735E−15 | −2.4904839268E−16 |
| A15 | −1.1766679804E−18 | 9.1403683050E−17 | 2.7859304124E−17 |
| A16 | 2.4864493600E−20 | −3.3723965423E−18 | −4.6598088564E−19 |
| Sn | 18 | 30 | 31 |
| KA | −1.0023382329E+00 | 1.1059095571E+00 | 9.9708939919E−01 |
| A3 | 0.0000000000E+00 | 0.0000000000E+00 | 0.0000000000E+00 |
| A4 | 9.1501683775E−06 | 1.8262429407E−05 | 1.4203004677E−05 |
| A5 | −2.1936068564E−07 | 1.5332847046E−06 | 1.6226075815E−06 |
| A6 | 1.6993006512E−08 | −2.4331582038E−07 | −2.7673760774E−07 |
| A7 | 1.3115473655E−08 | 2.6095835660E−09 | 1.0525342061E−08 |
| A8 | −3.2345225167E−09 | 2.0208294863E−09 | 1.2874590198E−09 |
| A9 | 2.3480660031E−10 | −1.3784108952E−10 | −1.4111901470E−10 |
| A10 | 9.5260746649E−12 | −6.0395560557E−12 | −6.5425853194E−13 |
| A11 | −1.9335699559E−12 | 8.4303508130E−13 | 5.5438716225E−13 |
| A12 | 3.1871750283E−14 | −1.5756866882E−15 | −9.4547858935E−15 |
| A13 | 5.1841997073E−15 | −2.0518754500E−15 | −9.5122980649E−16 |
| A14 | −1.7889075929E−16 | 3.7785384349E−17 | 2.2672668712E−17 |
| A15 | −4.8761327413E−18 | 1.7912201176E−18 | 6.0940865227E−19 |
| A16 | 2.1850142815E−19 | −4.8979562546E−20 | −1.5565554067E−20 |

TABLE 24B
Example 8

| Sn | 43 | 44 |
|---|---|---|
| KA | 1.0427911636E+00 | 1.3026194898E+00 |
| A3 | 0.0000000000E+00 | 0.0000000000E+00 |
| A4 | 3.7121219845E−05 | 3.9662638199E−05 |
| A5 | −1.0547470281E−06 | −2.2898973157E−06 |
| A6 | 1.2802258124E−08 | 2.1497883454E−07 |
| A7 | 1.3267908913E−08 | −4.7915312935E−09 |
| A8 | −1.8729497970E−09 | −1.2018089935E−09 |
| A9 | 3.3332162894E−11 | 6.8772239515E−11 |
| A10 | 6.2914763454E−12 | 1.4345970553E−12 |
| A11 | −2.8147726636E−13 | −1.6083491213E−13 |
| A12 | −5.6460233132E−15 | 4.3236370288E−16 |
| A13 | 5.0004421885E−16 | 1.5208801985E−16 |
| A14 | −2.7716001330E−18 | −1.7363594824E−18 |
| A15 | −2.7938582497E−19 | −5.2678409125E−20 |
| A16 | 4.4779720026E−21 | 8.0529530572E−22 |

### Example 9

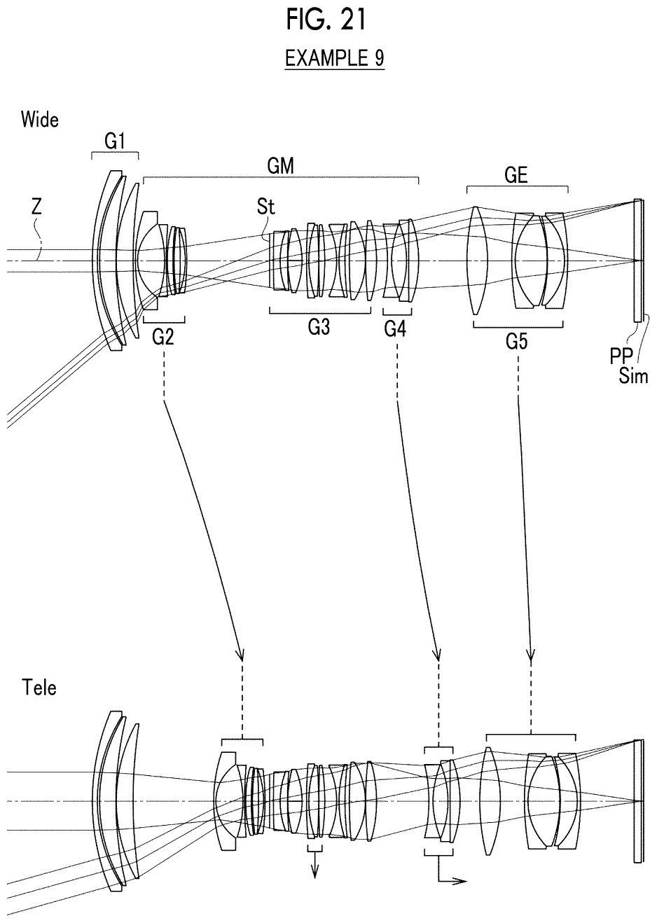

FIG. 21 shows a configuration and a moving path of a zoom lens of Example 9. The zoom lens of Example 9 consists of, in order from the object side to the image side, the first lens group G1 having positive refractive power, the second lens group G2 having negative refractive power, the third lens group G3 having positive refractive power, the fourth lens group G4 having negative refractive power, and the fifth lens group G5 having positive refractive power. The intermediate group GM consists of the second lens group G2, the third lens group G3, and the fourth lens group G4. The final lens group GE consists of the fifth lens group G5.

During zooming from the wide angle end to the telephoto end, the second lens group G2, the fourth lens group G4, and the fifth lens group G5 move along the optical axis Z by changing spacings with respect to adjacent lens groups, and other lens groups remain stationary with respect to the image plane Sim. The focus group consists of the fourth lens group G4. During focusing from the infinite distance object to the nearest object, the focus group moves to the image side. The vibration-proof group consists of three lenses including the fourth to sixth lenses from the object side in the third lens group G3.

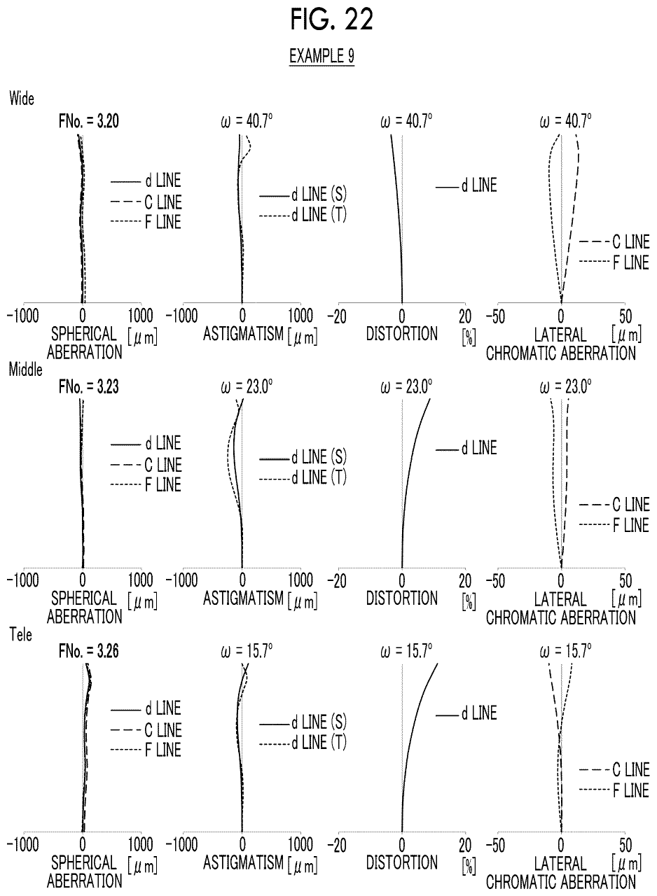

For the zoom lens of Example 9, Tables 25A and 25B show basic lens data, Table 26 shows specifications and a variable surface spacing, Table 27 shows aspherical coefficients, and FIG. 22 shows each aberration diagram.

TABLE 25A
Example 9

| Sn | R | D | Nd | νd | θg, F | dN/dT | ED |
|---|---|---|---|---|---|---|---|
| 1 | 110.2210 | 2.2036 | 1.84666 | 23.784 | 0.619 | 1.4 | 83.268 |
| 2 | 76.4706 | 0.9938 | | | | | 78.472 |
| 3 | 78.2673 | 7.2442 | 1.61800 | 63.395 | 0.540 | −2.2 | 78.043 |
| 4 | 169.3749 | 0.1500 | | | | | 76.933 |
| 5 | 78.2349 | 7.4571 | 1.75500 | 52.318 | 0.548 | 4.2 | 71.661 |
| 6 | 248.0898 | DD[6] | | | | | 70.238 |
| 7 | 73.8923 | 0.9931 | 1.75500 | 52.318 | 0.548 | 4.2 | 45.175 |
| 8 | 20.9253 | 11.9716 | | | | | 34.06 |
| 9 | −54.8583 | 0.7428 | 1.75500 | 52.318 | 0.548 | 4.2 | 33.296 |
| 10 | 211.6993 | 0.5002 | | | | | 32.2 |
| *11 | 87.8964 | 2.4744 | 1.58313 | 59.385 | 0.542 | 3.8 | 31.500 |
| *12 | 183.3704 | 0.5000 | | | | | 30.818 |
| 13 | 111.4998 | 2.6772 | 1.89286 | 20.361 | 0.639 | 1.2 | 30.506 |
| 14 | −223.7188 | 2.2369 | | | | | 30.039 |
| 15 | −43.7924 | 0.6597 | 1.72916 | 54.094 | 0.545 | 4.9 | 29.932 |
| 16 | −119.4961 | DD[16] | | | | | 29.522 |
| 17 (St) | ∞ | 1.6992 | | | | | 24.789 |
| 18 | 438.7809 | 2.9888 | 1.90366 | 31.274 | 0.595 | 4.6 | 25.781 |
| 19 | 40.2049 | 3.2860 | 1.59270 | 35.309 | 0.593 | 0.2 | 27.008 |
| 20 | 173.5669 | 0.1000 | | | | | 27.678 |
| *21 | 55.8032 | 6.2936 | 1.49710 | 81.558 | 0.538 | −5.5 | 28.832 |
| *22 | −39.2075 | 1.9984 | | | | | 29.452 |
| 23 | 234.4961 | 1.0388 | 1.89286 | 20.361 | 0.639 | 1.2 | 32.610 |
| 24 | 55.1369 | 4.3519 | 1.60342 | 37.999 | 0.582 | 2.7 | 32.741 |
| 25 | −235.5388 | 0.1001 | | | | | 32.959 |
| 26 | 517.7246 | 2.5907 | 1.80610 | 33.269 | 0.588 | 4.7 | 33.135 |
| 27 | −112.2451 | 5.0102 | | | | | 33.216 |
| 28 | −40.9833 | 1.0715 | 1.80610 | 33.269 | 0.588 | 4.7 | 31.339 |
| 29 | 59.3773 | 2.6103 | 1.80809 | 22.764 | 0.629 | −2.6 | 33.525 |
| 30 | 137.7324 | 1.9243 | | | | | 33.935 |
| 31 | 214.5190 | 7.1466 | 1.55032 | 75.495 | 0.540 | −5.5 | 35.353 |
| 32 | −36.2734 | 0.1000 | | | | | 36.107 |
| 33 | 177.9983 | 4.8443 | 1.77400 | 49.590 | 0.555 | 3.8 | 36.819 |
| 34 | −67.8729 | DD[34] | | | | | 36.788 |

TABLE 25B
Example 9

| Sn | R | D | Nd | νd | θg, F | dN/dT | ED |
|---|---|---|---|---|---|---|---|
| *35 | −113.6642 | 1.8374 | 1.69350 | 53.185 | 0.548 | 3.3 | 33.904 |
| *36 | 37.4033 | 6.6360 | | | | | 33.902 |
| 37 | −47.3820 | 0.9196 | 1.48749 | 70.440 | 0.531 | −1.4 | 34.111 |
| 38 | 3686.9921 | 4.4425 | 1.92286 | 18.896 | 0.650 | 1.3 | 37.364 |
| 39 | −59.0527 | DD[39] | | | | | 38.088 |
| 40 | 106.5974 | 9.1294 | 1.60300 | 65.443 | 0.540 | −2.4 | 49.682 |
| 41 | −69.0461 | 10.6956 | | | | | 49.819 |
| 42 | 132.0703 | 1.5549 | 1.87070 | 40.728 | 0.568 | 3.9 | 43.976 |
| 43 | 30.7494 | 14.1184 | 1.49700 | 81.607 | 0.539 | −6.2 | 41.364 |
| 44 | −61.1843 | 0.1998 | | | | | 41.383 |
| 45 | −82.1955 | 7.5155 | 1.49700 | 81.607 | 0.539 | −6.2 | 40.940 |
| 46 | −29.3683 | 1.4177 | 1.92286 | 18.899 | 0.650 | 2.5 | 40.824 |
| 47 | −113.0643 | DD[47] | | | | | 43.561 |
| 48 | ∞ | 3.2000 | 1.51680 | 64.197 | 0.534 | 2.7 | 53.654 |
| 49 | ∞ | 0.9882 | | | | | 54.367 |

TABLE 26
Example 9

| | Wide | Middle | Tele |
|---|---|---|---|
| Zr | 1.00 | 1.79 | 2.65 |
| f | 32.99 | 59.20 | 87.41 |
| FNo. | 3.20 | 3.23 | 3.26 |
| 2ω[°] | 81.4 | 46.0 | 31.4 |
| DD[6] | 1.0039 | 23.5325 | 35.7181 |
| DD[16] | 36.7071 | 14.1785 | 1.9929 |
| DD[34] | 4.8029 | 14.4477 | 23.1632 |
| DD[39] | 21.4121 | 15.3325 | 8.7325 |
| DD[47] | 29.4230 | 25.8577 | 23.7423 |

TABLE 27
Example 9

| Sn | 11 | 12 | 21 |
|---|---|---|---|
| KA | −5.9765410624E−01 | 4.9999999032E+00 | −5.5908907622E−02 |
| A3 | 0.0000000000E+00 | 0.0000000000E+00 | 0.0000000000E+00 |
| A4 | 3.2198038829E−06 | 3.5397350064E−07 | −5.1749421887E−06 |
| A5 | 4.0363675147E−06 | 3.3468734811E−06 | 1.2434586069E−06 |
| A6 | −5.1846015205E−07 | −3.8473051043E−07 | −4.4144262001E−07 |
| A7 | −8.3733075148E−09 | −1.7579794419E−08 | 9.0832681265E−08 |
| A8 | 6.8026643023E−09 | 5.8633260506E−09 | −7.7976707969E−09 |
| A9 | −3.8414355708E−10 | −1.8538157929E−10 | −2.8336781896E−10 |
| A10 | −2.3949203265E−11 | −2.8663375957E−11 | 9.8907439006E−11 |
| A11 | 2.9143020105E−12 | 1.8649394964E−12 | −4.3275356200E−12 |
| A12 | −1.2061924644E−14 | 4.2831096459E−14 | −2.7535155389E−13 |
| A13 | −7.8923926854E−15 | −5.6087237381E−15 | 2.5581041410E−14 |
| A14 | 2.0758416348E−16 | 4.3779365333E−17 | −1.1893311053E−16 |
| A15 | 7.4906594038E−18 | 5.7014497845E−18 | −3.7583418306E−17 |
| A16 | −2.8711940400E−19 | −1.2158767524E−19 | 8.9693824989E−19 |
| Sn | 22 | 35 | 36 |
| KA | 1.1618997918E+00 | −2.6136009955E+00 | 9.3143555855E−01 |
| A3 | 0.0000000000E+00 | 0.0000000000E+00 | 0.0000000000E+00 |
| A4 | 2.0751603608E−06 | −2.8939561390E−05 | −3.1768060012E−05 |
| A5 | −1.6178449468E−07 | −1.8509918890E−06 | −1.6563480228E−06 |
| A6 | 7.4220616932E−08 | 7.4494749138E−07 | 7.1875378051E−07 |
| A7 | −8.8315662734E−09 | −2.4099429722E−08 | −2.5291810212E−08 |
| A8 | 4.2211630075E−10 | −6.7110303027E−09 | −6.0492827999E−09 |
| A9 | 1.0110387735E−11 | 5.2010556778E−10 | 4.8617952660E−10 |
| A10 | −7.6005962668E−12 | 2.3100626299E−11 | 1.8545928726E−11 |
| A11 | 8.7834883739E−13 | −3.3182077311E−12 | −2.8853049934E−12 |
| A12 | 2.6632832716E−15 | 2.8220949729E−15 | 9.7349117755E−15 |
| A13 | −5.1582076803E−15 | 9.1205643498E−15 | 7.4333968055E−15 |
| A14 | 1.5413057524E−16 | −1.8050232740E−16 | −1.5633836924E−16 |
| A15 | 8.2225093409E−18 | −9.2767440616E−18 | −7.1233771773E−18 |
| A16 | −3.3967242637E−19 | 2.7852647461E−19 | 2.1855709301E−19 |

### Example 10

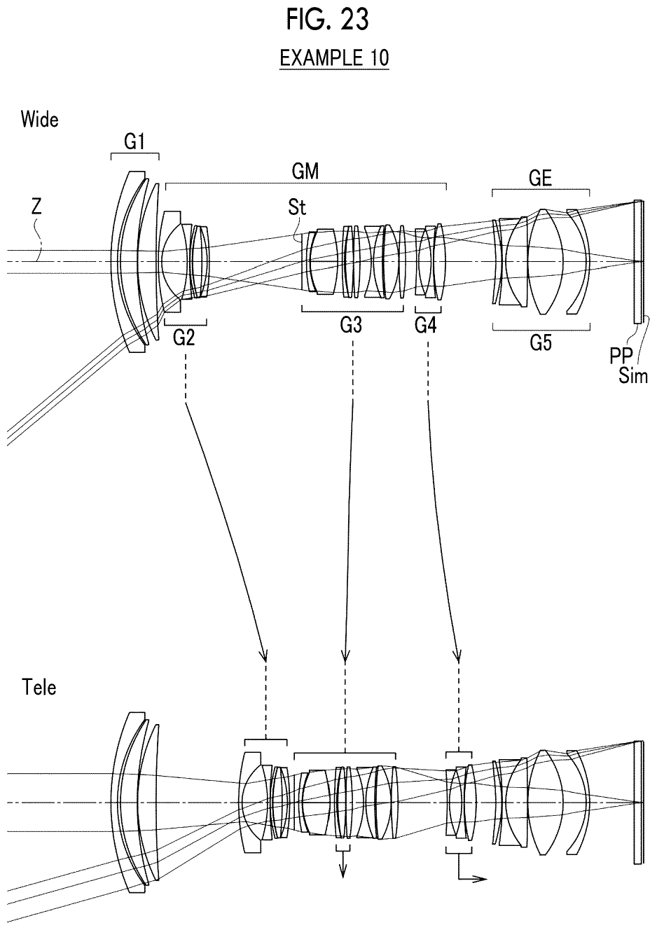

FIG. 23 shows a configuration and a moving path of a zoom lens of Example 10. The zoom lens of Example 10 consists of, in order from the object side to the image side, the first lens group G1 having positive refractive power, the second lens group G2 having negative lens group G3, and the fourth lens group G4. The final lens group GE consists of the fifth lens group G5.

During zooming from the wide angle end to the telephoto end, the second lens group G2, the third lens group G3, and the fourth lens group G4 move along the optical axis Z by changing spacings with respect to adjacent lens groups, and other lens groups remain stationary with respect to the image plane Sim. The focus group consists of the fourth lens group G4. During focusing from the infinite distance object to the nearest object, the focus group moves to the image side. The vibration-proof group consists of three lenses including third to fifth lenses from the object side in the third lens group G3.

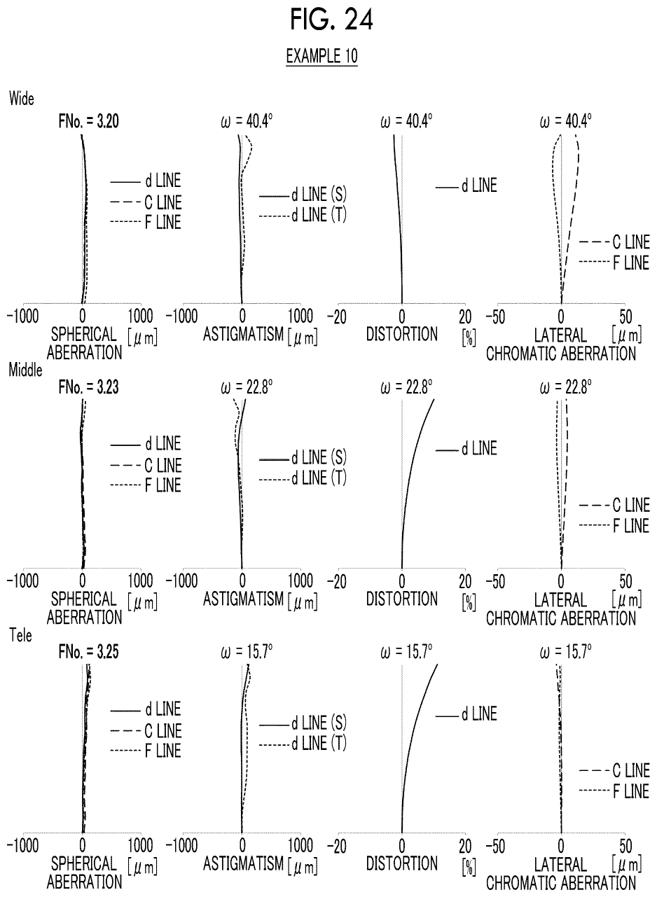

For the zoom lens of Example 10, Tables 28A and 28B show basic lens data, Table 29 shows specifications and a variable surface spacing, Table 30 shows aspherical coefficients, and FIG. 24 shows each aberration diagram.

TABLE 28A
Example 10

| Sn | R | D | Nd | νd | θg, F | dN/dT | ED |
|---|---|---|---|---|---|---|---|
| 1 | 110.1398 | 2.8877 | 1.84666 | 23.784 | 0.619 | 1.4 | 83.448 |
| 2 | 67.0676 | 1.3531 | | | | | 76.906 |
| 3 | 70.3089 | 7.4378 | 1.69343 | 53.300 | 0.548 | 4.1 | 76.572 |
| 4 | 143.2992 | 0.1500 | | | | | 75.568 |
| 5 | 84.5191 | 8.1666 | 1.69211 | 54.538 | 0.548 | −0.3 | 72.100 |
| 6 | 533.9919 | DD[6] | | | | | 70.789 |
| 7 | 100.7158 | 1.5151 | 1.80400 | 46.597 | 0.558 | 4.3 | 46.239 |
| 8 | 22.5663 | 11.2932 | | | | | 34.983 |
| 9 | −61.9548 | 1.1121 | 1.75500 | 52.348 | 0.548 | 3.4 | 34.437 |
| 10 | 151.0315 | 0.1000 | | | | | 33.404 |
| *11 | 83.2062 | 1.0324 | 1.58313 | 59.385 | 0.542 | 3.8 | 33.098 |
| *12 | 72.4258 | 0.1625 | | | | | 32.777 |
| 13 | 65.7468 | 4.0936 | 1.92286 | 20.880 | 0.639 | 1.8 | 32.761 |
| 14 | −165.8644 | 2.3061 | | | | | 32.37 |
| 15 | −44.9744 | 1.0099 | 1.83400 | 37.210 | 0.578 | 10.1 | 32.281 |
| 16 | −108.5967 | DD[16] | | | | | 32.355 |
| 17 (St) | ∞ | 2.0053 | | | | | 25.625 |
| 18 | 71.5704 | 1.5435 | 1.95375 | 32.324 | 0.591 | 4.4 | 27.271 |
| 19 | 36.7786 | 0.1742 | | | | | 27.415 |
| *20 | 32.6998 | 11.9006 | 1.49710 | 81.558 | 0.538 | −5.5 | 28.143 |
| *21 | −52.6400 | 1.9996 | | | | | 29.919 |
| 22 | 179.7390 | 1.0345 | 1.92286 | 18.899 | 0.650 | 2.5 | 32.495 |
| 23 | 69.6530 | 0.4429 | | | | | 32.559 |
| 24 | 88.8369 | 3.4731 | 1.62291 | 58.302 | 0.544 | 3.6 | 32.569 |
| 25 | −169.1621 | 0.1002 | | | | | 32.77 |
| 26 | 247.5081 | 2.8515 | 1.78589 | 44.174 | 0.563 | 8.6 | 32.997 |
| 27 | −124.4918 | 4.9624 | | | | | 33.031 |
| 28 | −42.2290 | 1.0384 | 1.74950 | 35.332 | 0.582 | 5.4 | 30.883 |
| 29 | 42.1984 | 3.9356 | 1.69895 | 30.130 | 0.602 | 1.1 | 32.643 |
| 30 | 166.4188 | 0.5934 | | | | | 33.051 |
| 31 | 157.1907 | 6.6633 | 1.61999 | 63.763 | 0.543 | −4.1 | 33.480 |
| 32 | −36.9665 | 0.1002 | | | | | 33.965 |
| 33 | 178.9146 | 2.9501 | 1.95375 | 32.324 | 0.591 | 4.4 | 33.192 |
| 34 | −129.2674 | DD[34] | | | | | 33.001 |

TABLE 28B
Example 10

| Sn | R | D | Nd | νd | θg, F | dN/dT | ED |
|---|---|---|---|---|---|---|---|
| 35 | −203.1449 | 0.9836 | 1.80610 | 41.016 | 0.569 | 9.1 | 30.296 |
| 36 | 40.8954 | 5.4569 | | | | | 29.591 |
| 37 | −46.8323 | 1.0458 | 1.55352 | 71.717 | 0.540 | −6.1 | 29.760 |
| 38 | 147.6272 | 0.1001 | | | | | 32.633 |
| 39 | 79.9232 | 5.2619 | 1.92286 | 18.896 | 0.650 | 1.3 | 34.014 |
| 40 | −77.2155 | DD[40] | | | | | 34.536 |
| *41 | −89.0895 | 2.7075 | 1.69350 | 53.185 | 0.548 | 3.3 | 38.115 |
| *42 | −49.3111 | 0.2000 | | | | | 38.41 |
| 43 | −135.4985 | 1.5674 | 1.92119 | 23.956 | 0.620 | 2.4 | 38.388 |
| 44 | 32.4016 | 9.6104 | 1.53996 | 59.682 | 0.543 | 1.6 | 39.663 |
| 45 | −756.3621 | 0.1502 | | | | | 41.348 |
| 46 | 55.2785 | 15.6439 | 1.49700 | 81.607 | 0.539 | −6.2 | 47.482 |
| 47 | −41.2700 | 10.2068 | | | | | 48.103 |
| 48 | −34.3204 | 1.5380 | 1.92286 | 20.886 | 0.638 | 2.3 | 44.529 |
| 49 | −53.2150 | 19.7378 | | | | | 47.093 |
| 50 | ∞ | 3.2000 | 1.51680 | 64.197 | 0.534 | 2.7 | 53.940 |
| 51 | ∞ | 0.9870 | | | | | 54.508 |

TABLE 29
Example 10

| | Wide | Middle | Tele |
|---|---|---|---|
| Zr | 1.00 | 1.79 | 2.65 |
| f | 32.98 | 59.19 | 87.41 |
| FNo. | 3.20 | 3.23 | 3.25 |
| 2ω[°] | 80.8 | 45.6 | 31.4 |
| DD[6] | 1.0046 | 24.1220 | 36.6621 |
| DD[16] | 41.0078 | 15.7906 | 2.0043 |
| DD[34] | 4.8039 | 13.1871 | 21.8370 |
| DD[40] | 22.2759 | 15.9924 | 8.5888 |

TABLE 30
Example 10

| Sn | 11 | 12 | 20 |
|---|---|---|---|
| KA | −6.4461508402E−01 | 2.2554725773E−01 | 1.3272658016E+00 |
| A3 | −4.6765962073E−20 | 0.0000000000E+00 | 0.0000000000E+00 |
| A4 | 1.4443812383E−06 | −2.8912508815E−06 | −7.6146704546E−06 |
| A5 | 5.6725884389E−06 | 5.9535519481E−06 | 2.7860917457E−06 |
| A6 | −4.6872147222E−07 | −4.2773489167E−07 | −9.6931505839E−07 |
| A7 | −3.8475085583E−08 | −5.9953786267E−08 | 1.7894459751E−07 |
| A8 | 5.9729947053E−09 | 8.2792356792E−09 | −1.3212520797E−08 |
| A9 | 3.9260123985E−11 | 8.4595068071E−11 | −9.0043083485E−10 |
| A10 | −3.2193724353E−11 | −5.5060041309E−11 | 2.3291435955E−10 |
| A11 | 4.3076206922E−13 | 1.3623551052E−12 | −1.0131126038E−11 |
| A12 | 8.8031280780E−14 | 1.4946464953E−13 | −7.9351612008E−13 |
| A13 | −1.4888944678E−15 | −6.4647509434E−15 | 7.9759949616E−14 |
| A14 | −1.2536642537E−16 | −1.1929694320E−16 | −5.1740518918E−16 |
| A15 | 1.4267739868E−18 | 8.3717387765E−18 | −1.4503629604E−16 |
| A16 | 7.6334133594E−20 | −7.0156859992E−20 | 4.0741054971E−18 |
| Sn | 21 | 41 | 42 |
| KA | 6.1176122826E−01 | −4.7333466227E+00 | 3.2195855716E−01 |
| A3 | 0.0000000000E+00 | 0.0000000000E+00 | 0.0000000000E+00 |
| A4 | 3.4662829931E−06 | 2.7687402786E−06 | 4.6380111036E−06 |
| A5 | −7.9998936005E−07 | 1.0158361370E−06 | 1.1368930079E−06 |
| A6 | 2.0227425135E−07 | −9.2712738575E−08 | −9.3593943899E−08 |
| A7 | −1.3574074920E−08 | −7.8993835630E−09 | −9.0126333325E−09 |
| A8 | −2.3060933268E−09 | 1.0268020314E−09 | 1.0106948855E−09 |
| A9 | 3.8732629801E−10 | 4.8422373897E−11 | 5.6773353730E−11 |
| A10 | −1.3489175985E−12 | −6.0417432328E−12 | −6.1400809120E−12 |
| A11 | −2.6534262765E−12 | −1.7149883403E−13 | −1.9008570843E−13 |
| A12 | 9.7926369582E−14 | 2.0231902428E−14 | 2.0678006083E−14 |
| A13 | 6.9952806623E−15 | 2.9687846177E−16 | 2.8830488216E−16 |
| A14 | −3.7840058396E−16 | −3.5541880423E−17 | −3.5104514095E−17 |
| A15 | −6.0821304490E−18 | −1.9657071572E−19 | −1.5560003711E−19 |
| A16 | 4.2534931070E−19 | 2.4879495064E−20 | 2.3170567516E−20 |

### Example 11

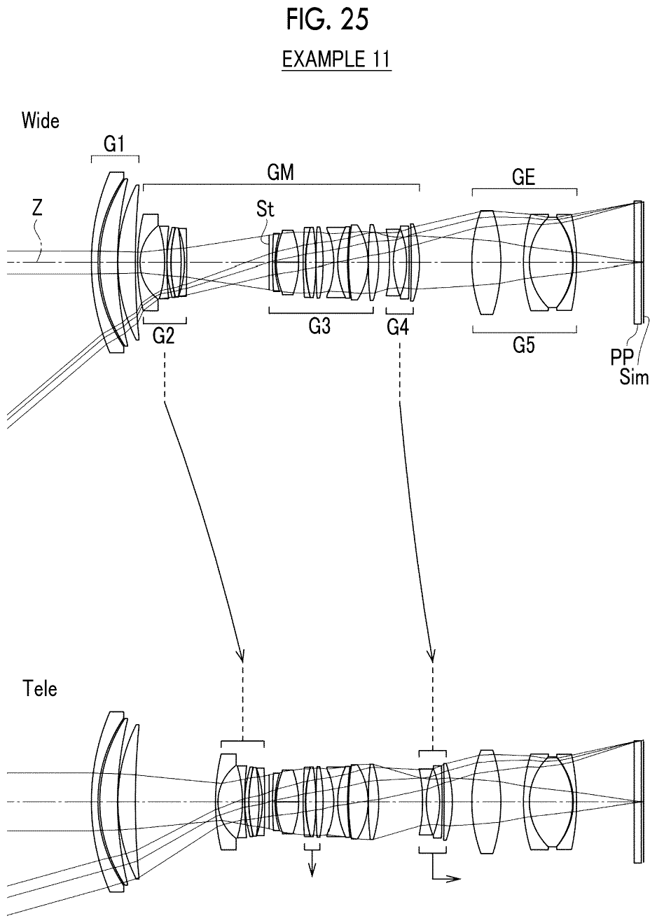

FIG. 25 shows a configuration and a moving path of a zoom lens of Example 11. The zoom lens of Example 11 consists of, in order from the object side to the image side, the first lens group G1 having positive refractive power, the second lens group G2 having negative lens group G3, and the fourth lens group G4. The final lens group GE consists of the fifth lens group G5.

During zooming from the wide angle end to the telephoto end, the second lens group G2 and the fourth lens group G4 move along the optical axis Z by changing spacings with respect to adjacent lens groups, and other lens groups remain stationary with respect to the image plane Sim. The focus group consists of the fourth lens group G4. During focusing from the infinite distance object to the nearest object, the focus group moves to the image side. The vibration-proof group consists of three lenses including the third to fifth lenses from the object side in the third lens group G3.

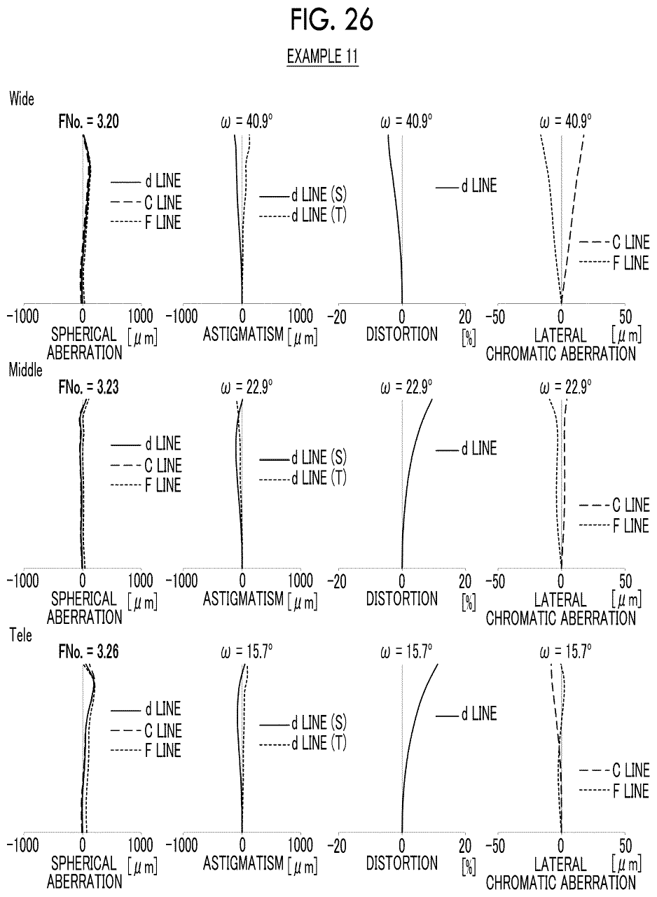

For the zoom lens of Example 11, Tables 31A and 31B show basic lens data, Table 32 shows specifications and a variable surface spacing, Table 33 shows aspherical coefficients, and FIG. 26 shows each aberration diagram.

TABLE 31A
Example 11

| Sn | R | D | Nd | νd | θg, F | dN/dT | ED |
|---|---|---|---|---|---|---|---|
| 1 | 110.6904 | 2.8922 | 1.84666 | 23.784 | 0.619 | 1.4 | 83.573 |
| 2 | 71.8471 | 0.8152 | | | | | 77.585 |
| 3 | 72.5915 | 7.9072 | 1.61800 | 63.356 | 0.539 | −2.4 | 77.212 |
| 4 | 166.1153 | 0.1502 | | | | | 76.146 |
| 5 | 82.9464 | 7.7493 | 1.72916 | 54.537 | 0.545 | 3.4 | 71.619 |
| 6 | 385.9459 | DD[6] | | | | | 70.296 |
| 7 | 99.7145 | 1.0908 | 1.85150 | 40.760 | 0.569 | 5.0 | 44.284 |
| 8 | 21.9569 | 10.8843 | | | | | 33.937 |
| 9 | −61.1812 | 0.9762 | 1.80400 | 46.597 | 0.558 | 4.3 | 33.407 |
| 10 | 166.2084 | 0.1002 | | | | | 32.558 |
| *11 | 59.7897 | 1.7207 | 1.58313 | 59.385 | 0.542 | 3.8 | 32.242 |
| *12 | 70.7194 | 0.1058 | | | | | 31.918 |
| 13 | 66.6567 | 4.4524 | 1.86074 | 23.077 | 0.626 | −1.4 | 31.854 |
| 14 | −100.9391 | 1.4932 | | | | | 31.383 |
| 15 | −47.5071 | 0.9839 | 1.72916 | 54.673 | 0.545 | 3.4 | 31.308 |
| 16 | −577.1812 | DD[16] | | | | | 30.992 |
| 17 (St) | ∞ | 1.4998 | | | | | 25.017 |
| 18 | 190.4555 | 1.1186 | 1.80400 | 46.574 | 0.558 | 3.7 | 26.063 |
| 19 | 45.3707 | 0.5853 | | | | | 26.668 |
| *20 | 37.3782 | 9.8931 | 1.49710 | 81.558 | 0.538 | −5.5 | 28.068 |
| *21 | −41.4167 | 1.9996 | | | | | 29.566 |
| 22 | 216.3174 | 1.0208 | 1.95906 | 17.472 | 0.659 | 4.1 | 32.018 |
| 23 | 60.0066 | 0.2281 | | | | | 32.139 |
| 24 | 66.4596 | 4.4033 | 1.62004 | 36.333 | 0.589 | 3.7 | 32.145 |
| 25 | −114.0436 | 0.1000 | | | | | 32.403 |
| 26 | 323.0868 | 3.1239 | 1.80420 | 46.502 | 0.557 | 4.2 | 32.653 |
| 27 | −91.5501 | 4.4703 | | | | | 32.699 |
| 28 | −43.6031 | 1.7844 | 1.85027 | 32.267 | 0.591 | 4.8 | 30.608 |
| 29 | 39.5697 | 4.3790 | 1.78472 | 25.729 | 0.615 | 1.2 | 32.390 |
| 30 | 129.6748 | 0.4372 | | | | | 32.911 |
| 31 | 111.1861 | 8.6470 | 1.41390 | 100.822 | 0.534 | −5.2 | 33.384 |
| 32 | −33.8637 | 0.1000 | | | | | 34.445 |
| 33 | 178.9146 | 4.6490 | 1.83481 | 42.725 | 0.565 | 4.6 | 34.954 |
| 34 | −63.2349 | DD[34] | | | | | 34.9 |

TABLE 31B
Example 11

| Sn | R | D | Nd | νd | θg, F | dN/dT | ED |
|---|---|---|---|---|---|---|---|
| *35 | −116.4349 | 1.6680 | 1.69350 | 53.185 | 0.548 | 3.3 | 30.607 |
| *36 | 34.0312 | 5.9184 | | | | | 30.58 |
| 37 | −43.9959 | 1.1055 | 1.64000 | 60.222 | 0.536 | 3.2 | 30.785 |
| 38 | −470.7853 | 0.9368 | | | | | 33.488 |
| 39 | −609.4914 | 3.6125 | 2.14400 | 17.755 | 0.659 | 26.8 | 34.801 |
| 40 | −59.6127 | DD[40] | | | | | 35.461 |
| 41 | 73.3565 | 12.8940 | 1.48749 | 70.440 | 0.531 | −1.4 | 47.622 |
| 42 | −82.3339 | 10.0445 | | | | | 47.968 |
| 43 | 77.6554 | 2.6099 | 1.90110 | 27.058 | 0.607 | 4.7 | 44.504 |
| 44 | 30.0475 | 19.1966 | 1.49700 | 81.607 | 0.539 | −6.2 | 41.515 |
| 45 | −33.9844 | 0.3512 | | | | | 41.484 |
| 46 | −32.9841 | 1.4170 | 1.95906 | 17.471 | 0.660 | 4.1 | 41.327 |
| 47 | −110.3851 | 25.5898 | | | | | 43.791 |
| 48 | ∞ | 3.2000 | 1.51680 | 64.197 | 0.534 | 2.7 | 53.644 |
| 49 | ∞ | 0.9896 | | | | | 54.385 |

TABLE 32
Example 11

| | Wide | Middle | Tele |
|---|---|---|---|
| Zr | 1.00 | 1.79 | 2.65 |
| f | 32.99 | 59.20 | 87.42 |
| FNo. | 3.20 | 3.23 | 3.26 |
| 2ω[°] | 81.8 | 45.8 | 31.4 |
| DD[6] | 1.0041 | 23.5088 | 35.6185 |
| DD[16] | 36.6086 | 14.1039 | 1.9942 |
| DD[34] | 4.8126 | 12.4772 | 19.4454 |
| DD[40] | 23.2923 | 15.6277 | 8.6595 |

TABLE 33
Example 11

| Sn | 11 | 12 | 20 |
|---|---|---|---|
| KA | −1.4733600621E−01 | −2.8921232001E+00 | 1.2753663503E+00 |
| A3 | 0.0000000000E+00 | 0.0000000000E+00 | 0.0000000000E+00 |
| A4 | 1.4811582834E−05 | 1.2783869684E−05 | −2.4510674022E−06 |
| A5 | −6.1624608488E−09 | 2.6810299678E−07 | 3.2213508111E−07 |
| A6 | −7.9665303532E−08 | −1.2215574842E−07 | −8.6357300437E−07 |
| A7 | −3.5826724607E−09 | −3.4143249140E−09 | 2.4403796760E−07 |
| A8 | 5.3227056576E−10 | 1.0904891930E−09 | −2.0809701517E−08 |
| A9 | 4.1850134134E−11 | 1.7592966347E−11 | −1.2636520460E−09 |
| A10 | −2.9922608634E−12 | −5.7001859403E−12 | 3.1833329808E−10 |
| A11 | −2.6989566233E−13 | −1.3685933930E−13 | −1.0803677484E−11 |
| A12 | 1.0520003603E−14 | 1.8385946325E−14 | −1.1722598747E−12 |
| A13 | 7.8364510872E−16 | 4.7381224358E−16 | 9.0655428444E−14 |
| A14 | −2.2708523385E−17 | −3.5830981915E−17 | 9.3140895283E−17 |
| A15 | −8.3421484521E−19 | −5.4023084615E−19 | −1.6820644820E−16 |
| A16 | 2.1710346786E−20 | 3.0761452283E−20 | 4.0102906525E−18 |
| Sn | 21 | 35 | 36 |
| KA | 1.2045076278E+00 | 2.6794299652E+00 | 9.3857023664E−01 |
| A3 | 0.0000000000E+00 | 0.0000000000E+00 | 0.0000000000E+00 |
| A4 | 4.5380691413E−06 | −3.4640426053E−05 | −3.9220183984E−05 |
| A5 | −1.0147355191E−07 | −1.2526548898E−06 | −1.3981729302E−06 |
| A6 | −1.9602062600E−07 | 4.6712274607E−07 | 5.2188799640E−07 |
| A7 | 4.0003522522E−08 | 1.1199230966E−08 | 6.5782680668E−09 |
| A8 | 1.0155953456E−10 | −3.9636268849E−09 | −4.2724298233E−09 |
| A9 | −5.1490360499E−10 | −6.6556969298E−11 | −4.8605400648E−12 |
| A10 | 1.8773113479E−11 | 2.2622991475E−11 | 2.2212221404E−11 |
| A11 | 3.0328085241E−12 | 2.5729741140E−13 | −8.3048383045E−14 |
| A12 | −1.5642628463E−13 | −8.2203177061E−14 | −7.1146722037E−14 |
| A13 | −9.1033647678E−15 | −5.3430966711E−16 | 3.0941611593E−16 |
| A14 | 5.4157090400E−16 | 1.6793816991E−16 | 1.2877085955E−16 |
| A15 | 1.1076705565E−17 | 4.3196186945E−19 | −3.3418228083E−19 |
| A16 | −7.0180818816E−19 | −1.4473537963E−19 | −1.0149981835E−19 |

Tables 34 to 36 show the corresponding values of Conditional Expressions (1) to (37) of the zoom lenses of Examples 1 to 11. Preferable ranges of the conditional expressions may be set using the corresponding values of the examples shown in Tables 34 to 36 as upper limits and lower limits of the conditional expressions.

TABLE 34

| Expression Number | | Example 1 | Example 2 | Example 3 | Example 4 |
|---|---|---|---|---|---|
| (1) | Bfw/fw | 1.0503 | 0.9429 | 1.0112 | 0.6048 |
| (2) | fw/f1 | 0.2572 | 0.3232 | 0.2672 | 0.3675 |
| (3) | DStw/TLw | 0.6691 | 0.6789 | 0.6725 | 0.6605 |
| (4) | Bfw/(fw × tan ωw) | 1.2040 | 1.1255 | 1.1666 | 0.7804 |
| (5) | fw/fE | 0.2113 | −0.3926 | 0.2466 | 0.3430 |
| (6) | νEmax | 81.554 | 90.194 | 81.607 | 81.548 |
| (7) | D12w/(fw × tan ωw) | 0.0759 | 0.0597 | 0.0350 | 0.0892 |
| (8) | DNPt/(fw × tan ωw) | 0.0696 | 0.0719 | 0.0707 | 0.1783 |
| (9) | NE + 0.0067 × νEmax − 2 | 0.0434 | 0.0629 | 0.0438 | 0.0430 |
| (10) | \|ΔsagM\|/HaM | 0.01022 | 0.00264 | 0.02018 | 0.00997 |
| (11) | Nn1 | 1.84666 | 1.95906 | 1.95906 | 1.80810 |
| (12) | Dn1/Hn1 | 0.0511 | 0.0508 | 0.0507 | 0.0799 |
| (13) | Dn2/Hn2 | 0.0440 | 0.0436 | 0.0600 | 0.0613 |
| (14) | fw/fFE | −0.5443 | 0.3659 | −0.5896 | −0.4965 |
| (15) | NStp | 1.80400 | 1.72342 | 1.49700 | 1.74330 |
| (16) | N1ave | 1.72311 | 1.77007 | 1.85094 | 1.70293 |
| (17) | βEt × βFEt | 1.83456 | 0.15636 | 1.77845 | 1.39152 |
| (18) | νNmin | 18.897 | 22.728 | 20.361 | 23.627 |
| (19) | fw/fGSt | 0.9163 | 0.4509 | 0.8489 | 0.5875 |
| (20) | fw/fN | −1.3799 | −1.5386 | −1.3794 | −1.5286 |
| (21) | \|γw\| | 3.5583 | 2.1524 | 3.3792 | 1.6138 |
| (22) | [(1 − βISt) × βISRt\| | 1.0205 | 0.8327 | 1.0062 | 1.0024 |
| (23) | TLw/ft | 2.8276 | 2.8462 | 2.7852 | 2.2476 |
| (24) | ft/fw | 2.6511 | 2.6492 | 2.6487 | 2.6977 |
| (25) | ωw | 41.098 | 39.955 | 40.918 | 37.776 |
| (26) | Denp/fw | 1.3405 | 1.2202 | 1.2286 | 1.0491 |
| (27) | fw/\|ffoc\| | 0.5443 | 0.3659 | 0.5896 | 0.4965 |
| (28) | \|γt\| | 3.1669 | 2.3492 | 2.9732 | 1.4745 |
| (29) | \|BRt × (ft × tan ωt)\| | 0.0100 | 0.0237 | 0.0091 | 0.0033 |
| (30) | ft/\|fIS\| | 0.8959 | 0.7323 | 0.9401 | 1.2158 |
| (31) | fN/fGSt | −0.6641 | −0.2931 | −0.6154 | −0.3843 |
| (32) | \|fIS/fGSt\| | 2.7113 | 1.6314 | 2.3917 | 1.3035 |
| (33) | FNot/FNow | 1.0321 | 1.0071 | 0.9936 | 1.0019 |
| (34) | (fw × tan ωw)/Dexw | 0.1824 | 0.2262 | 0.1598 | 0.1068 |
| (35) | \|fN/f1\| | 0.1864 | 0.2101 | 0.1937 | 0.2404 |
| (36) | φSw/φSt | 1.0000 | 1.0000 | 1.0000 | 0.7987 |
| (37) | dNp/dT | 2.7 | 3.0 | 2.0 | — |

TABLE 35

| Expression Number | | Example 5 | Example 6 | Example 7 | Example 8 |
|---|---|---|---|---|---|
| (1) | Bfw/fw | 0.7956 | 1.0683 | 0.6773 | 0.8610 |
| (2) | fw/f1 | 0.2842 | 0.2580 | 0.2901 | 0.2340 |
| (3) | DStw/TLw | 0.6790 | 0.6750 | 0.6481 | 0.6640 |
| (4) | Bfw/(fw × tan ωw) | 0.9302 | 1.2255 | 0.7267 | 0.9228 |
| (5) | fw/fE | 0.1900 | 0.2152 | 0.2598 | 0.1671 |
| (6) | νEmax | 91.306 | 81.607 | 90.171 | 70.439 |
| (7) | D12w/(fw × tan ωw) | 0.0920 | 0.0621 | 0.0931 | 0.0899 |
| (8) | DNPt/(fw × tan ωw) | 0.0884 | 0.0693 | 0.0869 | 0.0864 |
| (9) | NE + 0.0067 × νEmax − 2 | 0.0674 | 0.0438 | 0.0627 | −0.0406 |
| (10) | \|ΔsagM\|/HaM | 0.02326 | 0.00717 | 0.02032 | 0.03792 |
| (11) | Nn1 | 1.86966 | 1.89286 | 1.84666 | 1.95203 |
| (12) | Dn1/Hn1 | 0.0693 | 0.0508 | 0.0692 | 0.0692 |
| (13) | Dn2/Hn2 | 0.1035 | 0.0440 | 0.0525 | 0.0723 |
| (14) | fw/fFE | −0.4785 | −0.5511 | −0.5242 | −0.5356 |
| (15) | NStp | 1.88300 | 1.83400 | 1.80625 | 1.72916 |
| (16) | N1ave | 1.75474 | 1.69096 | 1.70872 | 1.81761 |
| (17) | βEt × βFEt | 1.70906 | 1.86881 | 1.66436 | 1.89869 |
| (18) | νNmin | 20.019 | 18.897 | 17.984 | 25.456 |
| (19) | fw/fGSt | 0.8825 | 0.9300 | 0.4582 | 0.8920 |
| (20) | fw/fN | −1.6182 | −1.4045 | −1.6259 | −1.5930 |
| (21) | \|γw\| | 3.2477 | 3.7050 | 2.3430 | 4.3445 |
| (22) | \|(1 − βISt) × βISRt\| | 0.9873 | 0.9237 | 0.8913 | 0.9631 |
| (23) | TLw/ft | 2.7411 | 2.7969 | 2.7509 | 2.7495 |
| (24) | ft/fw | 2.6500 | 2.6500 | 2.8244 | 2.8260 |
| (25) | ωw | 40.538 | 41.080 | 42.986 | 43.016 |
| (26) | Denp/fw | 1.1705 | 1.3013 | 1.2771 | 1.2125 |
| (27) | fw/\|ffoc\| | 0.4785 | 0.5511 | 0.5242 | 0.5356 |
| (28) | \|γt\| | 2.4840 | 3.2624 | 2.1335 | 3.0256 |
| (29) | \|BRt × (ft × tan ωt)\| | 0.0052 | 0.0064 | 0.0378 | 0.0161 |
| (30) | ft/\|fIS\| | 0.8341 | 0.8165 | 0.9590 | 0.7958 |
| (31) | fN/fGSt | −0.5454 | −0.6622 | −0.2818 | −0.5599 |
| (32) | \|fIS/fGSt\| | 2.8038 | 3.0184 | 1.3493 | 3.1674 |
| (33) | FNot/FNow | 1.0205 | 1.0264 | 1.0000 | 0.9994 |
| (34) | (fw × tan ωw)/Dexw | 0.1284 | 0.1572 | 0.0814 | 0.1306 |
| (35) | \|fN/f1\| | 0.1756 | 0.1837 | 0.1784 | 0.1469 |
| (36) | φSw/φSt | 1.0000 | 1.0000 | 0.8507 | 1.0000 |
| (37) | dNp/dT | 4.1 | −6.2 | — | −0.4 |

TABLE 36

| Expression Number | | Example 9 | Example 10 | Example 11 |
|---|---|---|---|---|
| (1) | Bfw/fw | 0.9859 | 0.6923 | 0.8696 |
| (2) | fw/f1 | 0.2499 | 0.2332 | 0.2510 |
| (3) | DStw/TLw | 0.6767 | 0.6395 | 0.6764 |
| (4) | Bfw/(fw × tan ωw) | 1.1480 | 0.8138 | 1.0032 |
| (5) | fw/fE | 0.2352 | 0.0779 | 0.2480 |
| (6) | νEmax | 81.607 | 81.607 | 81.607 |
| (7) | D12w/(fw × tan ωw) | 0.0354 | 0.0358 | 0.0351 |
| (8) | DNPt/(fw × tan ωw) | 0.0704 | 0.0714 | 0.0697 |
| (9) | NE + 0.0067 × νEmax − 2 | 0.0438 | 0.0438 | 0.0438 |
| (10) | \|ΔsagM\|/HaM | 0.01028 | 0.01386 | 0.00674 |
| (11) | Nn1 | 1.84666 | 1.84666 | 1.84666 |
| (12) | Dn1/Hn1 | 0.0529 | 0.0692 | 0.0692 |
| (13) | Dn2/Hn2 | 0.0440 | 0.0655 | 0.0492 |
| (14) | fw/fFE | −0.5506 | −0.4367 | −0.6271 |
| (15) | NStp | 1.77400 | 1.95375 | 1.83481 |
| (16) | N1ave | 1.73989 | 1.74407 | 1.73127 |
| (17) | βEt × βFEt | 1.72575 | 1.92312 | 1.89376 |
| (18) | νNmin | 20.361 | 20.880 | 23.077 |
| (19) | fw/fGSt | 0.8856 | 0.9429 | 0.9211 |
| (20) | fw/fN | −1.4039 | −1.3300 | −1.4125 |
| (21) | \|γw\| | 3.3181 | 3.4900 | 3.8669 |
| (22) | \|(1 − βISt) × βISRt\| | 0.9722 | 1.2043 | 1.4477 |
| (23) | TLw/ft | 2.7784 | 2.6861 | 2.7902 |
| (24) | ft/fw | 2.6500 | 2.6500 | 2.6500 |
| (25) | ωw | 40.656 | 40.389 | 40.921 |
| (26) | Denp/fw | 1.2875 | 1.3302 | 1.2542 |
| (27) | fw/\|ffoc\| | 0.5506 | 0.4367 | 0.6271 |
| (28) | \|γt\| | 2.7700 | 2.7998 | 3.4075 |
| (29) | \|BRt × (ft × tan ωt)\| | 0.0042 | 0.0201 | 0.0013 |
| (30) | ft/\|fIS\| | 0.8620 | 1.0567 | 1.2714 |
| (31) | fN/fGSt | −0.6308 | −0.7089 | 0.6521 |
| (32) | \|fIS/fGSt\| | 2.7227 | 2.3647 | 1.9200 |
| (33) | FNot/FNow | 1.0172 | 1.0154 | 1.0170 |
| (34) | (fw × tan ωw)/Dexw | 0.1695 | 0.1561 | 0.1659 |
| (35) | \|fN/f1\| | 0.1780 | 0.1754 | 0.1777 |
| (36) | φSw/φSt | 1.0000 | 1.0000 | 1.0000 |
| (37) | dNp/dT | −6.2 | 1.6 | −6.2 |

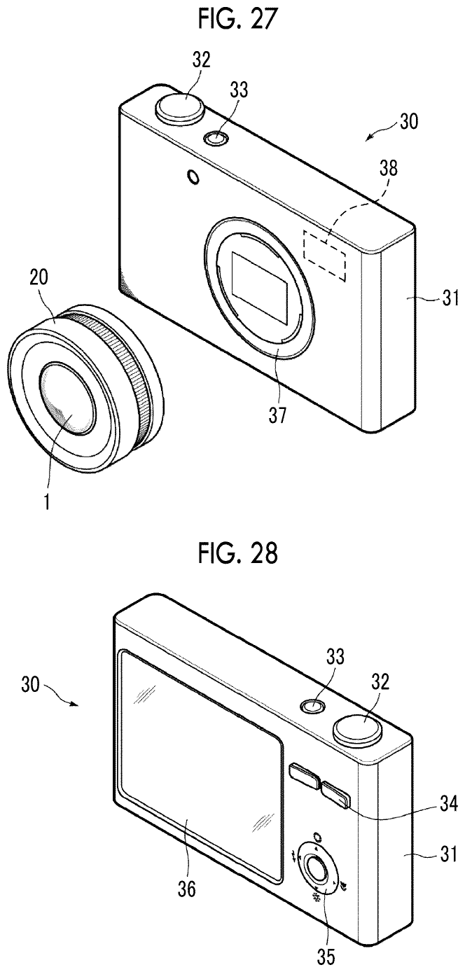

Next, an imaging apparatus according to the embodiment of the present disclosure will be described. FIGS. 27 and 28 show external views of a camera 30 that is the imaging apparatus according to the embodiment of the present disclosure. FIG. 27 shows a perspective view of the camera 30 seen from a front side, and FIG. 28 shows a perspective view of the camera 30 seen from a rear side. The camera 30 is a digital camera of a so-called mirrorless type on which an interchangeable lens 20 can be attachably and detachably mounted. The interchangeable lens 20 is composed of a zoom lens 1 according to one embodiment of the present disclosure accommodated in a lens barrel.

The camera 30 comprises a camera body 31. A shutter button 32 and a power button 33 are provided on an upper surface of the camera body 31. An operator 34, an operator 35, and a display unit 36 are provided on a rear surface of the camera body 31. The display unit 36 can display a captured image and an image within an angle of view before being captured.

An imaging aperture on which light from an imaging target is incident is provided in a center portion of a front surface of the camera body 31. A mount 37 is provided at a position corresponding to the imaging aperture, and the interchangeable lens 20 is mounted on the camera body 31 via the mount 37.

An imaging element 38 is provided in the camera body 31. The imaging element 38 outputs an imaging signal corresponding to a subject image formed by the interchangeable lens 20. For example, a charge coupled device (CCD) or a complementary metal oxide semiconductor (CMOS) is used as the imaging element 38. A signal processing circuit (not shown), a recording medium (not shown), and the like are provided in the camera body 31. The signal processing circuit generates an image by processing the imaging signal output from the imaging element 38. The generated image is recorded on the recording medium. In the camera 30, a still image or a moving image can be captured by pressing the shutter button 32, and image data obtained by this capturing is recorded on the recording medium.

While the disclosed technology is described above using the embodiment and the examples, the disclosed technology is not limited to the embodiment and the examples, and various modifications can be made. For example, the curvature radius, the surface spacing, the refractive index, the Abbe number, and the aspherical coefficients of each lens are not limited to the values shown in each example and may have other values.

The imaging apparatus according to the embodiment of the present disclosure is not limited to the above example and may adopt various aspects such as a camera of a type other than a mirrorless type, a camera composed of an imaging lens and a camera body that are integrated with each other, a film camera, a video camera, a surveillance camera, a broadcasting camera, a movie imaging camera, a factory automation (FA) camera, and a machine vision (MV) camera.

The following appendices are further disclosed with respect to the embodiment and the examples described above.

### Appendix 1

A zoom lens comprising:
a first lens group positioned closest to an object side;
an intermediate group including a plurality of lens groups; and
a final lens group positioned closest to an image side,
in which during zooming, the first lens group remains stationary with respect to an image plane, a spacing between the first lens group and the intermediate group changes, a spacing between the intermediate group and the final lens group changes, and all spacings between adjacent lens groups in the intermediate group change,
the number of lenses included in the first lens group is four or less, and
in a case where a back focus of a whole system as an air conversion distance in a state where an infinite distance object is in focus at a wide angle end is denoted by Bfw, and
a focal length of the whole system in the state where the infinite distance object is in focus at the wide angle end is denoted by fw,
Conditional Expression (1) is satisfied, which is represented by

$$0.1 < Bfw / fw < 1.9 . \qquad ( 1 )$$

### Appendix 2

The zoom lens according to Appendix 1,
in which the final lens group includes three or more lenses.

### Appendix 3

The zoom lens according to Appendix 1 or 2,
in which at least one of the plurality of lens groups included in the intermediate group is an intermediate stationary lens group that remains stationary with respect to an image plane during zooming.

### Appendix 4

The zoom lens according to Appendix 3,
in which the intermediate stationary lens group includes three or more lenses.

### Appendix 5

The zoom lens according to any one of Appendices 1 to 4,
in which a lens closest to the object side in the first lens group is a negative lens.

### Appendix 6

The zoom lens according to any one of Appendices 1 to 5,
in which the final lens group remains stationary with respect to the image plane during zooming.

### Appendix 7

The zoom lens according to any one of Appendices 1 to 6,
in which in a case where a focal length of the first lens group is denoted by f1,
Conditional Expression (2) is satisfied, which is represented by

$$0.05 < f w / f 1 < 0.54 . \qquad ( 2 )$$

### Appendix 8

The zoom lens according to any one of Appendices 1 to 7,
in which the zoom lens includes an aperture stop, and
in a case where a sum of a distance on an optical axis from the aperture stop to a lens surface closest to the image side in the final lens group and the back focus of the whole system as the air conversion distance in the state where the infinite distance object is in focus at the wide angle end is denoted by DStw, and
a sum of a distance on the optical axis from a lens surface closest to the object side in the first lens group to the lens surface closest to the image side in the final lens group and the back focus of the whole system as the air conversion distance in the state where the infinite distance object is in focus at the wide angle end is denoted by TLw,
Conditional Expression (3) is satisfied, which is represented by

$$0.5 < DStw / T L w < 0 \text{.85} . \qquad ( 3 )$$

### Appendix 9

The zoom lens according to Appendix 8,
in which Conditional Expression (3-1) is satisfied, which is represented by

$$0.61 < DStw / T L w < 0.8 . \qquad ( 3 - 1 )$$

### Appendix 10

The zoom lens according to any one of Appendices 1 to 9,
in which the intermediate group includes a focus group that moves along an optical axis during focusing.

### Appendix 11

The zoom lens according to Appendix 10,
in which the focus group has negative refractive power.

### Appendix 12

The zoom lens according to any one of Appendices 1 to 11,
in which a lens surface closest to the object side in the first lens group is a convex surface.

### Appendix 13

The zoom lens according to any one of Appendices 1 to 12,
in which the intermediate group includes a vibration-proof group that moves in a direction intersecting with an optical axis during image shake correction.

### Appendix 14

The zoom lens according to Appendix 13,
in which the vibration-proof group consists of all or a part of an intermediate stationary lens group that remains stationary with respect to the image plane during zooming.

### Appendix 15

The zoom lens according to Appendix 13 or 14,
in which the vibration-proof group has positive refractive power.

### Appendix 16

The zoom lens according to any one of Appendices 1 to 15,
in which in a case where a maximum half angle of view in the state where the infinite distance object is in focus at the wide angle end is denoted by ωw,
Conditional Expression (4) is satisfied, which is represented by

$$0.4 < Bfw / ( f w \times tan ω w ) < 1.6 . \qquad ( 4 )$$

### Appendix 17

The zoom lens according to any one of Appendices 1 to 16,
in which in a case where a focal length of the final lens group is denoted by fE,
Conditional Expression (5) is satisfied, which is represented by

$$- 0.7 < fw / fE < 0.7 . \qquad ( 5 )$$

### Appendix 18

The zoom lens according to any one of Appendices 1 to 17,
in which in a case where a maximum value of Abbe numbers based on a d line for all lenses included in the final lens group is denoted by νEmax,
Conditional Expression (6) is satisfied, which is represented by

$$60 < vEmax < 105. \qquad ( 6 )$$

### Appendix 19

The zoom lens according to any one of Appendices 1 to 18, in which in a case where a spacing on an optical axis between the first lens group and a lens group adjacent to the image side of the first lens group in the state where the infinite distance object is in focus at the wide angle end is denoted by D12w, and a maximum half angle of view in the state where the infinite distance object is in focus at the wide angle end is denoted by ωw,
Conditional Expression (7) is satisfied, which is represented by

$$0.005 < D 12 w / ( f w \times tan ω w ) < 0.35 . \qquad ( 7 )$$

### Appendix 20

The zoom lens according to any one of Appendices 1 to 19,
in which the zoom lens includes at least one combination consisting of a lens group having negative refractive power and a lens group having positive refractive power that are disposed adjacent to each other in order from the object side to the image side, and
in a case where a spacing on an optical axis at a telephoto end between a lens group having negative refractive power and a lens group having positive refractive power in a combination closest to the object side among the combinations is denoted by DNPt, and
a maximum half angle of view in the state where the infinite distance object is in focus at the wide angle end is denoted by ωw,
Conditional Expression (8) is satisfied, which is represented by

$$0.005 < DNPt / ( fw \times tan ω w ) < 0.5 . \qquad ( 8 )$$

### Appendix 21

The zoom lens according to any one of Appendices 1 to 20,
in which in a case where a refractive index with respect to a d line for a lens of which an Abbe number based on a d line is highest among lenses included in the final lens group and the Abbe number are denoted by NE and νEmax, respectively,
Conditional Expression (9) is satisfied, which is represented by

$$- 0.05 < N E + 0.0067 \times vEm ax - 2 < 0.13 . \qquad ( 9 )$$

### Appendix 22

The zoom lens according to any one of Appendices 1 to 21,
in which the zoom lens includes at least one aspherical lens, and
in a case where a difference between an amount of sag of a lens surface of the aspherical lens at a height of 70% of a maximum effective radius of the lens surface and an amount of sag of a paraxial curvature spherical surface of the lens surface is defined as Δsag,
in an aspherical lens closest to the object side among the aspherical lenses included in the zoom lens, any of Δsag of a surface on the object side or Δsag of a surface on the image side having a larger absolute value is denoted by ΔsagM, and
in the aspherical lens closest to the object side among the aspherical lenses included in the zoom lens, a larger of a maximum effective radius of the surface on the object side or a maximum effective radius of the surface on the image side is denoted by HaM,
Conditional Expression (10) is satisfied, which is represented by

$$0.001 < \vert Δ sagM \vert / HaM < 0.07 . \qquad ( 10 )$$

### Appendix 23

The zoom lens according to Appendix 22,
in which the zoom lens includes at least one lens group having negative refractive power, and
the aspherical lens closest to the object side is a third lens from the object side in a lens group having negative refractive power closest to the object side among the lens groups having negative refractive power and included in the zoom lens.

### Appendix 24

The zoom lens according to Appendix 22,
in which the zoom lens includes at least one lens group having negative refractive power, and
the aspherical lens closest to the object side is a fourth lens from the object side in a lens group having negative refractive power closest to the object side among the lens groups having negative refractive power and included in the zoom lens.

### Appendix 25

The zoom lens according to any one of Appendices 1 to 24,
in which the zoom lens includes at least one negative lens, and
in a case where a refractive index with respect to a d line for a negative lens closest to the object side among the negative lenses included in the zoom lens is denoted by Nn1,
Conditional Expression (11) is satisfied, which is represented by

$$1. 59 < Nn 1 < 1.99 . \qquad ( 11 )$$

### Appendix 26

The zoom lens according to any one of Appendices 1 to 25,
in which the zoom lens includes at least one negative lens, and
in a case where a center thickness of a negative lens closest to the object side among the negative lenses included in the zoom lens and a maximum effective radius of a surface, on the object side, of the negative lens are denoted by Dn1 and Hn1, respectively,
Conditional Expression (12) is satisfied, which is represented by

$$0.02 < Dn 1 / Hn 1 < 0.087 . \qquad ( 12 )$$

### Appendix 27

The zoom lens according to any one of Appendices 1 to 26,
in which the zoom lens includes at least one lens group having negative refractive power,
a lens group having negative refractive power closest to the object side among the lens groups having negative refractive power and included in the zoom lens includes at least one negative lens, and
in a case where a center thickness of a negative lens closest to the object side among the negative lenses included in the lens group having negative refractive power closest to the object side and a maximum effective radius of a surface, on the object side, of the negative lens are denoted by Dn2 and Hn2, respectively,
Conditional Expression (13) is satisfied, which is represented by

$$0.02 < Dn 2 / Hn 2 < 0 \text{.105} . \qquad ( 13 )$$

### Appendix 28

The zoom lens according to any one of Appendices 1 to 27,
in which the zoom lens includes at least one negative lens, and
a surface, on the image side, of a negative lens closest to the object side among the negative lenses included in the zoom lens is in contact with air.

### Appendix 29

The zoom lens according to any one of Appendices 1 to 28,
in which the zoom lens includes an aperture stop, and
a negative lens is disposed adjacent to the image side of the aperture stop.

### Appendix 30

The zoom lens according to any one of Appendices 1 to 29,
in which in a case where a focal length of a lens group disposed adjacent to the object side of the final lens group is denoted by fFE,
Conditional Expression (14) is satisfied, which is represented by

$$- 0.8 < f w / fFE < 0.4 . \qquad ( 14 )$$

### Appendix 31

The zoom lens according to any one of Appendices 1 to 30,
in which the zoom lens includes an aperture stop, and
in a case where, in a case where the aperture stop is included in a lens group, a refractive index with respect to a d line for a positive lens closest to the image side among positive lenses included in the lens group including the aperture stop is denoted by NStp, and
in a case where the aperture stop is not included in a lens group, a refractive index with respect to a d line for a positive lens closest to the image side among positive lenses included in a lens group adjacent to the image side of the aperture stop is denoted by NStp,
Conditional Expression (15) is satisfied, which is represented by

$$1.43 < NStp < 1.895 . \qquad ( 15 )$$

### Appendix 32

The zoom lens according to any one of Appendices 1 to 31,
in which in a case where an average value of refractive indices with respect to a d line for all lenses included in the first lens group is denoted by N1ave,
Conditional Expression (16) is satisfied, which is represented by

$$1. 6 < N 1 ave < 1.9 . \qquad ( 16 )$$

### Appendix 33

The zoom lens according to any one of Appendices 1 to 32,
in which in a case where a lateral magnification of the final lens group in a state where the infinite distance object is in focus at a telephoto end is denoted by βEt, and
a lateral magnification of a lens group adjacent to the object side of the final lens group in the state where the infinite distance object is in focus at the telephoto end is denoted by βFEt,
Conditional Expression (17) is satisfied, which is represented by

$$0.14 < β E t \times β F E t < 2.2 . \qquad ( 17 )$$

### Appendix 34

The zoom lens according to any one of Appendices 1 to 33,
in which the zoom lens includes at least one lens group having negative refractive power, and
in a case where a minimum value of Abbe numbers based on a d line for all lenses included in a lens group having negative refractive power closest to the object side among the lens groups having negative refractive power and included in the zoom lens is denoted by νNmin,
Conditional Expression (18) is satisfied, which is represented by

$$15 < vNmin < 25.6 . \qquad ( 18 )$$

### Appendix 35

The zoom lens according to any one of Appendices 1 to 34,
in which the zoom lens includes an aperture stop, and
in a case where, in a case where the aperture stop is included in a lens group, a focal length of the lens group including the aperture stop is denoted by fGSt, and
in a case where the aperture stop is not included in a lens group, a focal length of the lens group adjacent to the image side of the aperture stop is denoted by fGSt,
Conditional Expression (19) is satisfied, which is represented by

$$0.3 < fw / fGSt < 1.3 . \qquad ( 19 )$$

### Appendix 36

The zoom lens according to any one of Appendices 1 to 35,
in which the zoom lens includes at least one lens group having negative refractive power, and
in a case where a focal length of a lens group having negative refractive power closest to the object side among the lens groups having negative refractive power and included in the zoom lens is denoted by fN,
Conditional Expression (20) is satisfied, which is represented by

$$- 2.5 < fw / fN < - 0.8 . \qquad ( 20 )$$

### Appendix 37

An imaging apparatus comprising:
the zoom lens according to any one of Appendices 1 to 36.

What is claimed is:

1. A zoom lens comprising:
a first lens group positioned closest to an object side;
an intermediate group including a plurality of lens groups; and
a final lens group positioned closest to an image side,
wherein during zooming, the first lens group remains stationary with respect to an image plane, a spacing between the first lens group and the intermediate group changes, a spacing between the intermediate group and the final lens group changes, and all spacings between adjacent lens groups in the intermediate group change,
the number of lenses included in the first lens group is four or less, and
in a case where a back focus of the zoom lens as an air conversion distance in a state where an infinite distance object is in focus at a wide angle end is denoted by Bfw, and
a focal length of the zoom lens in the state where the infinite distance object is in focus at the wide angle end is denoted by fw,
Conditional Expression (1) is satisfied, which is represented by
$$0.1 < Bfw / fw < 1.9 . \qquad ( 1 )$$

2. The zoom lens according to claim 1,
wherein the final lens group includes three or more lenses.

3. The zoom lens according to claim 1,
wherein at least one of the plurality of lens groups included in the intermediate group is an intermediate stationary lens group that remains stationary with respect to an image plane during zooming.

4. The zoom lens according to claim 1,
wherein a lens closest to the object side in the first lens group is a negative lens.

5. The zoom lens according to claim 3,
wherein the intermediate stationary lens group includes three or more lenses.

6. The zoom lens according to claim 1,
wherein the final lens group remains stationary with respect to the image plane during zooming.

7. The zoom lens according to claim 1,
wherein in a case where a focal length of the first lens group is denoted by f1,
Conditional Expression (2) is satisfied, which is represented by
$$0.05 < f w / f 1 < 0.54 . \qquad ( 2 )$$

8. The zoom lens according to claim 1,
wherein the zoom lens includes an aperture stop, and
in a case where a sum of a distance on an optical axis from the aperture stop to a lens surface closest to the image side in the final lens group and the back focus of the zoom lens as the air conversion distance in the state where the infinite distance object is in focus at the wide angle end is denoted by DStw, and
a sum of a distance on the optical axis from a lens surface closest to the object side in the first lens group to the lens surface closest to the image side in the final lens group and the back focus of the zoom lens as the air conversion distance in the state where the infinite distance object is in focus at the wide angle end is denoted by TLw,
Conditional Expression (3) is satisfied, which is represented by
$$0.5 < D S t w / T L w < 0.85 . \qquad ( 3 )$$

9. The zoom lens according to claim 8,
wherein Conditional Expression (3-1) is satisfied, which is represented by
$$0.61 < DStw / T L w < 0.8 . \qquad ( 3 - 1 )$$

10. The zoom lens according to claim 1,
wherein the intermediate group includes a focus group that moves along an optical axis during focusing.

11. The zoom lens according to claim 10,
wherein the focus group has negative refractive power.

12. The zoom lens according to claim 1,
wherein a lens surface closest to the object side in the first lens group is a convex surface.

13. The zoom lens according to claim 1,
wherein the intermediate group includes a vibration-proof group that moves in a direction intersecting with an optical axis during image shake correction.

14. The zoom lens according to claim 13,
wherein the vibration-proof group consists of all or a part of an intermediate stationary lens group that remains stationary with respect to the image plane during zooming.

15. The zoom lens according to claim 13,
wherein the vibration-proof group has positive refractive power.

16. The zoom lens according to claim 1,
wherein in a case where a maximum half angle of view in the state where the infinite distance object is in focus at the wide angle end is denoted by ωw,
Conditional Expression (4) is satisfied, which is represented by
$$0.4 < Bfw / ( fw \times tan ω w ) < 1.6 . \qquad ( 4 )$$

17. The zoom lens according to claim 1,
wherein in a case where a focal length of the final lens group is denoted by fE,
Conditional Expression (5) is satisfied, which is represented by
$$- 0.7 < f w / f E < 0.7 . \qquad ( 5 )$$

18. The zoom lens according to claim 1,
wherein in a case where a maximum value of Abbe numbers based on a d line for all lenses included in the final lens group is denoted by νEmax,
Conditional Expression (6) is satisfied, which is represented by
$$60 < vEmax < 105. \qquad ( 6 )$$

19. The zoom lens according to claim 1,
wherein in a case where a spacing on an optical axis between the first lens group and a lens group adjacent to the image side of the first lens group in the state where the infinite distance object is in focus at the wide angle end is denoted by D12w, and
a maximum half angle of view in the state where the infinite distance object is in focus at the wide angle end is denoted by ωw,
Conditional Expression (7) is satisfied, which is represented by
$$0.005 < D 12 w / ( f w \times tan ω w ) < 0.35 . \qquad ( 7 )$$

20. The zoom lens according to claim 1,
wherein the zoom lens includes at least one combination consisting of a lens group having negative refractive power and a lens group having positive refractive power that are disposed adjacent to each other in order from the object side to the image side, and
in a case where a spacing on an optical axis at a telephoto end between a lens group having negative refractive power and a lens group having positive refractive power in a combination closest to the object side among the combinations is denoted by DNPt, and
a maximum half angle of view in the state where the infinite distance object is in focus at the wide angle end is denoted by ωw,
Conditional Expression (8) is satisfied, which is represented by
$$0.005 < DNPt / ( f w \times tan ω w ) < 0.5 . \qquad ( 8 )$$

21. The zoom lens according to claim 1,
wherein in a case where a refractive index with respect to a d line for a lens of which an Abbe number based on a d line is highest among lenses included in the final lens group and the Abbe number are denoted by NE and νEmax, respectively,
Conditional Expression (9) is satisfied, which is represented by
$$- 0.05 < N E + 0.0067 \times vE m ax - 2 < 0 \text{.13} . \qquad ( 9 )$$

22. The zoom lens according to claim 1,
wherein the zoom lens includes at least one aspherical lens, and
in a case where a difference between an amount of sag of a lens surface of the aspherical lens at a height of 70% of a maximum effective radius of the lens surface and an amount of sag of a paraxial curvature spherical surface of the lens surface is defined as Δsag,
in an aspherical lens closest to the object side among the aspherical lenses included in the zoom lens, any of Δsag of a surface on the object side or Δsag of a surface on the image side having a larger absolute value is denoted by ΔsagM, and
in the aspherical lens closest to the object side among the aspherical lenses included in the zoom lens, a larger of a maximum effective radius of the surface on the object side or a maximum effective radius of the surface on the image side is denoted by HaM,
Conditional Expression (10) is satisfied, which is represented by
$$0.001 < \vert Δ sagM \vert / HaM < 0.07 . \qquad ( 10 )$$

23. The zoom lens according to claim 22,
wherein the zoom lens includes at least one lens group having negative refractive power, and
the aspherical lens closest to the object side is a third lens from the object side in a lens group having negative refractive power closest to the object side among the lens groups having negative refractive power and included in the zoom lens.

24. The zoom lens according to claim 22,
wherein the zoom lens includes at least one lens group having negative refractive power, and
the aspherical lens closest to the object side is a fourth lens from the object side in a lens group having negative refractive power closest to the object side among the lens groups having negative refractive power and included in the zoom lens.

25. The zoom lens according to claim 1,
wherein the zoom lens includes at least one negative lens, and
in a case where a refractive index with respect to a d line for a negative lens closest to the object side among the negative lenses included in the zoom lens is denoted by Nn1,
Conditional Expression (11) is satisfied, which is represented by
$$1. 59 < Nn 1 < 1.99 . \qquad ( 11 )$$

26. The zoom lens according to claim 1,
wherein the zoom lens includes at least one negative lens, and
in a case where a center thickness of a negative lens closest to the object side among the negative lenses included in the zoom lens and a maximum effective radius of a surface, on the object side, of the negative lens are denoted by Dn1 and Hn1, respectively,
Conditional Expression (12) is satisfied, which is represented by
$$0.02 < Dn 1 / Hn 1 < 0.087 . \qquad ( 12 )$$

27. The zoom lens according to claim 1,
wherein the zoom lens includes at least one lens group having negative refractive power,
a lens group having negative refractive power closest to the object side among the lens groups having negative refractive power and included in the zoom lens includes at least one negative lens, and
in a case where a center thickness of a negative lens closest to the object side among the negative lenses included in the lens group having negative refractive power closest to the object side and a maximum effective radius of a surface, on the object side, of the negative lens are denoted by Dn2 and Hn2, respectively,
Conditional Expression (13) is satisfied, which is represented by
$$0.02 < Dn 2 / Hn 2 < 0 \text{.105} . \qquad ( 13 )$$

28. The zoom lens according to claim 1,
wherein the zoom lens includes at least one negative lens, and
a surface, on the image side, of a negative lens closest to the object side among the negative lenses included in the zoom lens is in contact with air.

29. The zoom lens according to claim 1,
wherein the zoom lens includes an aperture stop, and
a negative lens is disposed adjacent to the image side of the aperture stop.

30. The zoom lens according to claim 1,
wherein in a case where a focal length of a lens group disposed adjacent to the object side of the final lens group is denoted by fFE,
Conditional Expression (14) is satisfied, which is represented by
$$- 0.8 < fw / fFE < 0.4 . \qquad ( 14 )$$

31. The zoom lens according to claim 1,
wherein the zoom lens includes an aperture stop, and
in a case where, in a case where the aperture stop is included in a lens group, a refractive index with respect to a d line for a positive lens closest to the image side among positive lenses included in the lens group including the aperture stop is denoted by NStp, and
in a case where the aperture stop is not included in a lens group, a refractive index with respect to a d line for a positive lens closest to the image side among positive lenses included in a lens group adjacent to the image side of the aperture stop is denoted by NStp,
Conditional Expression (15) is satisfied, which is represented by
$$1.43 < NStp < 1.895 . \qquad ( 15 )$$

32. The zoom lens according to claim 1,
wherein in a case where an average value of refractive indices with respect to a d line for all lenses included in the first lens group is denoted by N1ave,
Conditional Expression (16) is satisfied, which is represented by
$$1.6 < N 1 ave < 1.9 . \qquad ( 16 )$$

33. The zoom lens according to claim 1,
wherein in a case where a lateral magnification of the final lens group in a state where the infinite distance object is in focus at a telephoto end is denoted by βEt, and
a lateral magnification of a lens group adjacent to the object side of the final lens group in the state where the infinite distance object is in focus at the telephoto end is denoted by βFEt,
Conditional Expression (17) is satisfied, which is represented by
$$0.14 < β E t \times β F E t < 2.2 . \qquad ( 17 )$$

34. The zoom lens according to claim 1,
wherein the zoom lens includes at least one lens group having negative refractive power, and
in a case where a minimum value of Abbe numbers based on a d line for all lenses included in a lens group having negative refractive power closest to the object side among the lens groups having negative refractive power and included in the zoom lens is denoted by νNmin,
Conditional Expression (18) is satisfied, which is represented by
$$15 < vNmin < 25.6 . \qquad ( 18 )$$

35. The zoom lens according to claim 1,
wherein the zoom lens includes an aperture stop, and
in a case where, in a case where the aperture stop is included in a lens group, a focal length of the lens group including the aperture stop is denoted by fGSt, and
in a case where the aperture stop is not included in a lens group, a focal length of the lens group adjacent to the image side of the aperture stop is denoted by fGSt,
Conditional Expression (19) is satisfied, which is represented by
$$0.3 < fw / fGSt < 1.3 . \qquad ( 19 )$$

36. The zoom lens according to claim 1,
wherein the zoom lens includes at least one lens group having negative refractive power, and
in a case where a focal length of a lens group having negative refractive power closest to the object side among the lens groups having negative refractive power and included in the zoom lens is denoted by fN,
Conditional Expression (20) is satisfied, which is represented by
$$- 2.5 < f w / fN < - 0.8 . \qquad ( 20 )$$

37. An imaging apparatus comprising:
the zoom lens according to claim 1.
